(19) United States
(12) Patent Application Publication
(10) Pub. No.: US 2016/0067644 A1
(43) Pub. Date: Mar. 10, 2016

(54) MODULAR COMPACT HI-PERFORMANCE SINGULAR SKU FILTRATION DEVICE WITH COMMON PLUG AND PLAY INTERFACE ARCHITECTURE CAPABLE OF DOCKING WITH FAN, MATERIAL HANDLING, HVAC, GEOTHERMAL COOLING AND OTHER ANCILLARY SYSTEMS

(71) Applicant: MOBIAIR PTE LTD., Singapore (SG)

(72) Inventor: Martin Scaife, Singapore (SG)

(73) Assignee: Martin Scaife, Singapore (SG)

(21) Appl. No.: 14/786,964

(22) PCT Filed: Apr. 23, 2014
(86) PCT No.: PCT/EP2014/058287

§ 371 Date: Oct. 23, 2015

(30) Foreign Application Priority Data
Apr. 23, 2013 (GB) 1307265.7

(51) Int. Cl. B01D 46/00; B01D 46/26; B01D 46/42; B01D 46/24

(52) U.S. Cl. CPC B01D 46/0045; B01D 46/2403; B01D 46/26; B01D 46/0023; B01D 46/0002; B01D 46/4263; B01D 46/429; B01D 46/0065

(57) ABSTRACT

A modular utility system comprising of filter modules, fans modules, ancillary equipment modules, material separator modules, baler modules, compactor modules, HVAC modules and geo-thermal cooling modules where the modules can be linked together via a common electrical and mechanical interface to create a total utility system.

### FIELD OF THE INVENTION

### Background

The present invention relates to a utility systems (also referred to as off-line systems) which typically consist of a filtration system, a number of related process fan(s), a main system fan, a nozzle cleaning fan, ductwork, cyclone(s), nozzle control valve(s), and multiple electrical systems typically enclosed within electrical panel(s) to power and control the respective system(s). The total utility system is typically specified to match the air volume requirements of the system(s) to which it is attached (referred to throughout this description as a convertor). Such a utility system could be connected to a variety of processes and associated equipment, which generate dust, fibres and other contaminants such as diaper production, tissue production, facemask production, garment production, concrete production, lime production, graphite powder production, fibre production, garment production and similar processes.

Many of the process requirements differ from industry to industry, and even within the same industry, a wide variety of process requirements exist. As an example, within the FMCG hygiene industry, a feminine pad convertor for instance would require lower air volumes, typically in the 10 000-30 000 CMH (cubic meters per hour) range, a baby diaper convertor could require air volumes in the 25 000-50 000 CMH range where as an adult diaper convertor could require air volumes in the 40 000-80 000 CMH range. Even within the same product category such as diapers, a variety of process requirements exist across OEMs and self-build equipment variations which can vary significantly such is the range above for diaper convertors stated between 25 000-50 000 CMH.

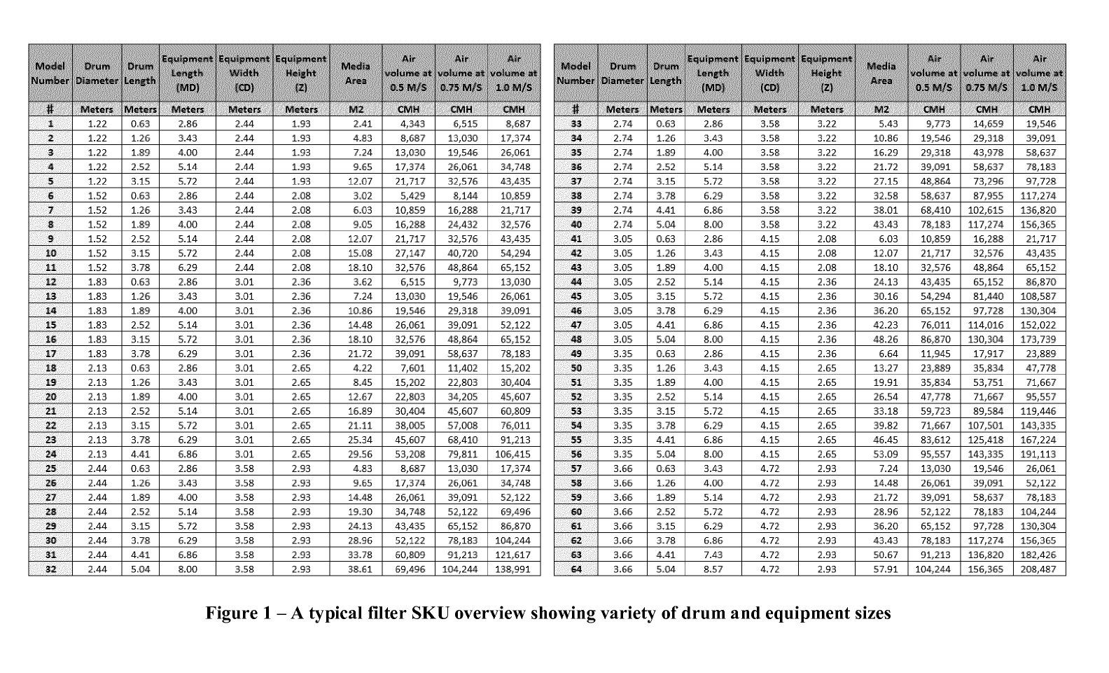

Current utility systems operate within a well-defined process window due to fundamental process characteristics of processes used within the utility system(s). Typically, during the design phase of the project the utility system capacity is calculated and sized based upon the air volumes that the system will be required to handle in the future. If air volumes flowing through parts of the utility system such as the filter system are too high, air pressure build up across the filter media can become excessive, and, in some instances typically in the stage 1 filtration process (of a drum filtration process), when air speed through the filter media reaches or exceeds a specific threshold, airborne contaminants can penetrate the media thereby causing significant filtration performance loss which either results in an increase in emissions, and/or, if secondary filtration stages are attached, a significantly reduced life span of filter media in the subsequent filtration phases. The airspeed at which these problems occur is not only based on air speed alone but are also very much dependent on contaminant type, moisture levels and filter media type. As a general rule of thumb, air speeds over 1 M/S present significant process issues and typically air speeds below 0.5 M/S are typically un-problematic. A typical equipment overview of a filter process details is shown in FIG. 1, which outlines filter size, media areas, airflows, and related air speeds.

On the lower end of the process window, current filter equipment however requires that a certain amount of air speed flowing through the filter exists to ensure that the internal surfaces of the filter are kept clean (typically the floor area of the filter housing). Basic concepts of which are outlined in U.S. Pat. No. 5,679,136 where airflow is used to continuously clean the filter floor. If air volumes passing through the filter fall below the designed airflow process window, significant contamination build-up will typically occur within the filter. This contamination build up not only requires significant continual manual cleaning but is also a significant safety hazard from both a fire and an explosion standpoint. If airborne dust within the utility system is within a defined level (referred to as LEL (lower explosive limit) and UEL (upper explosive limit) then an explosion hazard exists and if an ignition source is present (usually a hot surface, an electrical spark, static electricity or a mechanically generated frictional spark) then an explosion can occur and many utility systems around the globe have unfortunately been destroyed in such accidents, the majority causing asset loss only however in some instances, also causing human injury and loss of life. A further consideration also of importance is the concepts of increasing the amount of flammable material within the filter as this increases the hazard by adding additional fuel to the fire once the initial explosion has taken place.

Due to these inherent design requirements in today's utility systems, a large number of filter equipment SKUs (Stock Keeping Units) must be available to match the airflow requirements to the variety of Industries and their respective OEM suppliers.

The filter manufacturer is therefore required to maintain production capability for a large number of filter SKUs (FIG. 1 also gives a typical overview of filter SKUs) and as a consequence, production volumes of any single SKU by default are always low. Due to low equipment SKU production numbers, the filter manufacturer together with their respective supply chain(s) typically do not hold inventory stock of any equipment SKUs. To be able therefore to maintain any realistic production lead times when an order arrives for particular equipment SKU, the filter manufacturer is typically forced to use either in-house production capability and/or contract outside production companies located in the local vicinity and/or use component suppliers located in close vicinity.

When global sourcing is considered the total supply chain system becomes increasingly problematic as setting up production operations in other regions for a high SKU low volume production operation is typically very inefficient and in many cases not financially viable when the total cost structure is considered despite possible labour costs advantages in other regions.

Referring now to the actual tasks involved in building the filter. The production process typically starts with the assembly of the filter body and thereafter, parts are assembled to the interior and exterior of the filter body, the build and assembly typically follows a similar production concept to the basic Ford model T car, where multiple components are bolted together on a single assembly site to form the final assembly.

Once production of the air filter system is complete, the filter is typically larger than a standard sea-shipping container (assuming a baby diaper scenario), and as such, after initial assembly and testing, the system is dismantled, placed into wooden crates, and shipped within a standard sea-shipping container. A quality baby diaper air filter system containing 4 filtration stages would be only 20% to 30% larger than a shipping container (calculated on a volume to volume comparison) however when dismantled and crated would typically require 2-3 shipping containers to ship the packaged filter parts to the hygiene product manufacturer with further items such as fans & control panels also taking up additional shipment space in additional shipping containers. Having to package & crate the components as well as ship multiple shipping-containers not only increases the negative environmental impact of the project but also adds significant additional costs to the project when the total supply chain & total installed costs are considered.

Once all of the components of the filter arrive at the customer's site, the filter and fan components are re-assembled with a large number of man-hours required to re-assemble the equipment. Having multiple crews working across multiple shifts to re-assemble is typical which increases the total installed project costs. Furthermore, in many instances, external support staff must fly in to support the staff assembling the filter. Once the filter is assembled, ducting is typically used to connect the filter & fan systems and used to connect the total utility system to the convertor.

The engineering effort required to correctly design the entire system to fit within a given space (typically defined by the building surrounding the convertor but can also be defined by existing systems such as existing HVAC ducting, mezzanine' etc.) is significant and typically involves hundreds of engineering design hours and in some installation examples, the required engineering effort is not invested to complete a quality design which typically results in the installed system being either very inefficient thereby requiring excessive energy consumption, or excessive heat and noise emissions into the production area and leads to reduced convertor performance which in the hygiene industry would typically cause Pulp/SAP blending performance losses which has significant cost implications (raw material utilisation) for hygiene producers.

In many installation examples, fans are housed in an open environment, either on production floors or on mezzanine floors, whereby heat and noise are emitted directly into the convertor room.

Noise emissions and the health issues related to noise emissions are also becoming a more important topic within many industries including sectors within the FMCG industry and as such the invention described herein also provides solutions for significant noise reduction. As commonly known, hearing loss from exposure to noise in the workplace is one of the most common of all industrial diseases and is a key contributor to employee discomfort. Typically, employees can be exposed to a variety of high noise levels within an industrial production process and any exposure to excessive noise levels results in additional stress on employees. Many conclusive studies have been carried out which prove that production line operators operating in a low noise emission environment verses a high noise emission environment experience enhanced levels of concentration, stamina and general health. Furthermore, short-term exposure to excessive noise can cause temporary hearing loss, lasting from a few seconds to a few days with exposure to noise over a long period of time causing permanent hearing loss. Many OEMs producing equipment for the FMCG sector are re-assessing DBA emission targets with typical targets today recently moving from 85 to 83 DBA at 1 meter and would ideally like to reduce sounds emissions to 80 DBA at 1 meter—a target that a standard industrial utility systems typically cannot achieve without additional sound absorption systems being installed. Furthermore, fan system noise emissions are becoming an increasingly discussed topic within the FMCG hygiene industry, with the slow move to SAP only diapers such as Dry-lock in Europe, with the removal of incumbent hammer-mill processes, the main process items left within a diaper production site generating significant noise are typically the fans and their respective drive systems.

Industrial noise exposure can however be controlled with base design concepts typically aiming to reduce the noise at the source which can be achieved through a wise choice of fan, drive motor selection and frame design which typically would include a sound adsorbing fixture to limit sound transmission into the floor and/or mezzanines. The installation of additional sound containing and dampening equipment can also be installed to reduce DBA emissions and utilizing noise reduction concepts used within the building industry by architects aimed to reduce noise transfer between rooms can also be adopted in next generation of utility equipment.

In scenarios where the convertor room is within an HVAC environment, the excessive heat emissions (typically quantified in BTU/hour) from the fans & respective drives can be significant. Typically 34 000-36 000 BTU per hour is emitted by the fan motors alone for every 100 KW of electricity consumed which would requires approximately 3.0-3.5 tons of HVAC capacity to compensate which not only requires additional capital investment into the HVAC plant but also significantly increases on-going HVAC running costs. The total heat emitted by all fan electric drives connected to a baby diaper convertor would typically emit between 60 000 to 120 000 BTU into the production environment, which would subsequently require between 5 to 10 tons of HVAC to compensate. In real life however, when the heat emissions also from the fans are also taken into account, HVAC requirements to offset heat emission from both fans and motors would range between 10-20 tons per baby diaper convertor.

To avoid the above-described utility systems emitting heat directly into an HVAC controlled environment, a typical solution often involves building a separate room wherein typically the fans are installed and in some instances other equipment such as hammer mills are located (this room typically uses a very simple fan system to ventilate air typically directly outside of the factory) which prevents heat migration into the HVAC controlled environment.

Building a dedicated room and/or wall structure within the production area typically has significant disadvantages:
The room in which the utility equipment is housed is relatively large and as such the cost to install is typically high. Such rooms would typically require 75-125 SQMs of wall/ceiling area and due to the heat insulation & sound dampening requirements would typically incur a high $/SQM cost to install.
Due to energy losses in ductwork, typically this room has to be located close to the convertor and placing such a room close to the convertor typically has a negative impact on factory design and in some scenarios has a negative effect on factory efficiency and in some instances has a negative effect on safety as fire escape routes are often compromised.
The room and/or wall structure is typically very inflexible. In cases where convertors are relocated, typically it is not viable to dismantle and re-erect the wall(s) and in most relocation scenarios, the room/wall structure is disposed of, not only adding to project costs but also adding to the overall project environmental loading.
The room and/or wall structure gives an undesired environment within the factory where a single operator can work in an enclosed environment where he/she is not visible to other personnel.

In scenarios where no HVAC is installed, and in particular in scenarios where factories are located close to the equator where temperatures are typically higher, the additional heat emitted to the production area causes a significant rise in factory air temperature, which leads to personnel discomfort and is a key factor in companies where staff attrition rates are high. Often more critical to factory operations, an elevated temperature within the work environment often leads to factories operating with open door policy as this allows air to circulate through the factory and can typically reduce internal temperatures significantly. As a direct consequence, this reduces the factories compliance to typical QA criteria as insect & vermin contamination risk occur can occur and in many industries such as FMCG is common where factories operate with an open door policy.

With an increasingly competitive environment within the FMCG sector and ever growing consumer demands, FMCG producers are focusing more and more on flexibility within their manufacturing operations. Due to the relative high shipment cost of hygiene products verses most other household purchases, setting up a new factories close to the consumer and/or distribution centres are typically desired. Within the European region for instance, when all diaper factories are plotted on a map there is a relatively broad spread of production facilities sited across Europe.

Setting up new production sites and introducing new brands in new regions such as Asia is a complex technical & business task and having flexibility in production operations is often a key to success. Some hygiene companies may even set up initial production in a rented factory and after market introduction, assuming success, may then purchase a larger site and relocate their production equipment to this site. Also, having the capability to easily relocate production assets from site to site to meet consumer demand and even from category to category (for instance from feminine pad convertor to a baby diaper convertor) gives a significant competitive advance to a hygiene producer.

The above scenarios discuss the benefits of relocating utility equipment however, also to be considered in the total relocation cost of equipment from one site to another is the significant costs associated is with the dismantle the re-erection of mezzanine(s) and other equipment support structures and other static equipment which cause many weeks of down time.

In more extreme scenarios in the FMCG hygiene sector where say the sanitary pad market volumes in one region are declining, and where baby diapers market volumes are increasing in another region, an ideal futuristic utility equipment platform would have the capability to be quickly disconnected from the feminine convertor, relocated quickly to the new site without the need for crating and packaging and dismantling, and quickly installed and connected directly to the baby diaper convertor with no significant changes being required to the equipment and no fixed mezzanine structure or rooms/wall requiring relocation.

To improve the above mentioned problems and achieve the above mentioned goals, having a modular plug & play utility system which is made from 1 inherent equipment SKU which is capable of handling a large process window of air volumes which can eliminate heat migration and noise into the factory and can eliminate the need to build site specific mezzanine or wall enclosures would be a major step forward in all industries. Such a breakthrough would not only have cost and flexibility step enhancements but would also be more environmentally friendly verses systems in use today.

Having the flexible solution which can not only be re-deployed across multiple hygiene categories but could also be re-used in other industries would create a new market for second hand equipment (which typically does not exist today as dismantling, transportation, re-build costs are high) and thus prolong typical life expectancy of a utility system, thus, also, having a positive benefit on the environment.

Furthermore, the benefits would not be limited to the producer operating the utility equipment, having a modular “plug & play” concept within the utility equipment would also allow multiple suppliers to start simultaneously on major sub-assemblies and/or modules (a typical production concept used within the shipbuilding industry to significantly reduce lead times) would allow equipment lead times to be significantly reduced. Just as significant as the benefits of moving to a single equipment SKU which significantly reduces operational complexity at the filter manufacturer are the benefits created by being able to store finished filters at the filter manufacturer for enhanced customer response times due to step reduction in SKU numbers.

When new global supply chains are designed in response to the new modular design concepts in the next generation of utility system described herein, key fundamental changes allow step changes in the supply chain to occur predominantly (1)—A modular design allows modules to be made at separate vendors without any single vendor obtaining the drawing package for the total machine i.e. IP risk reduction, (2)—Simplifies final assembly operations, (3)—Allows easy cross shipment of modules between regions to ensure a competitive environment exists within the supply chain. These fundamental changes in the equipment design therefore opens up new opportunities to manufacture in regions where import tariffs are high as well as in regions where lower labour costs to be effectively used.

Net, there are significant benefits in all aspects of the total product life cycle from manufacture through to final user, and/or, second hand user.

A methodology and technical solution achieve these targets are subject of the present invention.

### DETAILED DESCRIPTION

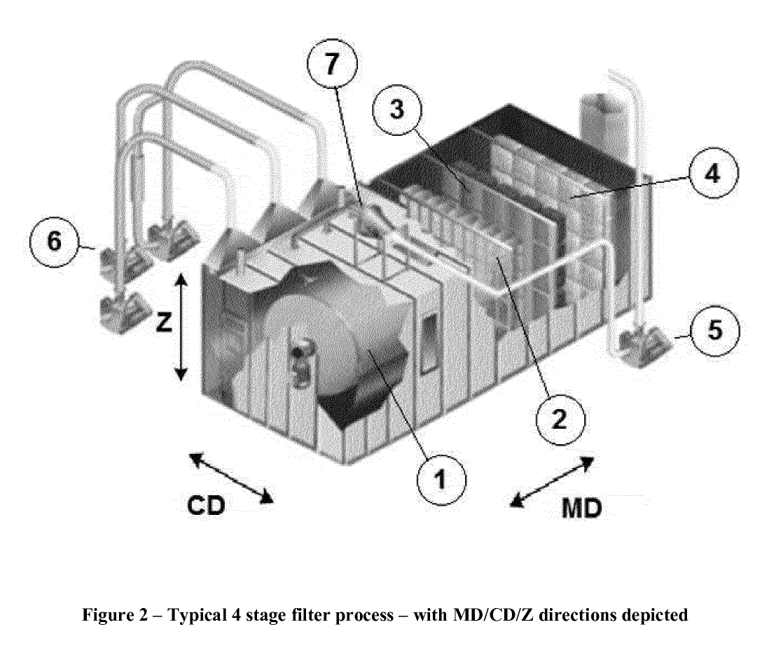

FIG. 2 illustrates a single filter container where (1) represents the stage 1 filter process, (2) represents the stage 2 filter process, (3) represents the stage 3 filter process, (4) represents the stage 4 filter process, (5) represents the nozzle fans, (6) represents the process fans (7) represents the valve system which diverts air to a multitude of nozzles. FIG. 2 also outlined the CD/MD/Z axis, which is used throughout the present description. Z is the vertical, with MD being used to describe the axis of the longest dimension of the container, with CD the width of the container.

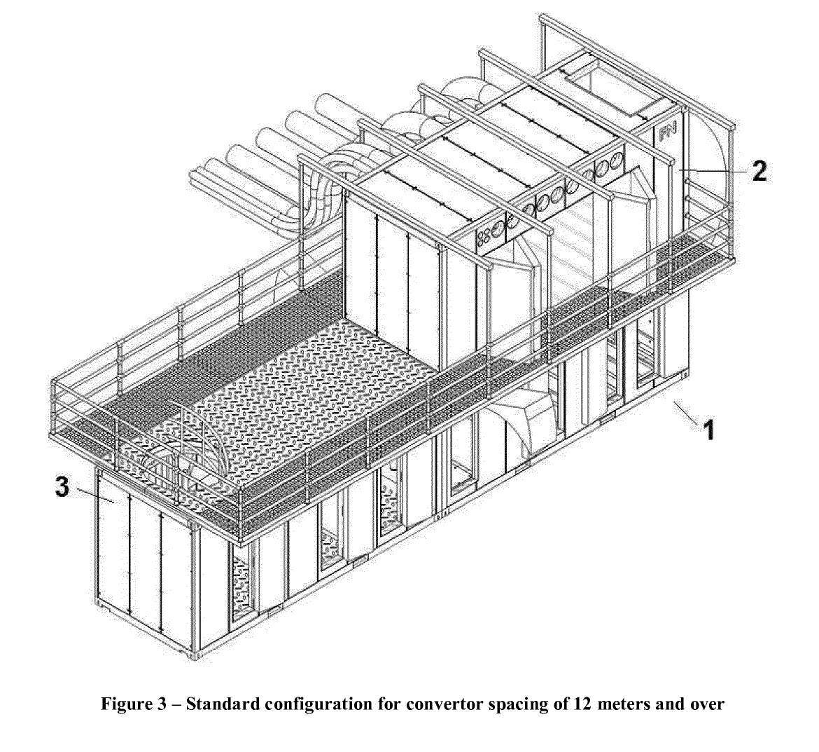

FIGS. 3 & 4 illustrate certain embodiments of a modular plug & play utility system where a multitude of boxes or containers used within the shipping industry are used to house the utility equipment. The term “shipping container” would typically be all sea shipping container formats conforming to standard outline in ISO 668, ISO 1496-1 & ISO 55.180.10, however, as ISO standards are continuously changing, the term “shipping container” described in this invention reference to any container and or box which has the ability to be directly shipped by sea without any significant modification.

The overall utility system is typically made from 3 shipping containers but could be made from anywhere between 1-100 shipping containers, where 1 or more shipping containers 1 are used to house fans and where 1 or more shipping containers are used to house filtration system(s), and 1 or more shipping containers are used to house all ancillary equipment such as cyclones, valves, power & control and even an integrated standardized staircase to reduce installation costs and scope and the FMCG manufacturers. Typically, as shown in FIGS. 3 & 4 a single shipping container would be used to house filtration systems, a single shipping container would be used to house fans, and a single container would be used to house ancillary equipment where (1) is the filter container, (2) is the fan container, (3) is the ancillary container.

FIGS. 5 & 6 illustrate the adding of an additional shipping container (4), which would primarily be used by OEMs to house additional off-line equipment. Installing equipment such as hammer mills and other ancillary equipment such as SAP supply systems within this container will reduce noise and heat emission within the convertor room and also serve as a method to reduce clutter within the manufacturing area. Additional equipment also housed in a shipping container or shipping container framework can also be attached such as air/material separators, briquette, and balers to form a complete system which is discussed herein below.

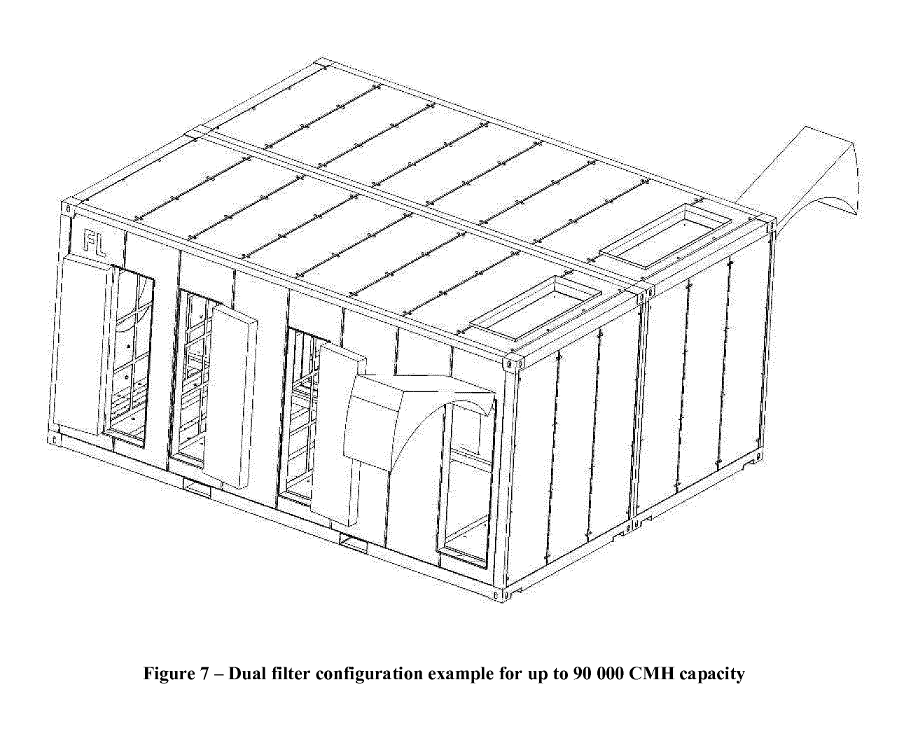

FIGS. 7 & 8 illustrate how filtration-shipping containers can be linked together to increase capacity. With a container having an estimated maximum air capacity of 45 000 CMH but could range between 5 000-100 000 CMH, it is unlikely that a single filtration container can be used for adult convertors and as such, 2 filtration containers can be linked to achieve double capacity. The scenario of increasing filtration capacity by linking containers together can be extend further and could involve any number of containers but would typically utilize between 1 and 100 containers and more typically utilize between 1 and 6 containers. The same concept to increase capacity can also be adopted for the fan container and the ancillary container and the OEM container. The scenario depicted in FIGS. 7 & 8 would typically handle air volumes up to 90 000 CMH.

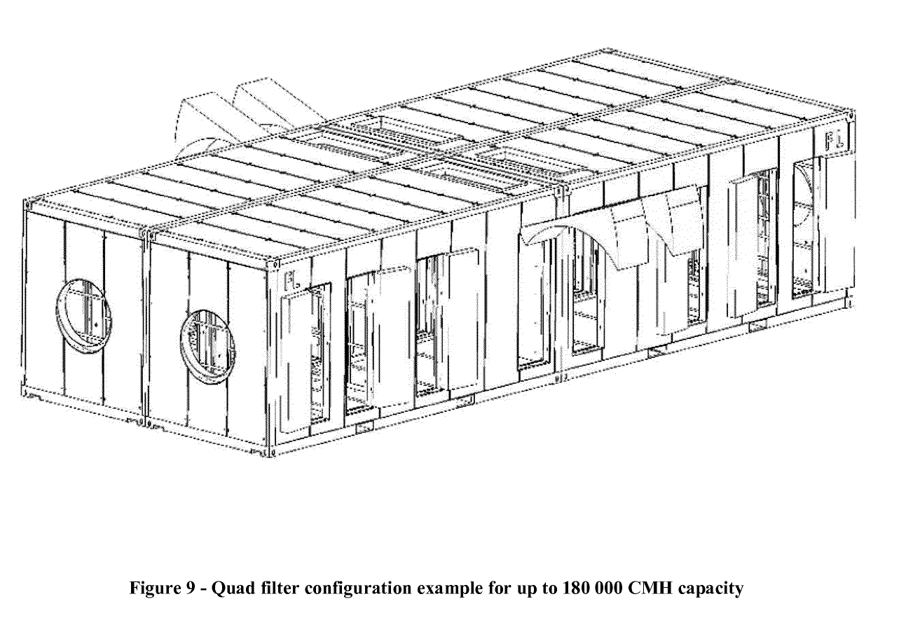

FIGS. 9 & 10 depict a scenario where 4 containers are linked to handle air volumes up to 180 000 CMH. The container design allows a total operation to be conducted if access is limited to one side only, and, as such, in this scenario the containers are positioned together in a 2×2 layout format. If desired however, the containers could be installed with a walkway or similar gap between them.

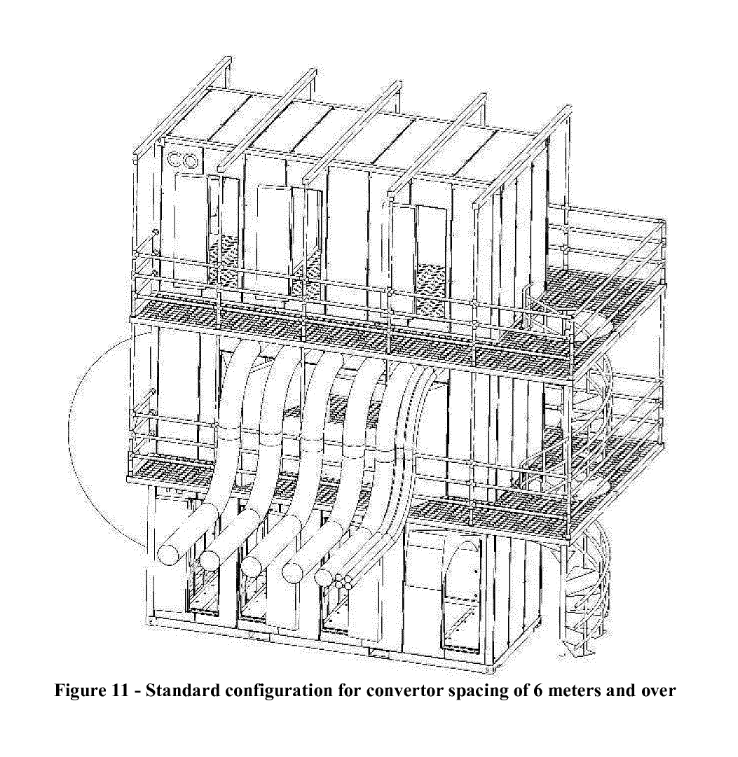

FIGS. 11 & 12 illustrate how shipping containers can be stacked in a vertical position to reduce space at the hygiene manufacturer's site. In this diagram a filter, fan and ancillary container are connected and would be ideal for a site where floor space is limited and/or, convertors are positioned close to each other as this scenario can accommodate a convertor spacing as low as 6 meters which can be directly coupled to the convertor(s) without the need for a significant ducting installation.

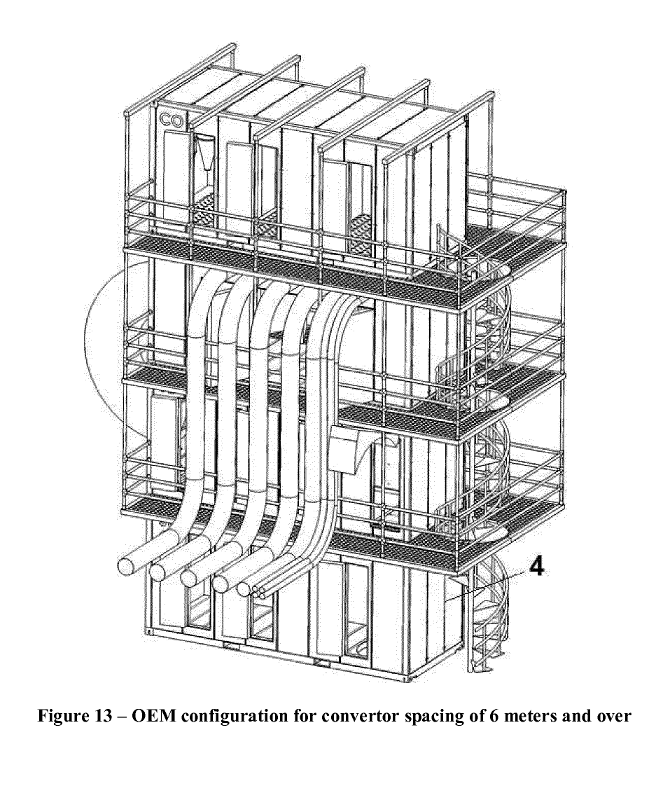

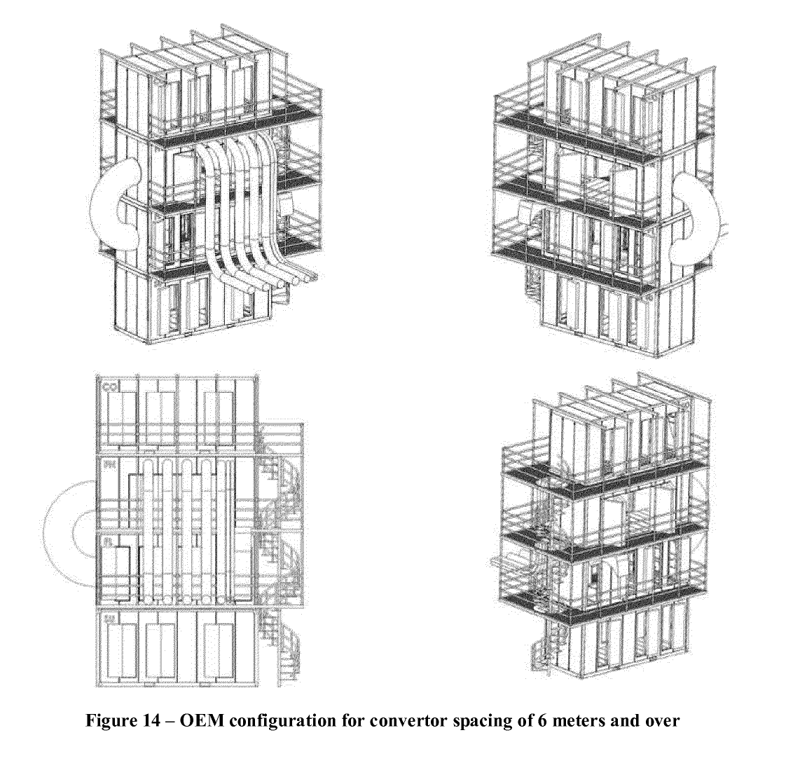

FIGS. 13 & 14 illustrates how shipping containers can again be stacked in a vertical position to reduce space at the hygiene manufacturer's site. In this diagram a filter, fan, OEM (4) and ancillary container are connected with the OEM (4) container being installed at ground level to gain quick access to hammer-mill and SAP supply equipment when required.

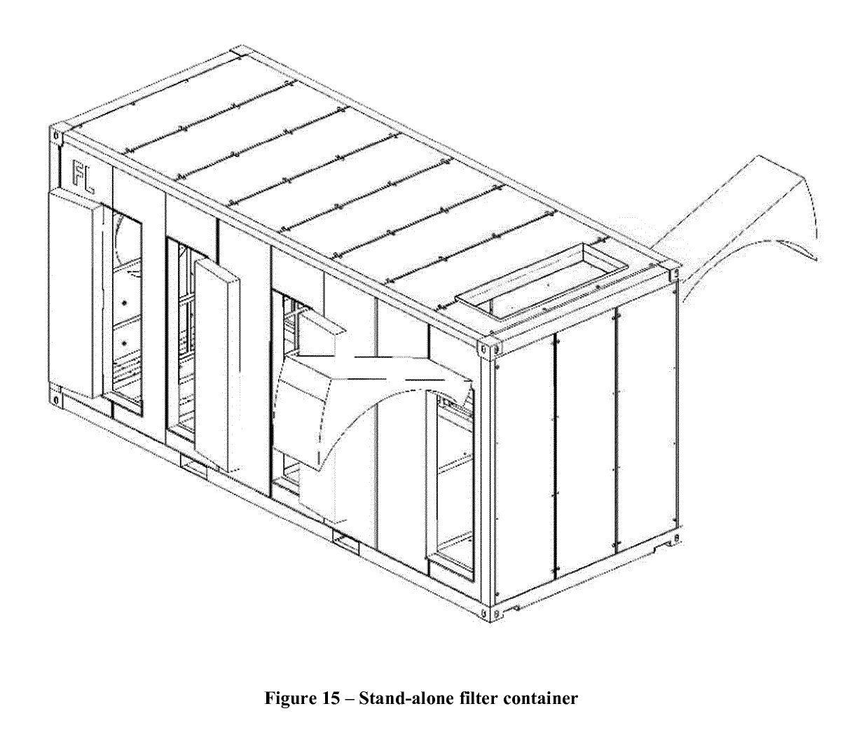

FIGS. 15 & 16 illustrates the concept of a single filter container which can be supplied as a stand-alone system typical to a filter system today, which can be linked to a separate fan system with power and controls and other ancillary items being installed nearby or, actually attached to the container itself.

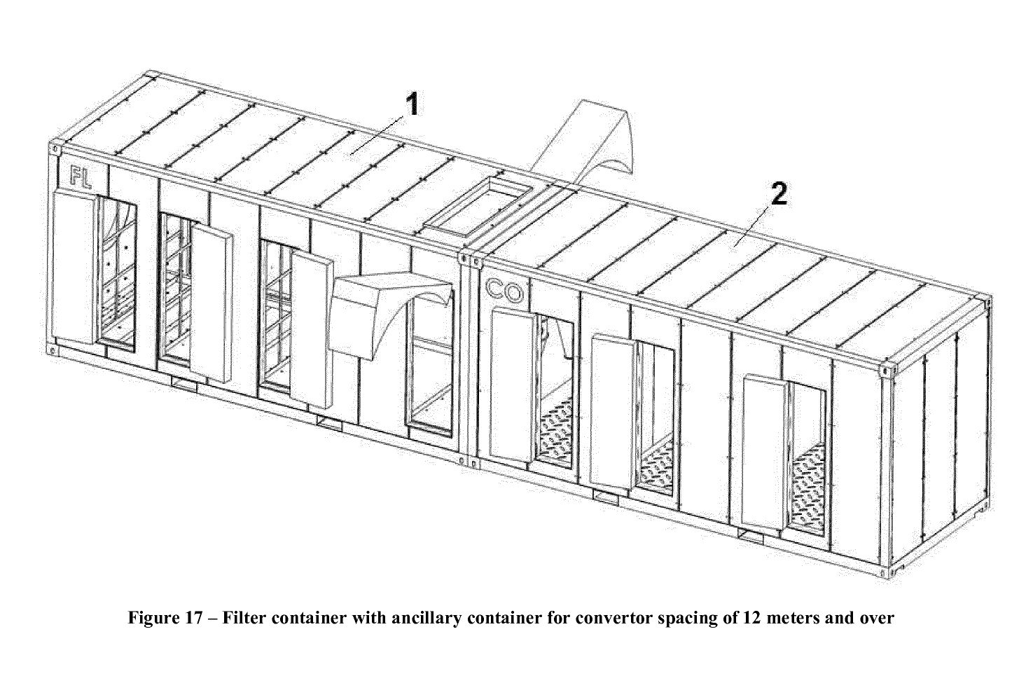

FIGS. 17 & 18 illustrates the concept of a single filter container (1), which can be linked to a separate fan system (not shown) with an attached ancillary container installed (2).

FIGS. 19 & 20 illustrates how a bolt on roof concept (1) (optional extra) which can be attached to the shipping container to allow for outside use. The containers can essentially be used outside without the addition of any roof structure however due to rain run-off and contamination build up, the additional of a dedicate roof structure is preferred.

FIGS. 21 & 22 illustrates the addition of an extra wall structure (1) (optional extra) attached to the shipping container to allow for outside use in more extreme weather environments.

FIGS. 23 & 24 illustrates a side-by-side stacking format with (1) being the fan container, (2) being the filter container, with (3) being the ancillary container, with (4) typically having a blanking plate in this location as exit from fan container is via the side. This scenario would be ideal for a site where floor space is limited and height is limited and/or, convertors are positioned close to each other as this scenario can accommodate a convertor spacing as low as 6 meters which can be directly coupled to the convertor(s) without the need for a significant ducting installation.

FIGS. 25 & 26 illustrates how 6 meter shipping containers can be stacked end on end where the ancillary containers (1b) & (2b) are stacked on top of each other each one supplier their respective filter system (1a) & (2a). This gives a total solution and reduces space at the hygiene manufacturer's site as spacing between convertors can be as low as 6 meters & 12 meters. In this solution, as the containers are positioned end on end with no walk-way between, ducting connecting the fan container with the filter container is passed through the floor area where the internal staircases is typically positioned (3) and as such, an external staircase (4) is required.

FIGS. 27 & 28 illustrates how 6 meter shipping containers can be stacked end on end where the ancillary container (1) are stacked on top of the OEM container (2) and reduces space at the hygiene manufacturers site, as spacing between convertors can be as low as 12 meters. In this solution, the holes in container are also used for the staircase is used to pass ducting from fan to filter container and as such addition external staircase system(s) are required (3).

FIGS. 29 & 30 is assembled to the same specification as FIGS. 27 & 28, but illustrates for solutions which require a mixed convertor spacing above 12-meter line spacing how the hanging mezzanine walkways can be extended and linked (1) and where internal staircases can be used (2).

In the present description a total of the 13 common stacking configurations have been reviewed however in total, there are over 248 configuration possibilities giving a substantial range of options for the total utility system to be assembled. Ultimately the customer can decide on the preferred scenario to maximise space utilization at customer sites & operator accessibility.

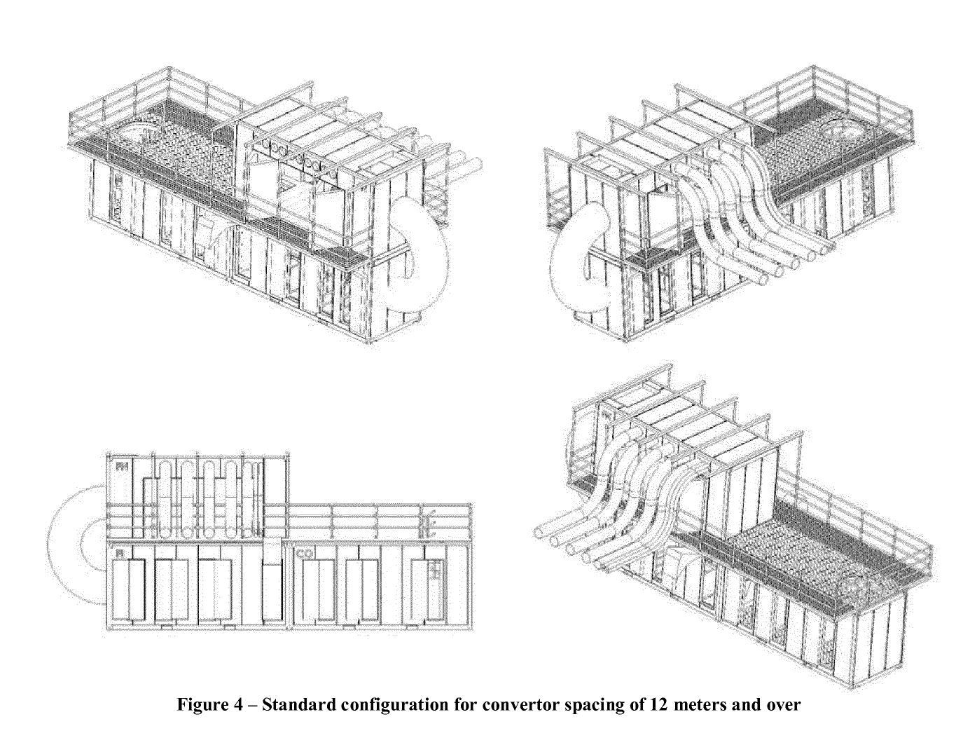

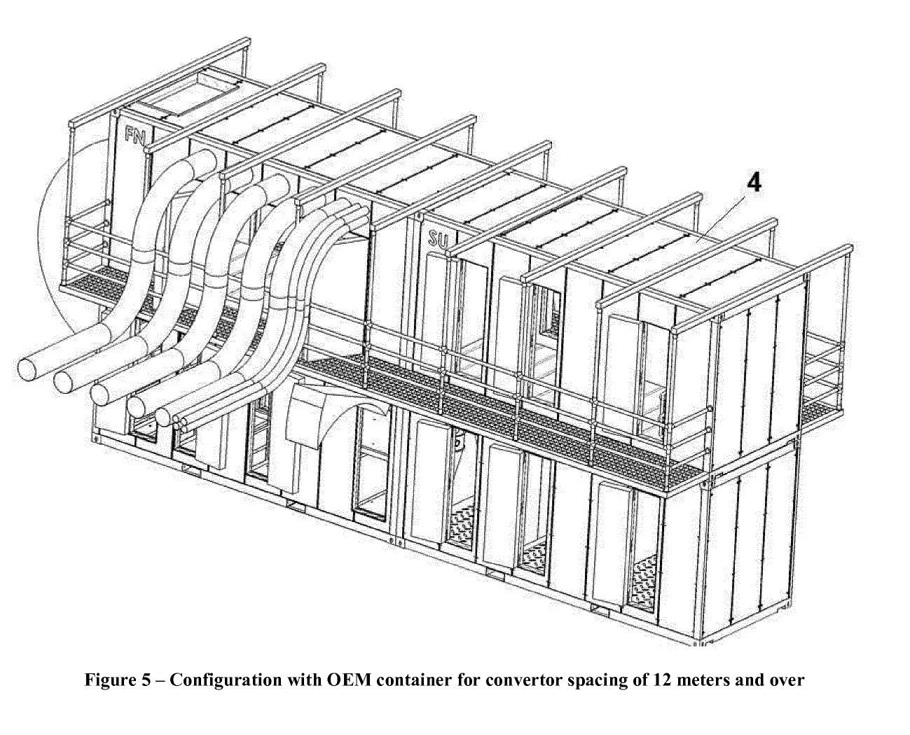

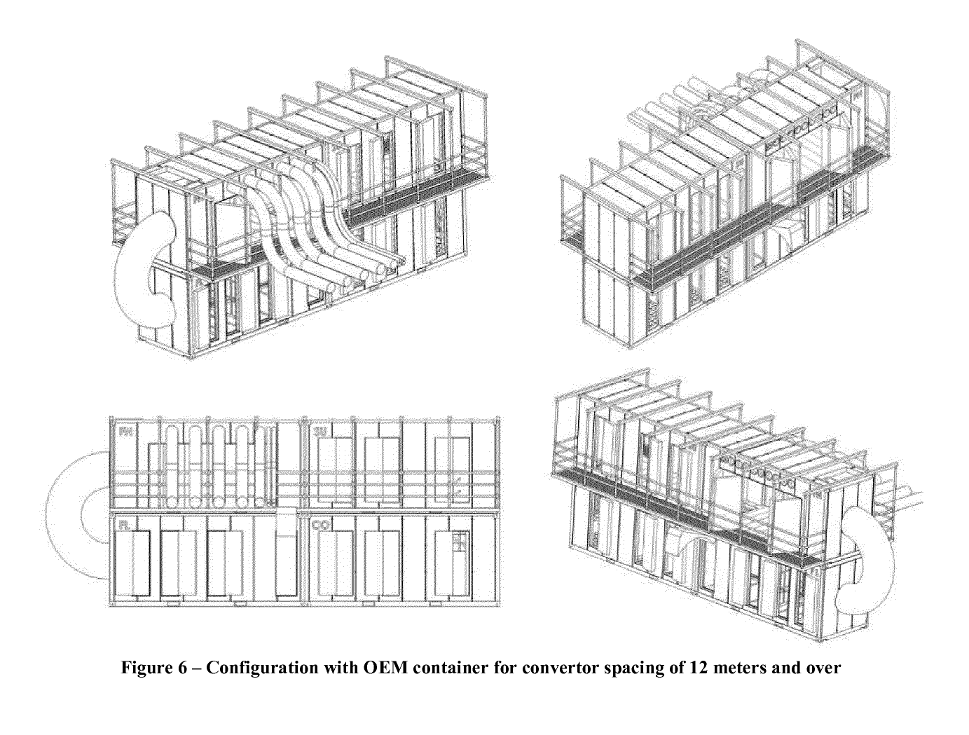

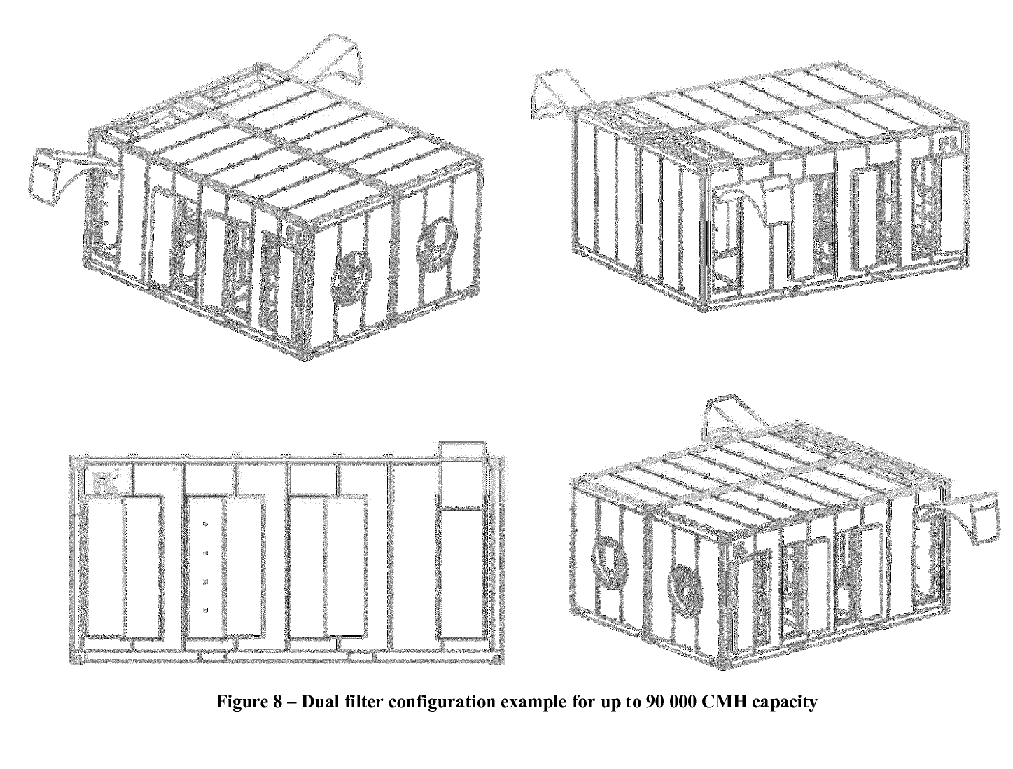

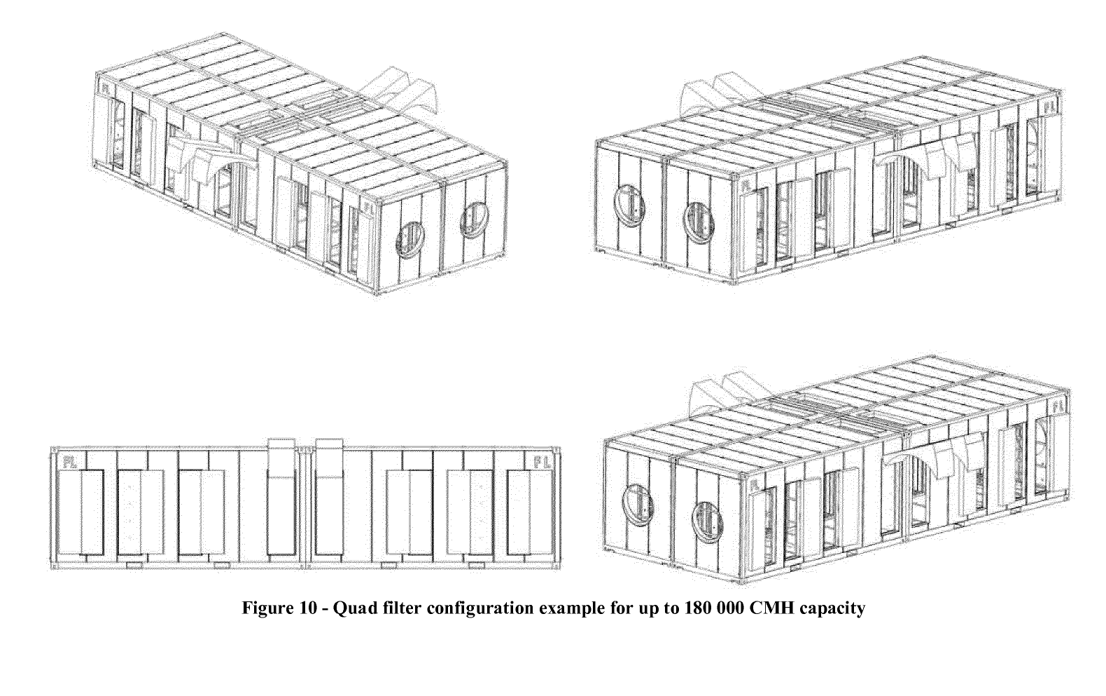

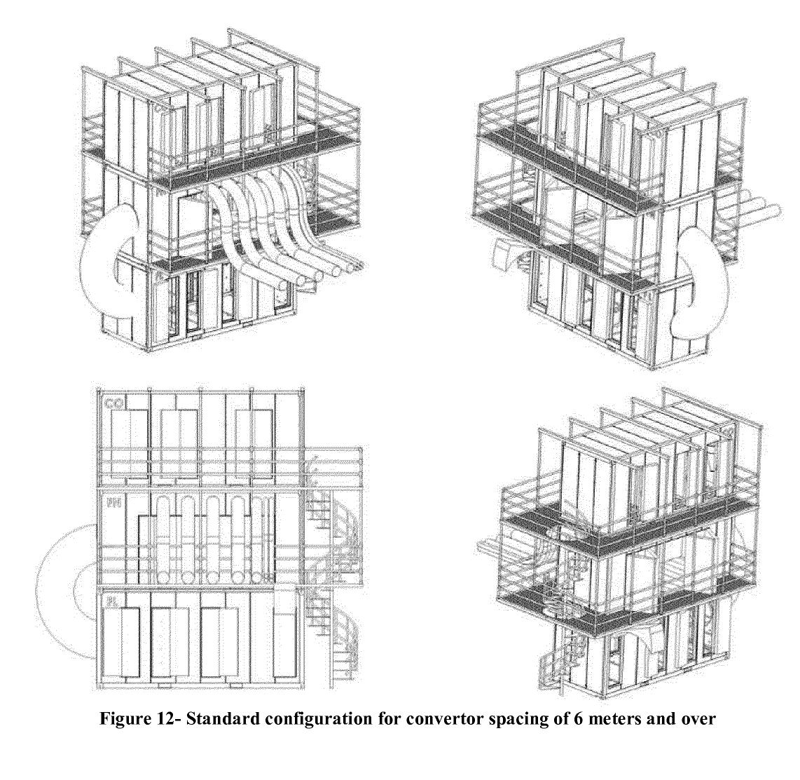

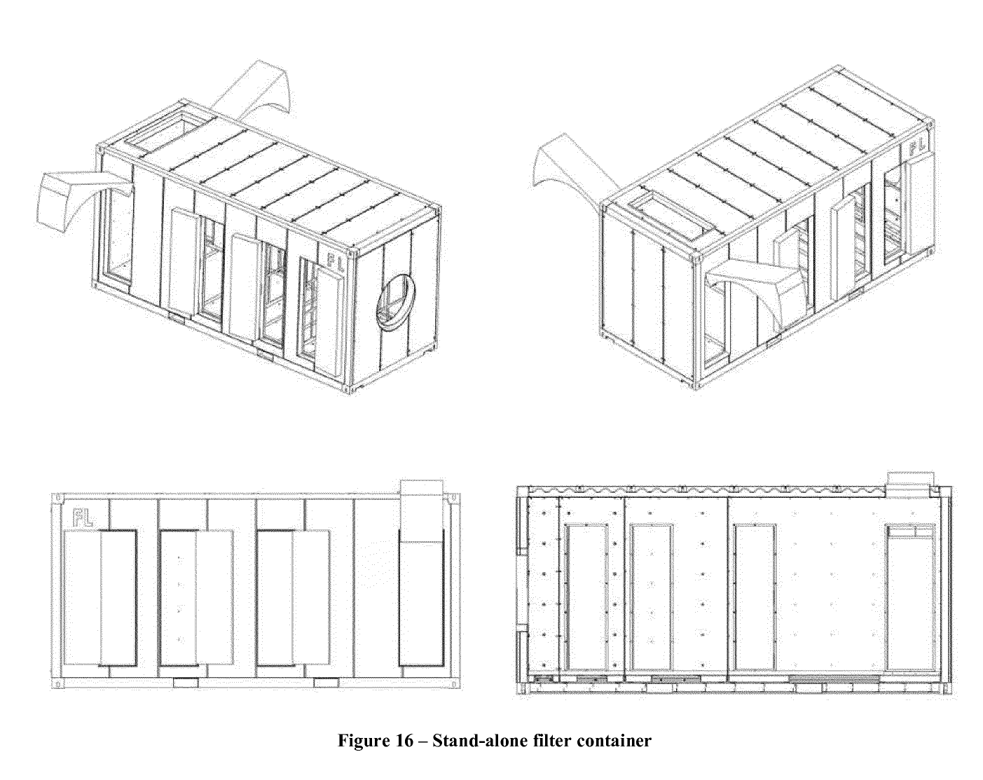

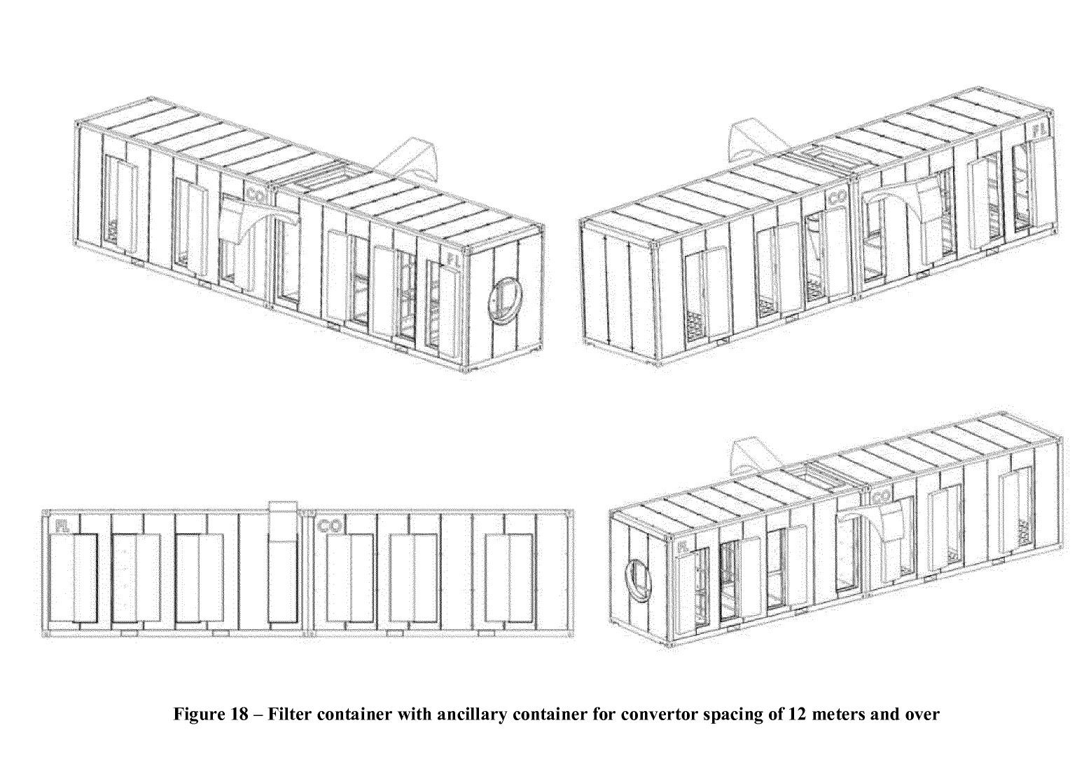

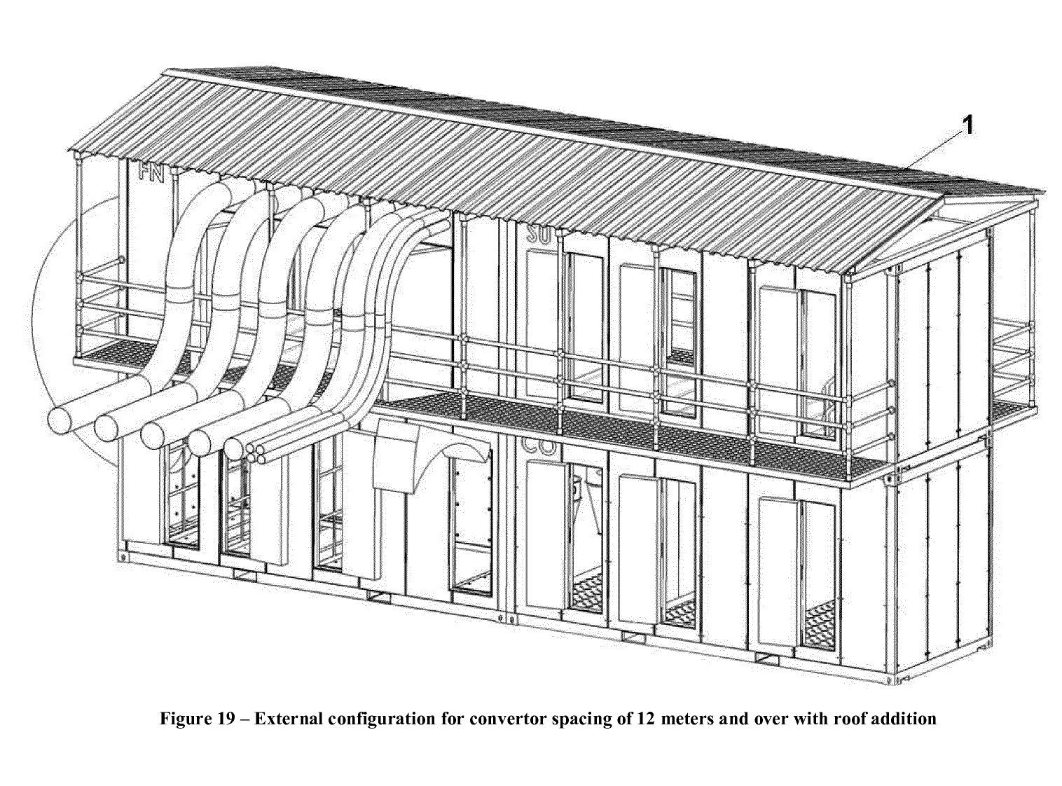

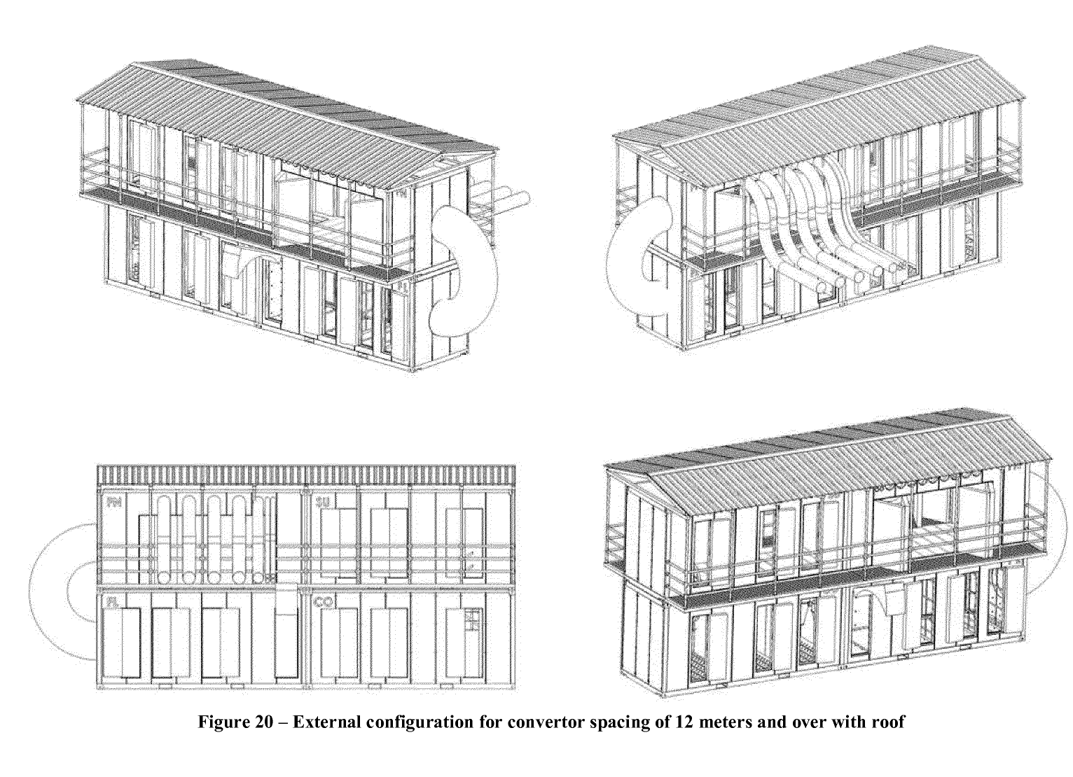

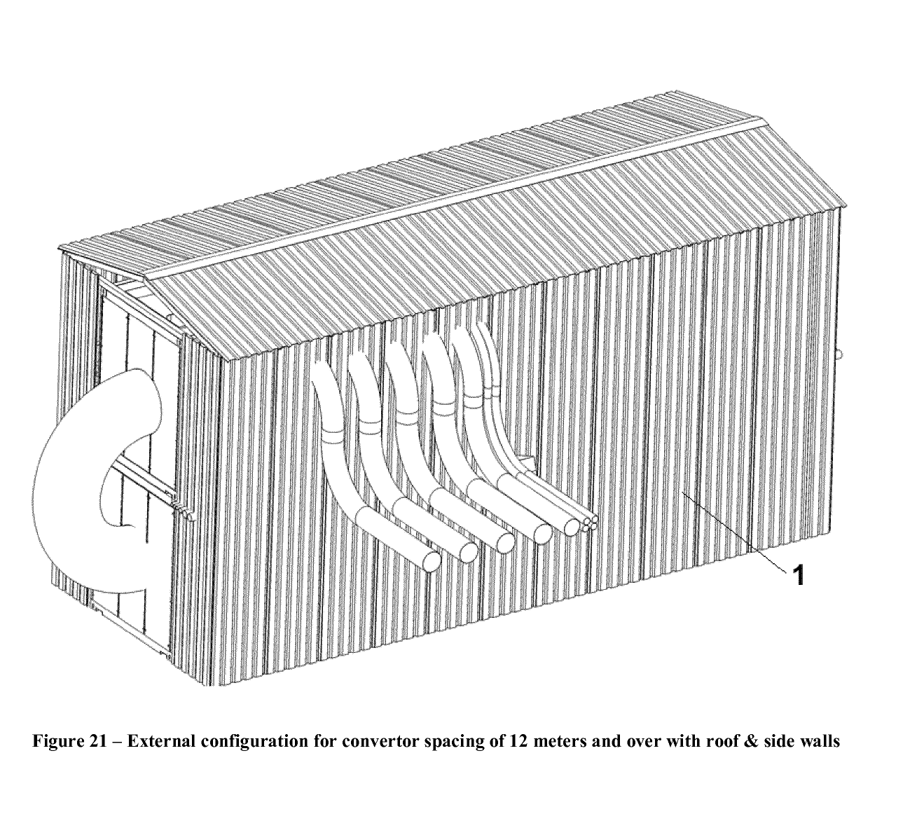

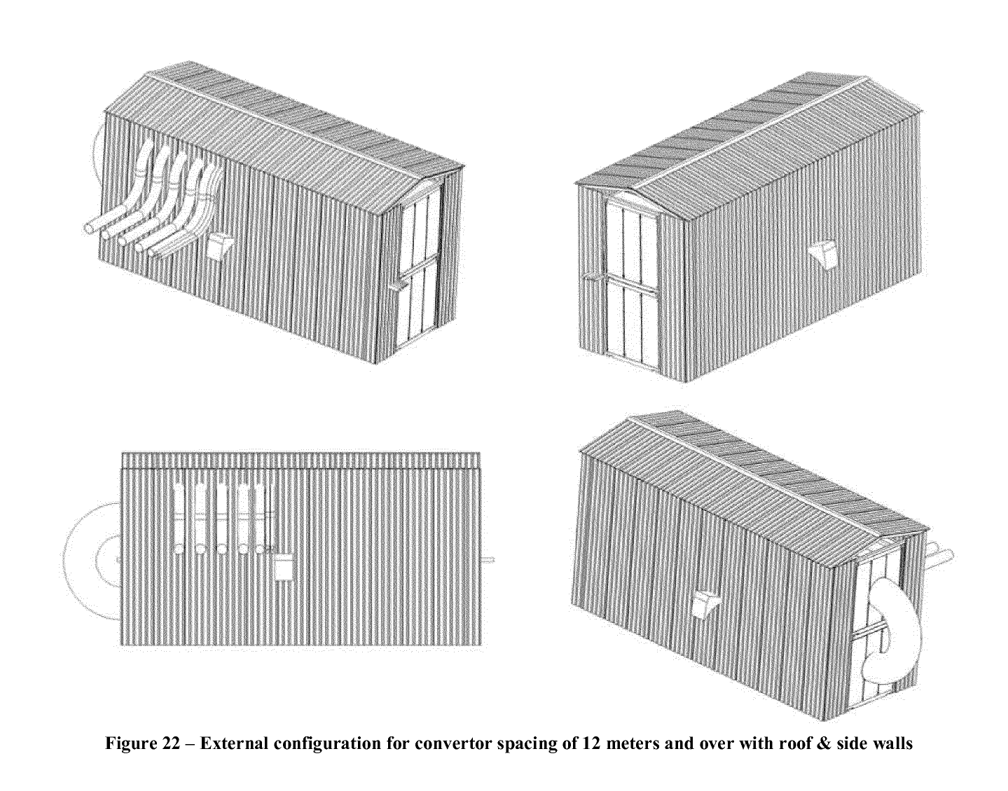

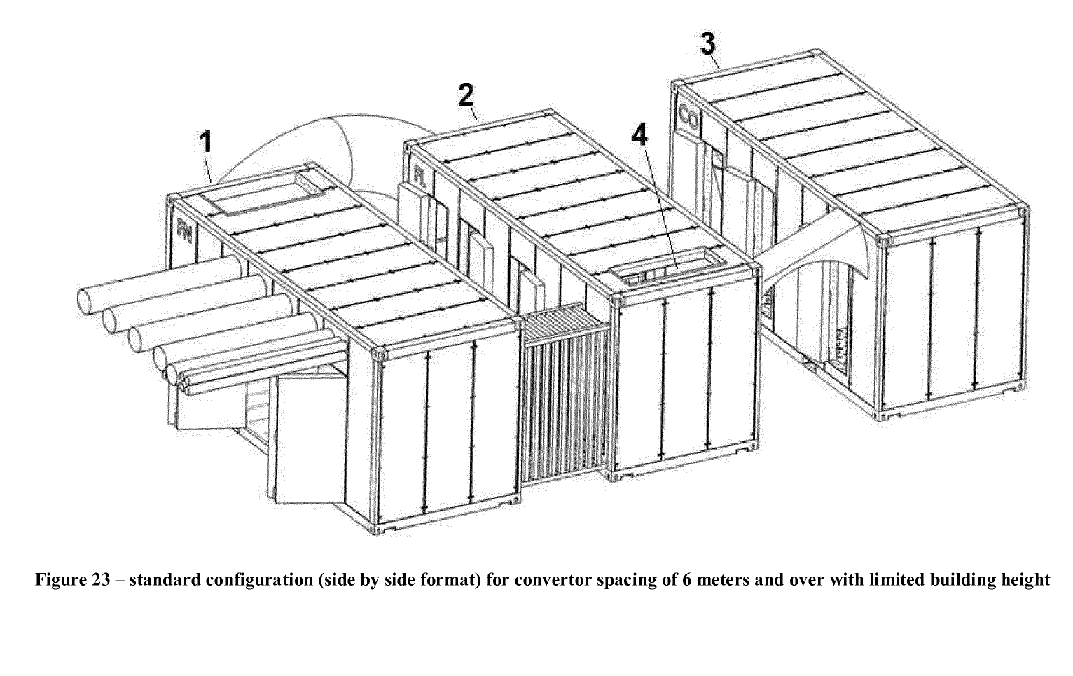

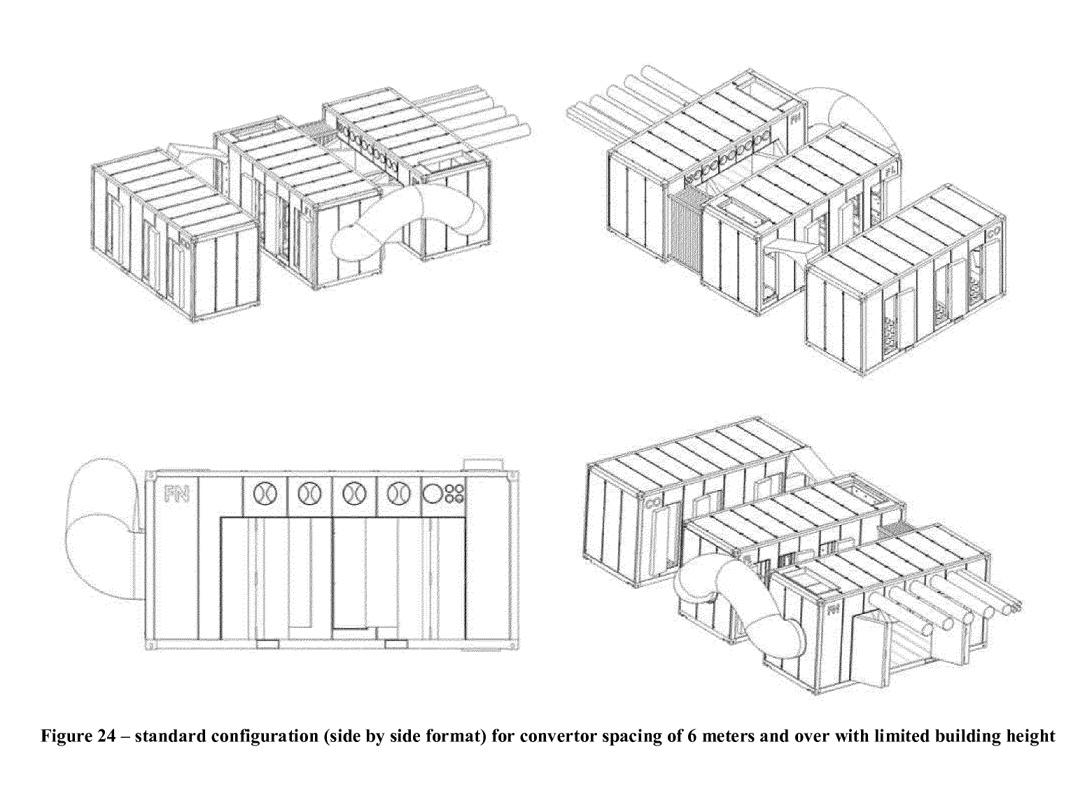

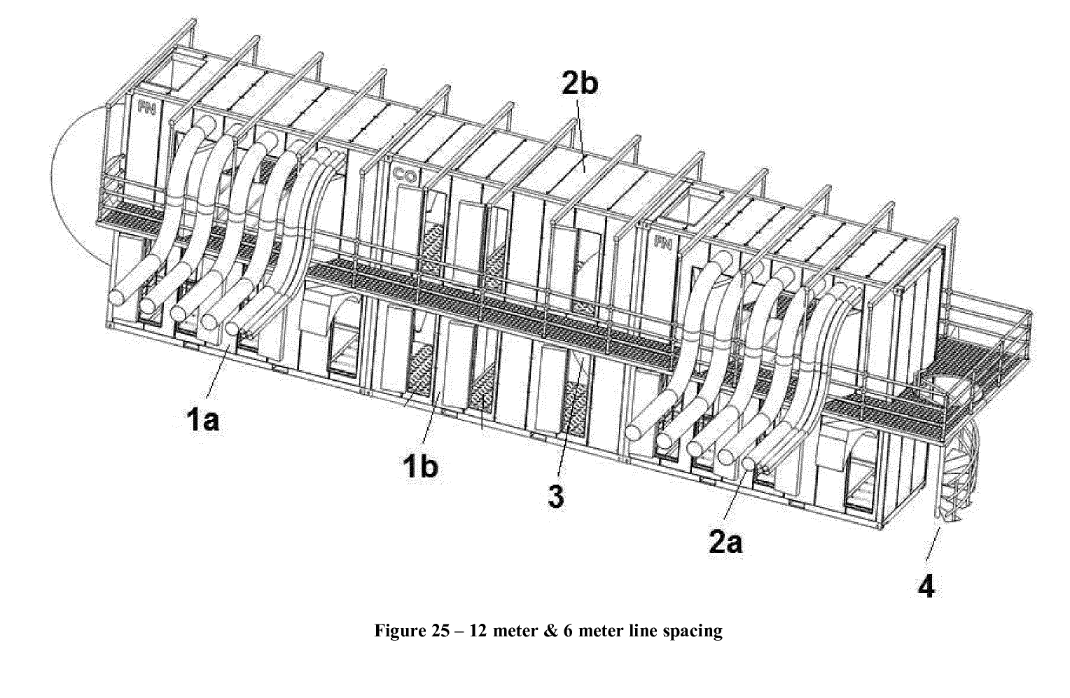

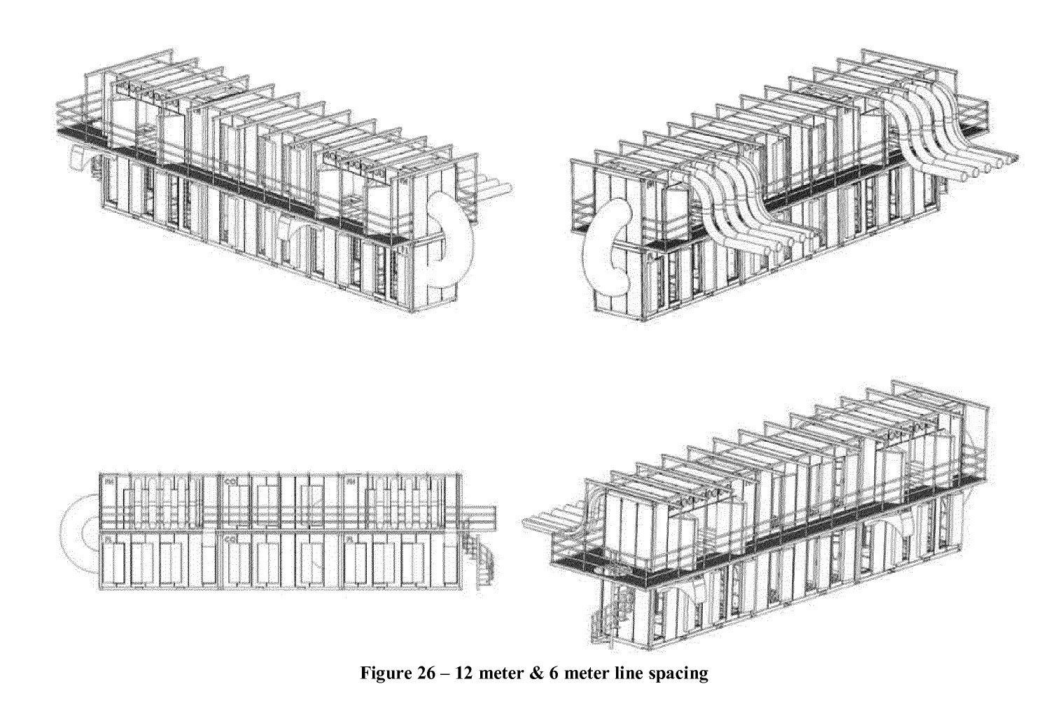

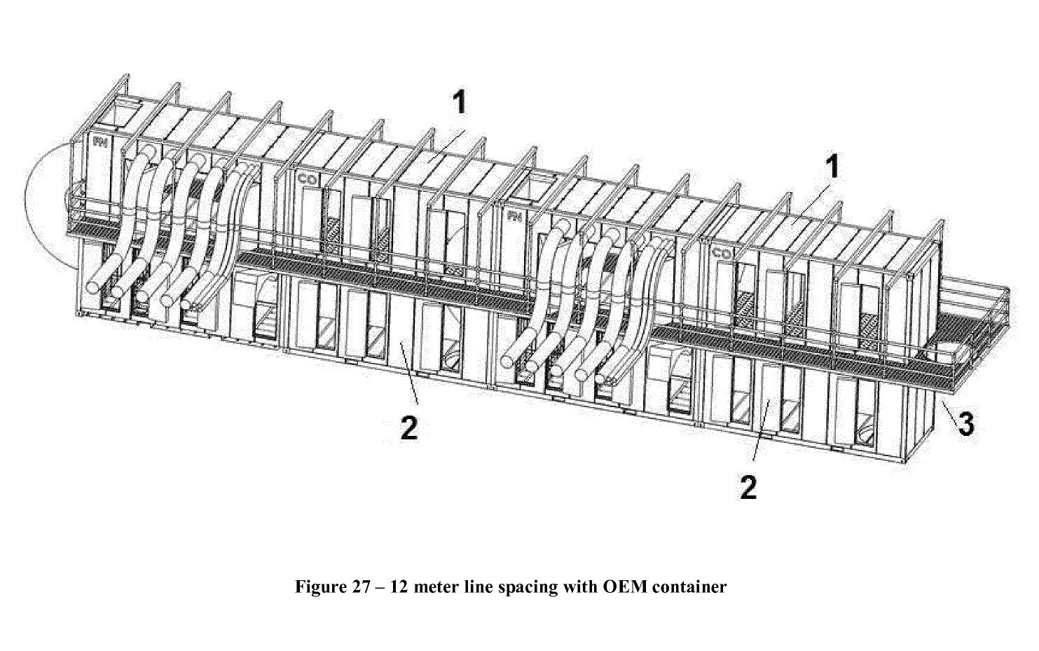

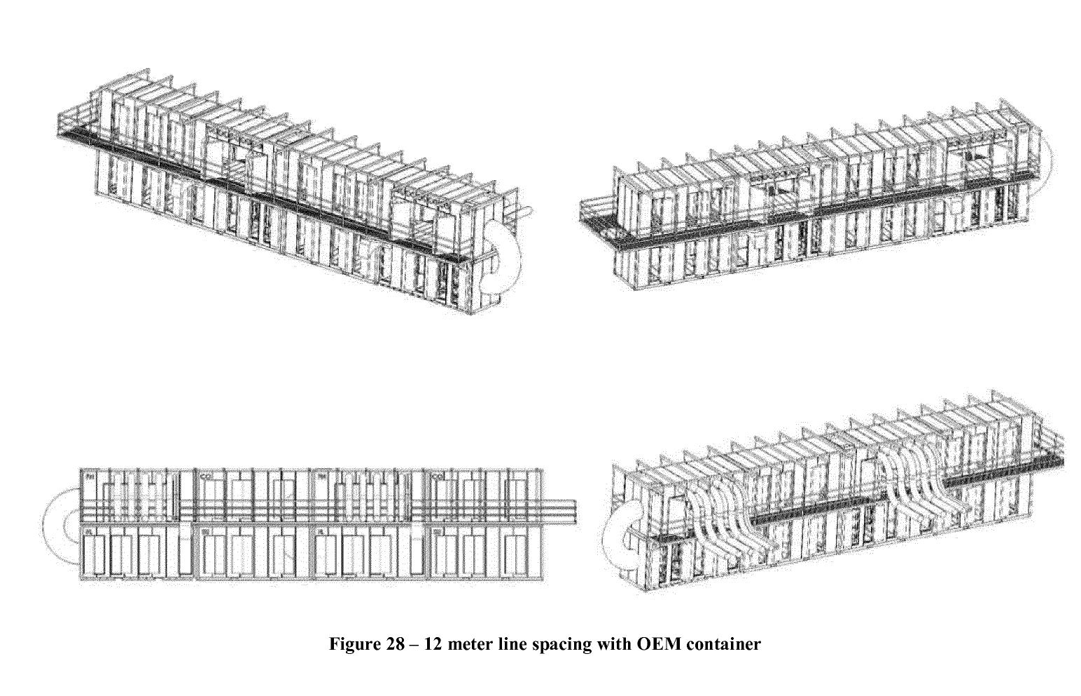

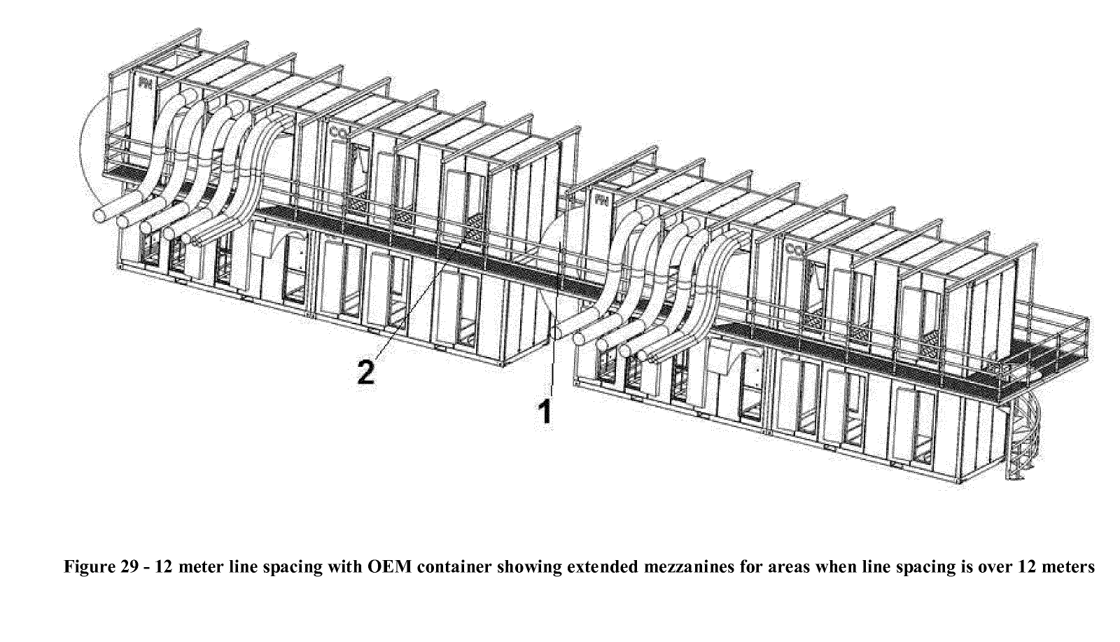

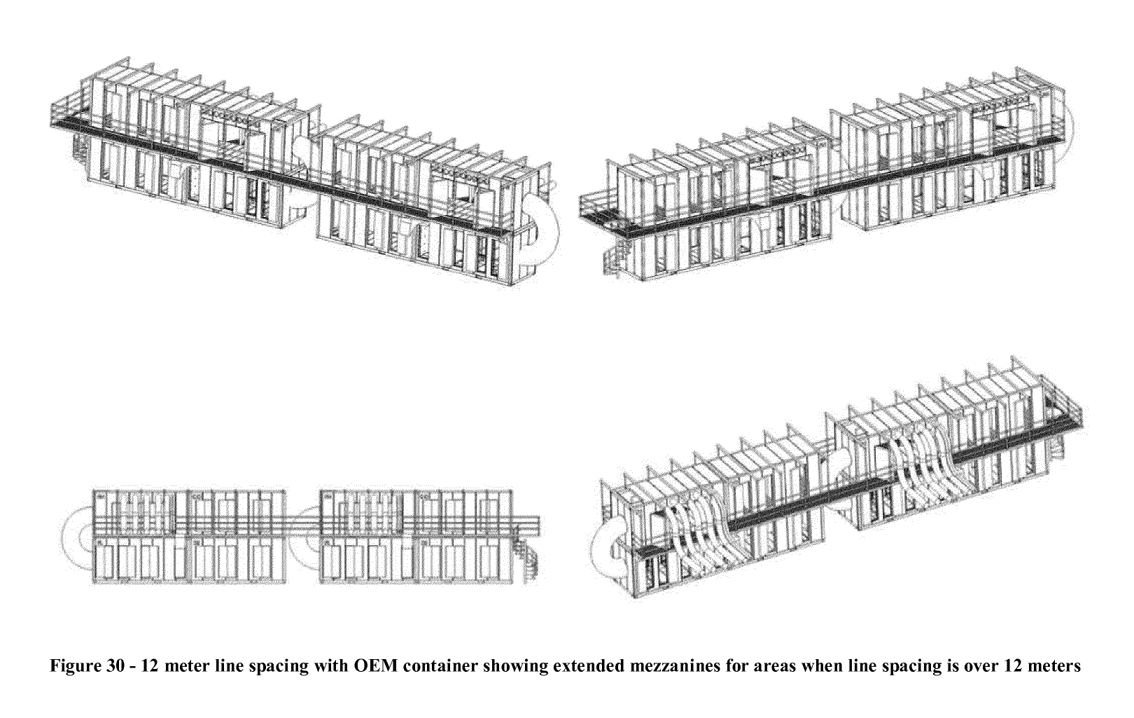

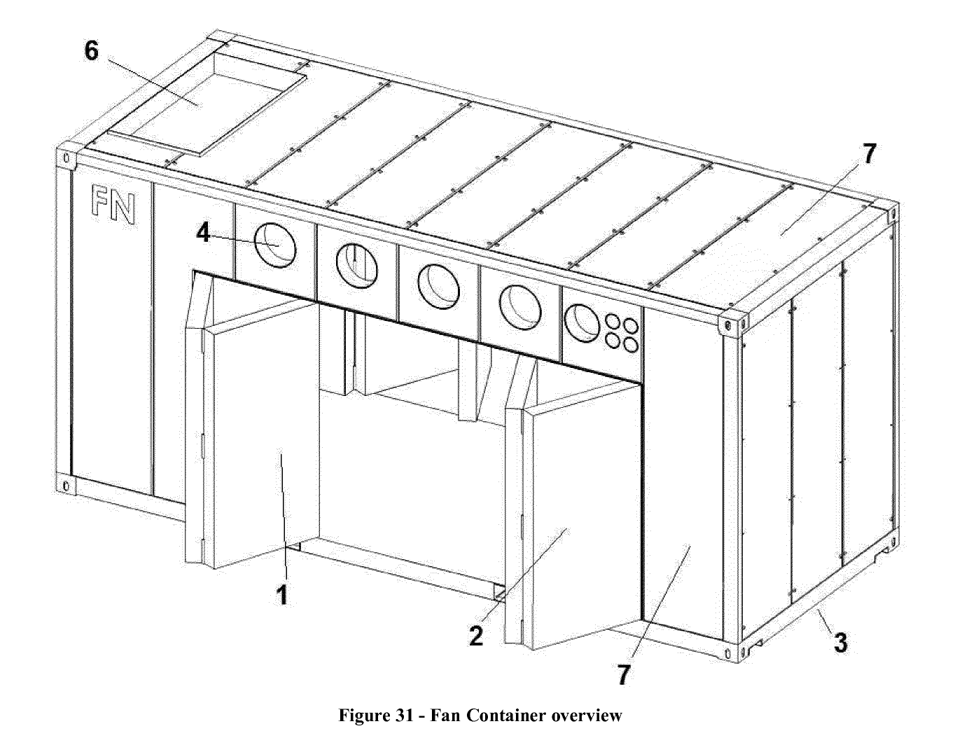

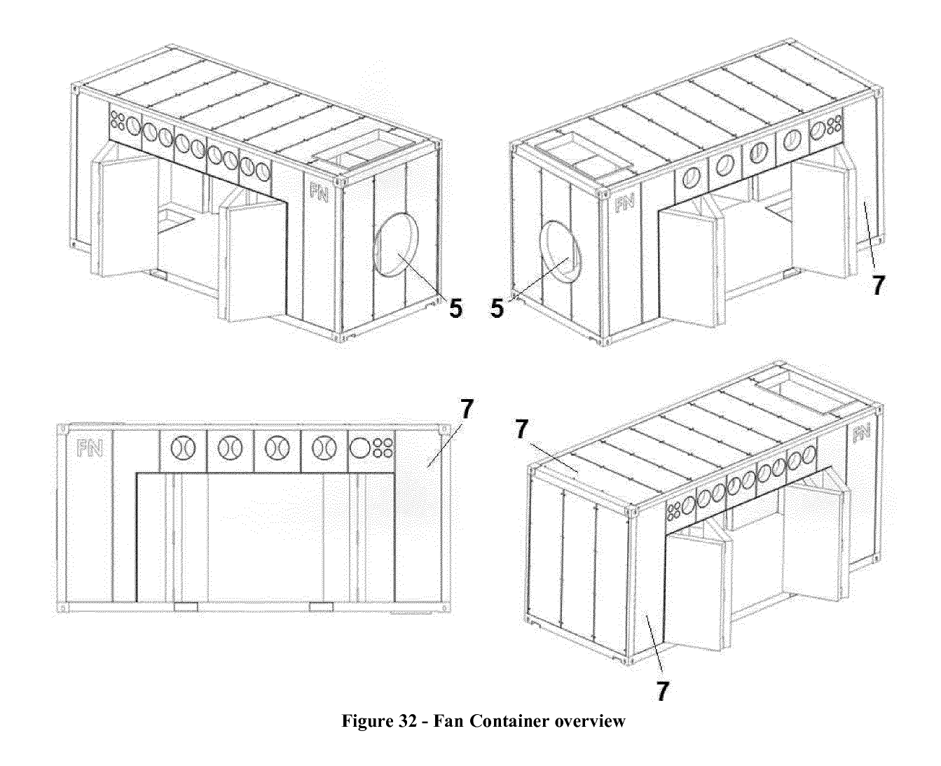

Key attributes of the embodiments related to the utility system are outlined as follows:
1. 5000-45 000 CMH process range via media replacement only.
2. 20 ft High cube container based however system could utilize any ISO 668, ISO 1496-1 & ISO55.180.10 specified container or and shipping container format or any object which could be as a shipping container with no or little modifications required.
3. Start up within 24 hours with 3 FTEs/shift.
4. Accelerated start up within 1 shift with 9 FTEs.
5. Stacking options for Filter/Fan/Control/OEM as outlined in FIGS. 3-30 but could include a further 248 layout combinations.
6. 85 DBA emission level @ 1 meter.
7. Fan can accommodate all OEM fan scenarios for fem & baby diaper scenarios.
8. Option for both air-cooled and water-cooled motors.
9. OEM/supply container only for OEMs wishing to house mill & SAP off-line.
10. Camera supervision.
11. Standard wiring looms for each container compatible with all stacking options.
12. Internet package for off-site supervision.
13. New Eco interface with convertor.
14. Modular-assists global sourcing strategy and upgradable with low tech resources.
15. Standard options for Siemens/Allen Bradley/Mitsubishi power & controls however this can be expanded to any provider upon request.
16. Designed/available interface for container HVAC & power generator container.
17. Spare capacity in for extra fans & extra cabinets.
18. Option for AFF none return cartridge filter or cyclone.
19. Upgrade capability through the linking of additional containers in order to protect for large air requirements such as adult care convertors and tissue convertors.
20. High air speed in area 1 to eliminate dust build-up on floor.
21.

The above mentioned design criteria is specified to handle up to 45 000 CMH of air flow, but this could range between 1 to 100 000 CMH of air flow and offers a standardized equipment SKU however, according to other embodiments of this invention, the container can have additional equipment options installed within the container to meet customer requirements similar to the concept of buying a car and choosing from optional extra at time of purchase. Typical bolt on options could therefore include but not be limited to:
1. Media insert package A up to 5 000 CMH
2. Media insert package B up to 10 000 CMH
3. Media insert package C up to 15 000 CMH
4. Media insert package D up to 20 000 CMH
5. Media insert package E up to 25 000 CMH
6. Media insert package F up to 30 000 CMH
7. Media insert package G up to 35 000 CMH
8. Media insert package H up to 40 000 CMH
9. Media insert package I up to 45 000 CMH
10. SAP only core upgrade package (no nozzle dust re-feed).
11. Hanging mezzanine with either internal or external staircase options.
12. Sound package A=83 DBA. B=80 DBA C=75 DBA (all DBA @ 1 meter).
13. Out-door package including waterproof E&I, roof, & insulation.
14. Additional outdoor package encompassing wall scope.
15. Stainless steel interior, and/or stainless steel exterior panels.
16. Floor sweeper in stage 2 and or stage 3 entry zone.
17. Additional cameras for off-site supervision.
18. Customised exterior graphics.

Specific Attributes of the Embodiments Related to the Fan Container:

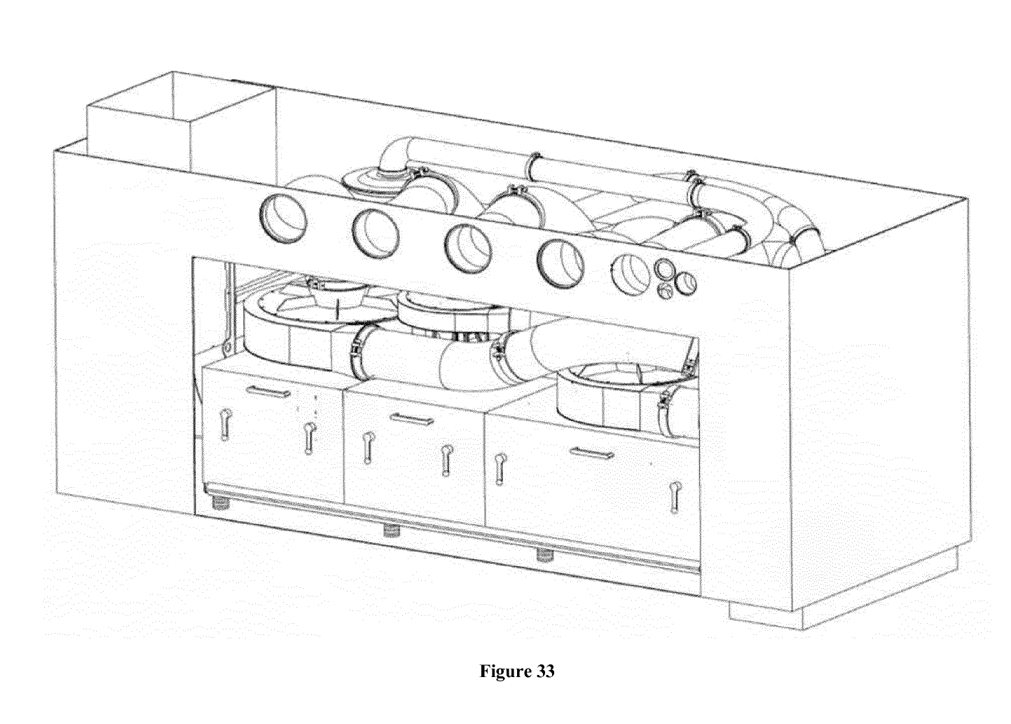

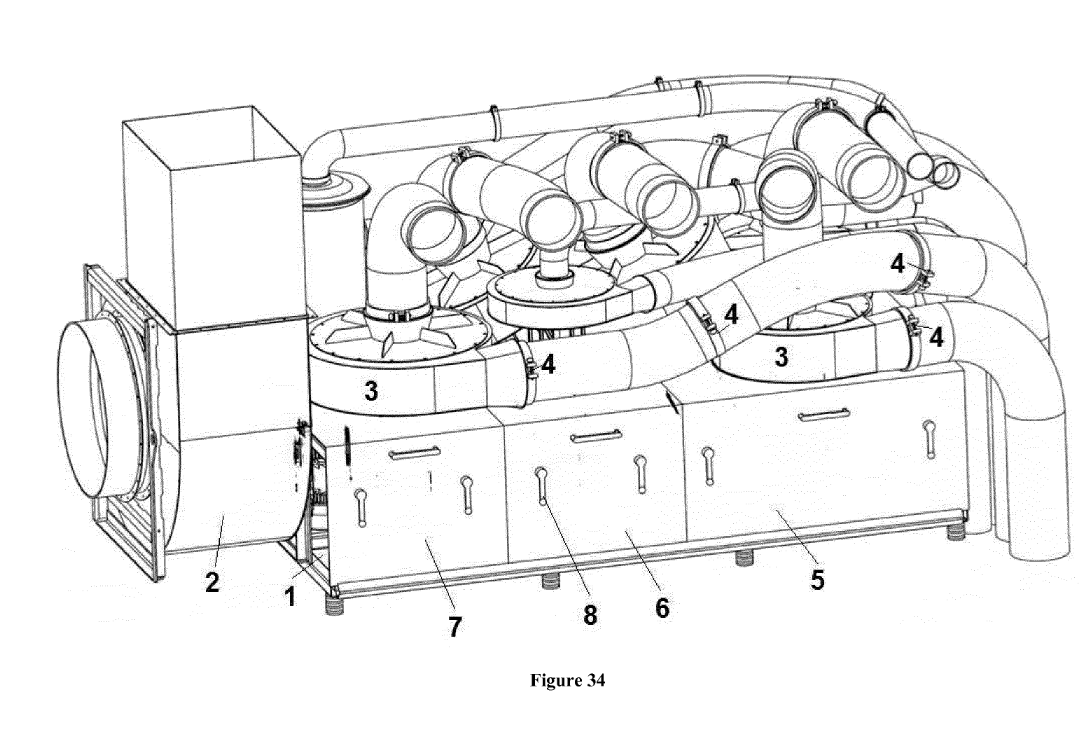

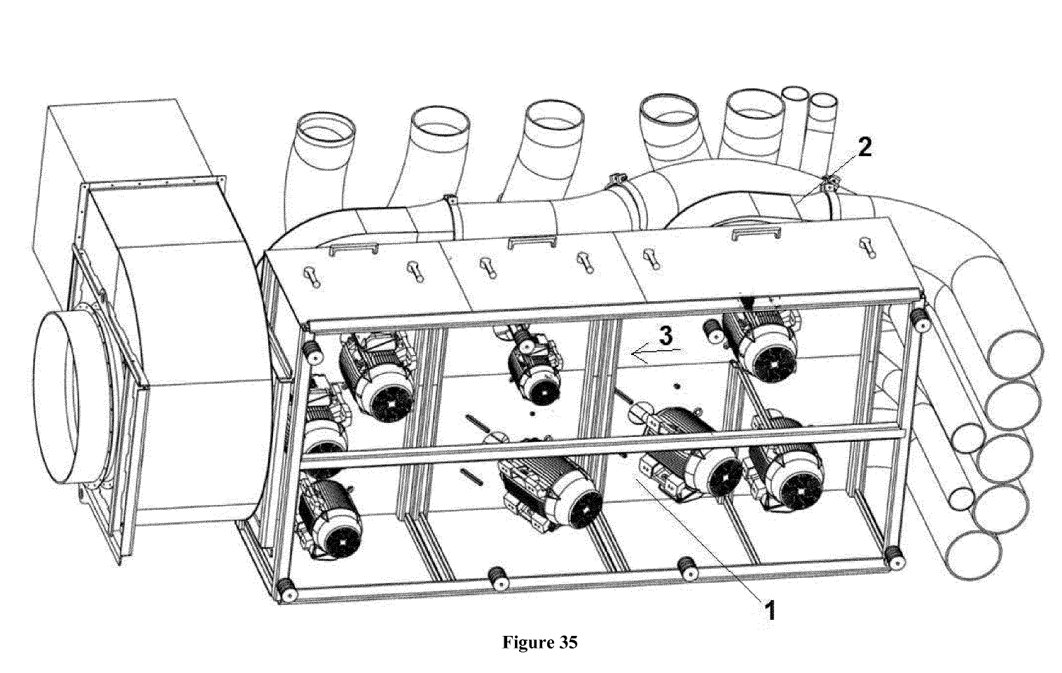

FIGS. 31 & 32 illustrate certain embodiments of a fan shipping container of the overall modular plug & play utility interface where a multitude of boxes or containers used within the shipping industry are used to house the utility equipment. The term “shipping container” would typically be all sea shipping container formats conforming to standard outline in ISO 668, ISO 1496-1 & ISO 55.180.10, however, as ISO standards are continuously changing, the term “shipping container” described in this invention reference to any container and or box which has the ability to be directly shipped by sea without any significant modification. Large doors are included on the side of the container to allow access to the fans shown in (1) & (2). Additional openings exist as shown in (3) where fans outlet air (underside), (4) inlets where air is sent into the container, (5) where main system fan air inlets the container, (6) where main system fan exits the container, (7) where outlet ducting can also be positioned for subsequent entry into filter container. FIG. 33 illustrates an overview of the internal components of a fan container in more detail with the boundaries of the inner container wall being shown. FIG. 34 shows the internal equipment with no boundary wall where (1) shows the drive motor location, (2) shows the main fans (3) shows the process fans, (4) shows quick release connections (5),(6),(7) shows insulation walls combined with sliding draw sections, (8) shows latches to secure draw in place. The internal room of the container is split into 2 separate zones, with the lower zone shown in FIG. 35. The fans systems are positioned so that the fans are located in the upper zone (2), and the motors are positioned so they are housed in the lower zone (1) with typical air flow direction shown in (3).

The heat management requirements are different from the fan zone verses the motor/drive zone and as such, housing these components in separate zones has significant advantages.

The fan components housed in the upper zone are essentially very robust equipment components and can run in elevated temperatures without incurring any damage. The only component that is susceptible to damage whilst operating at higher temperatures are the bearing components, however, if the bearings are specified taking into account the higher temperatures, then, no reliability issues will occur. Under the scenario where the fans are installed in a confined space within the container and a large amount of heat and sound insulation is added, typically heat build-up within the zone would create an issue, however, air passing through the fan system acts as a cooling medium and essentially cools the fan system. In the instance where for example factory air temperatures are 25 degrees centigrade, which is being sucked through the convertor, in many instances, by the time the air, reaches the inlet area of the fan, the air temperature could have been elevated to 31 degrees centigrade. The air is again heated within the fan and may exit the fan at 34 degrees centigrade. Certain components of the fan such as the fan housing, may be at a higher temperature, say at 42 degrees centigrade, however, as the air passing through the fan does not exceed 34 degrees centigrade, the air passing through the fan essentially prevents the fan temperature from exceeding 42 degrees centigrade even if the fan is positioned in a shipping container where additional sound and heat insulation have been installed to prevent heat and noise emissions into the factory environment.

The motor/drive components housed in the lower zone are far more susceptible to damage when running at higher temperatures and heat generation within the lower zone is more significant. The heat generated within the lower zone is from the electric motors and is related to physical laws involved in rotational power generation from electrically where electric motors are not 100% efficient and some of the losses incurred within the electric motor are converted to heat.

To allow the total fan assemblies consisting of fans and electric motors to be housed within a shipping container with adequate heat and sound insulation, further embodiments to this invention include the addition of an insulation barrier (reducing and/or eliminating air flow between the zones and insulation against conductive heat transmission as well as radiated heat) separating the upper and lower zone which allows a specifically designed heat management system to be installed in each zone to meet the specific requirements of the systems which are to be cooled.

One embodiment to this invention is to pass air through the lower zone, either, by venting this area to an area external to the container, or by venting this area to an area external to the container and having fans actively circulate the air through the lower zone, or by creating a venturi effect at the outlet of the main system fan which sucks air from the lower zone which is replaced by air from an external area from the shipping container.

A further embodiment to this invention is to use water-cooling technology to cool the motors in the lower zone where water is passed either directly or via a heat exchanged to a source external to the shipping container. Heat venting could either be carried out via a simple radiator located external to the production environment or alternatively the heat could be used within factory heating systems to heat offices and communal areas such as canteens. A typical installation could also include a heat exchanger installed in the container to allow a dedicated coolant to be used within the container, and water would then be circulated via standard plumbing couplings to both an radiator cooling external to the factory and offices & containers whilst a computer management system would manage the water flow between devices to make optimum use of the energy during day & night external environmental changes as well as during summer/winter fluctuations.

A further embodiment to this invention is to have a variety of ducting kits to allow multiple air venting into the next filter process which could be carried out through the floor, roof, end or side walls of the container. This in turn allows the fan container to be connected on top of the fan container, side by side (left & right side), end on end, and more typically to save space, the fan container would be stacked on top of the filter container which may also be preferred from an operational point of view as access to the fan container would be more frequent than with the filter container.

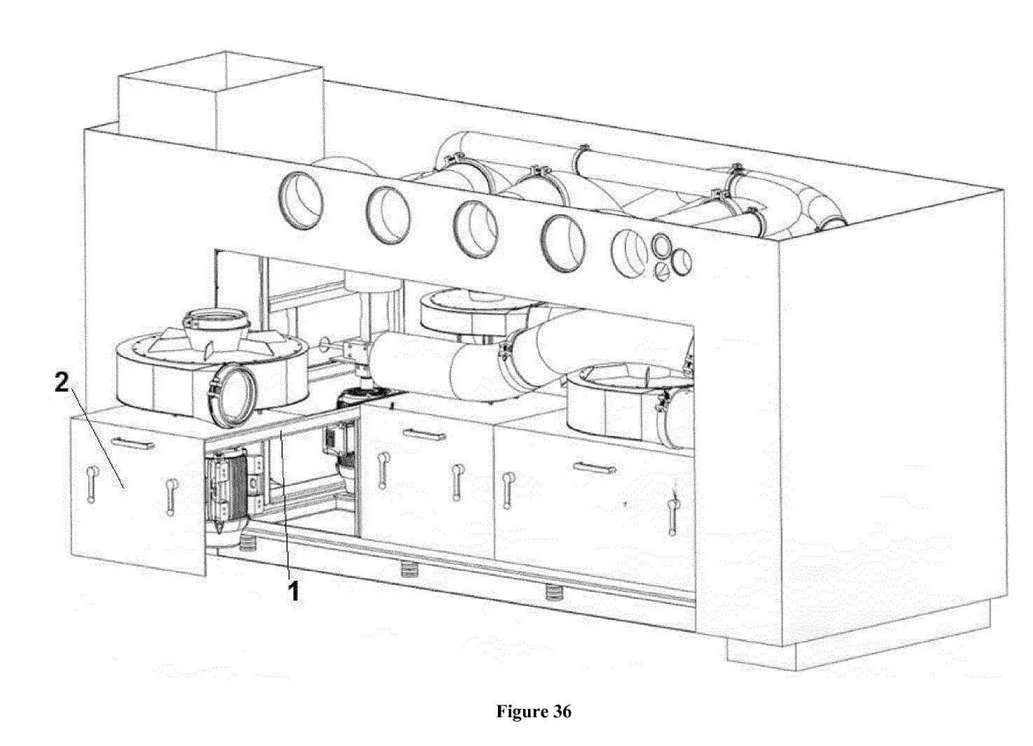

A further embodiment to this invention is to install the fans & related drive motor on a removable sliding drawer system as shown in FIG. 36 where part of the draw system (1) consists of an insulation layer (2) & (3) which separates the different zones within the container and a sliding mechanism which allows easy removal of the motor and fan from the container. Similarly, the draw system provides a housing within which the air can be circulated to the motors if the air-cooled option is installed. Simply installing the motor and fans in a confined space would be detrimental for maintenance and repair personnel wishing to gain access to the fan(s) and or motor(s). By installing sliding mechanism for each motor & fan assembly, which is combined with quick release couplings on the fan ductwork ducting the total assembly, can be easily released to allow motor & fans to be removed.

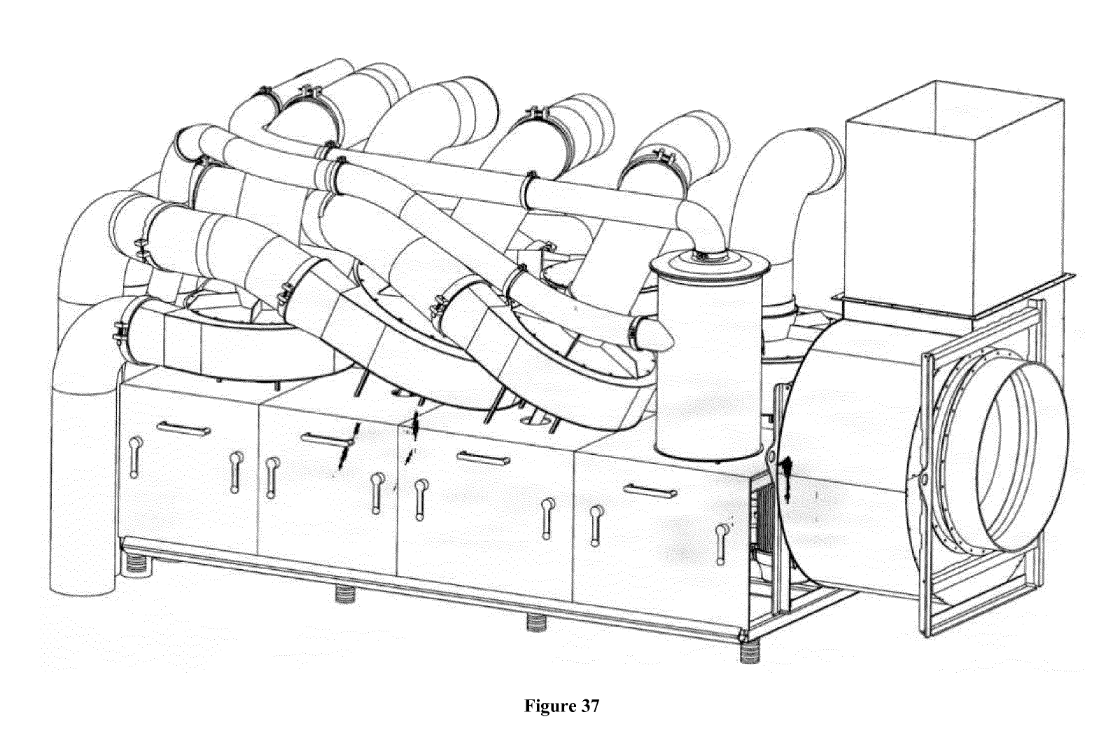

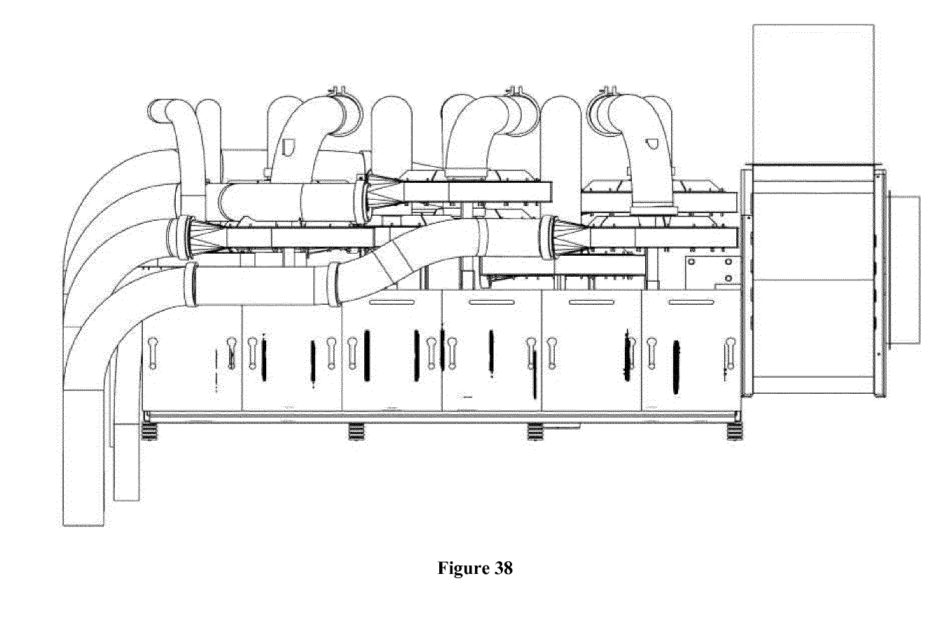

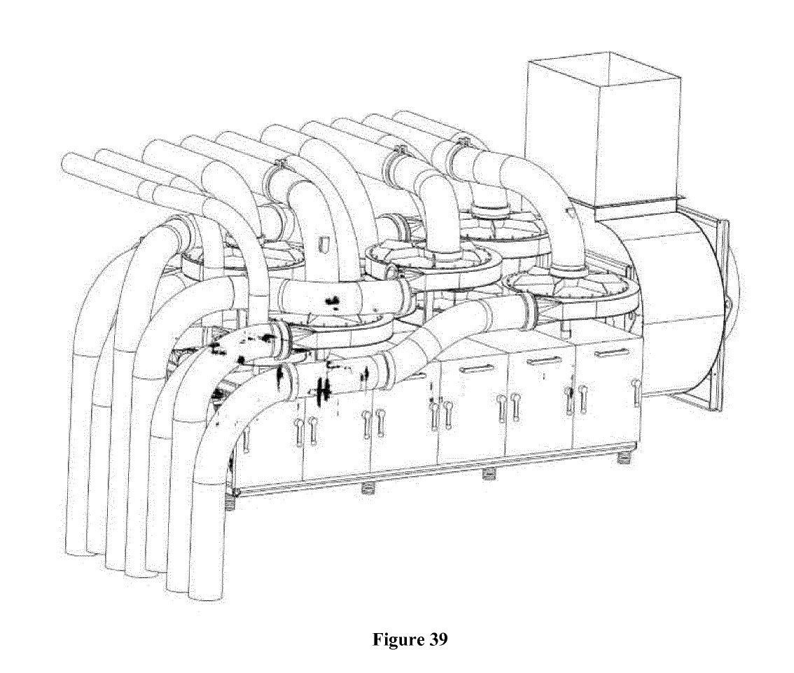

Fitting however a large number of fans within a container present a technical challenge. FIG. 37 shows the angling of fans where each fan is rotated at an angle of 26.5 degrees, which thereby allows the packing density of the fans to be increased where in this solution, 7 fans are installed. Another solution as shown in FIGS. 38 & 39 to the problem is not installed the fans at different heights and used different length drive shafts to connect the fans & motors which allows the fans to be overlapped on this 3 storey stacking configuration (1), (2), (3), where a total of 10 fans are installed.

Another embodiment to the fan container concept is to add heat and sound insulation material to the fans and the separation walls within the container and the container wall and, within the container wall sandwich, addition of such materials could be in any location of the wall sandwich or all walls of the sandwich.

Another embodiment to the fan container concept is to add vibration sensors to each of the fans and/or fan motors.

Another embodiment to the fan container concept is to add water temperature sensors for the options where water-cooling is installed.

Another embodiment to the fan container concept is to add bearing temperature sensors on 1 or more of the fan(s) and/or motor (s) bearing(s).

A further embodiment of this invention is to utilize a separate container for the installation for all ancillary items. Utility systems today require a number of ancillary items required to support the main process items. These for instance can include items, which are bolted onto the filter such a valve systems, fans, cyclones and may also include power and control items. Such a system however is not practical when moving to a new utility platform, which consists of sea shipment containers, as bolting external items onto a shopping container violates the strict ISO guidelines describing shipping container design requirements.

The term “shipping container” would typically be all sea shipping container formats conforming to standard outline in ISO 668, ISO 1496-1 & ISO 55.180.10, however, as ISO standards are continuously changing, the term “shipping container” described in this invention reference to any container and or box which has the ability to be directly shipped by sea without any significant modification.

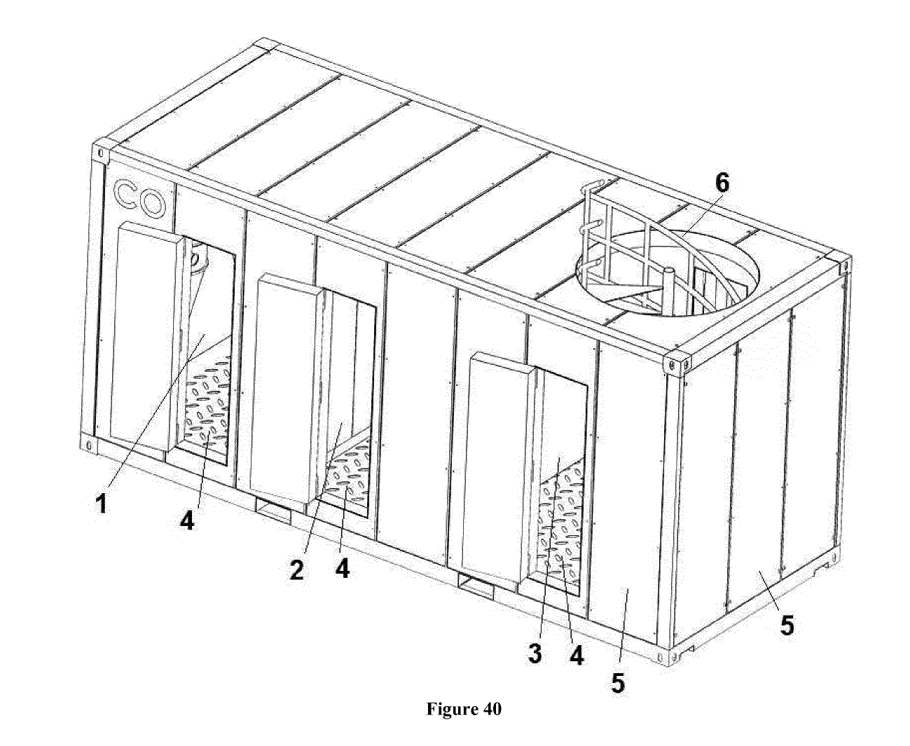

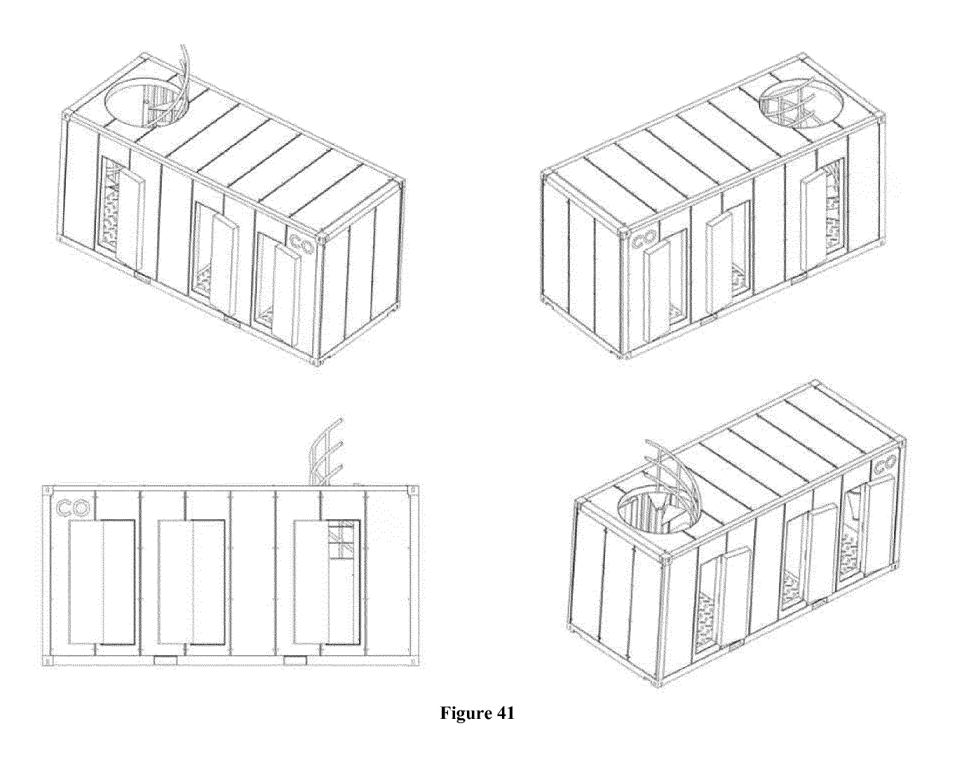

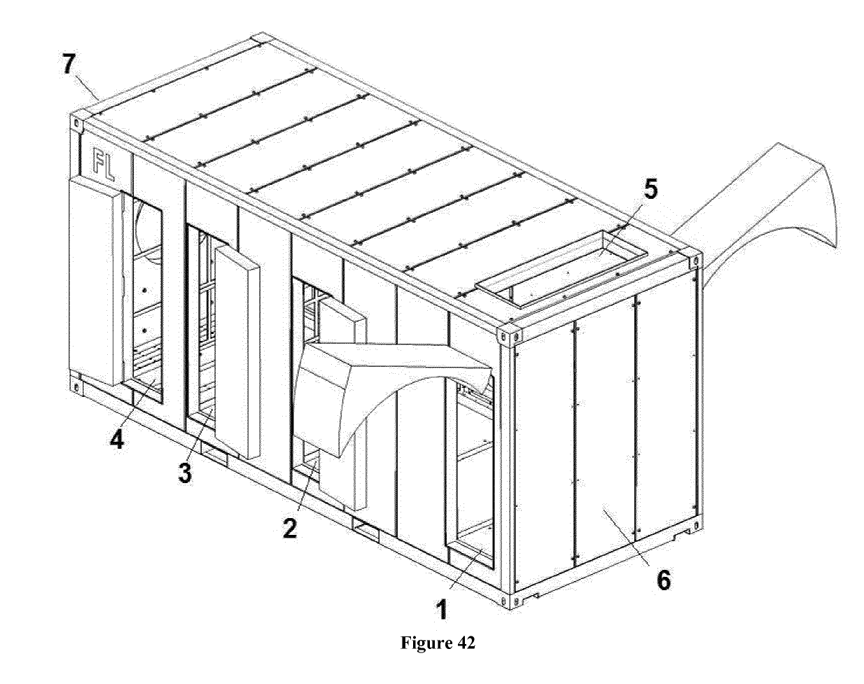

Within the ancillary container, 1-100 rooms could be used to house for nozzle valve systems and/or cyclone systems and/or pulp free diaper nozzle filtration technology however these items would typically be confined to 1 room. Also within the container, 1-100 rooms could be used to house power and control systems however these items would typically be confined to 1 room. Also within the container, 1-100 rooms could be used to stair case system to allow operator to access multiple levels however these items would typically be confined to 1 room. Offering a standardised staircase allows a standardised low cost solution to be installed as such dedicated installations with a hygienic site can be expensive to design, fabricate and install. FIGS. 40 & 41 shows an example of such a container where (1) depicts the area where cyclone and valve systems are installed, (2) depicts the area where electrical systems are installed, (3) depicts the area where an option staircase is installed to allow operator access to the upper level(s) without the need for additional staircases to be installed on-site, (4) depicts the false floor where cables and ancillary supply systems such as compress air can be positioned and allows easy access for plant personnel when required, (5) depicts removable panels where cables can also be installed and where also heat insulation upgrade packages are available to enable the container to be positioned inside and outside, a variety of sound insulation packages are also available to meet local noise emission requirements, (6) depicts options staircase to allow for access to second level without having to build any systems at installation site.

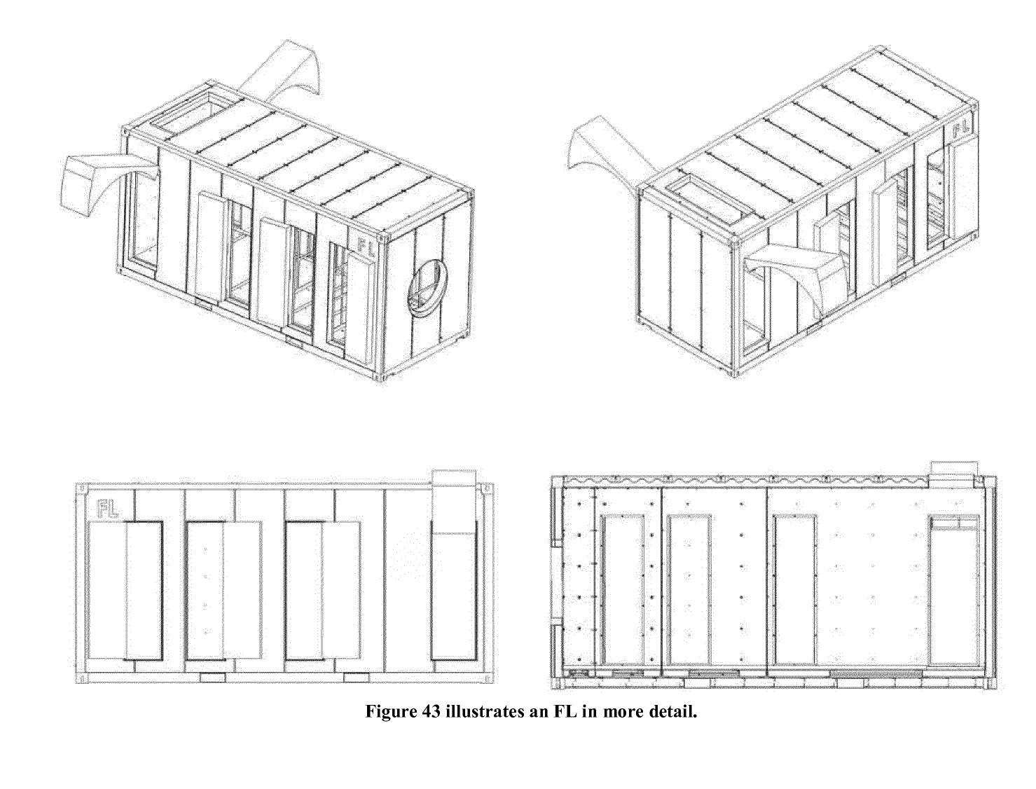

Specific attributes of the embodiments related to the filter container: FIGS. 42 & 43 illustrates certain embodiments of a filter shipping container of the overall modular plug & play utility interface where a multitude of boxes or containers used within the shipping industry are used to house the utility equipment. The term “shipping container” would typically be all sea shipping container formats conforming to standard outline in ISO 668, ISO 1496-1 & ISO 55.180.10, however, as ISO standards are continuously changing, the term “shipping container” described in this invention reference to any container and or box which has the ability to be directly shipped by sea without any significant modification. FIGS. 42 & 43 depict (1) is filter module 1, (2) is filter module 2, (3) is filter module 3, and (4) is filter module 4, are inserted into the container and used to house filtration equipment, (5) depicts the connection interface to the fan container which bolts to the container walls which can be assembled in a variety of positions.

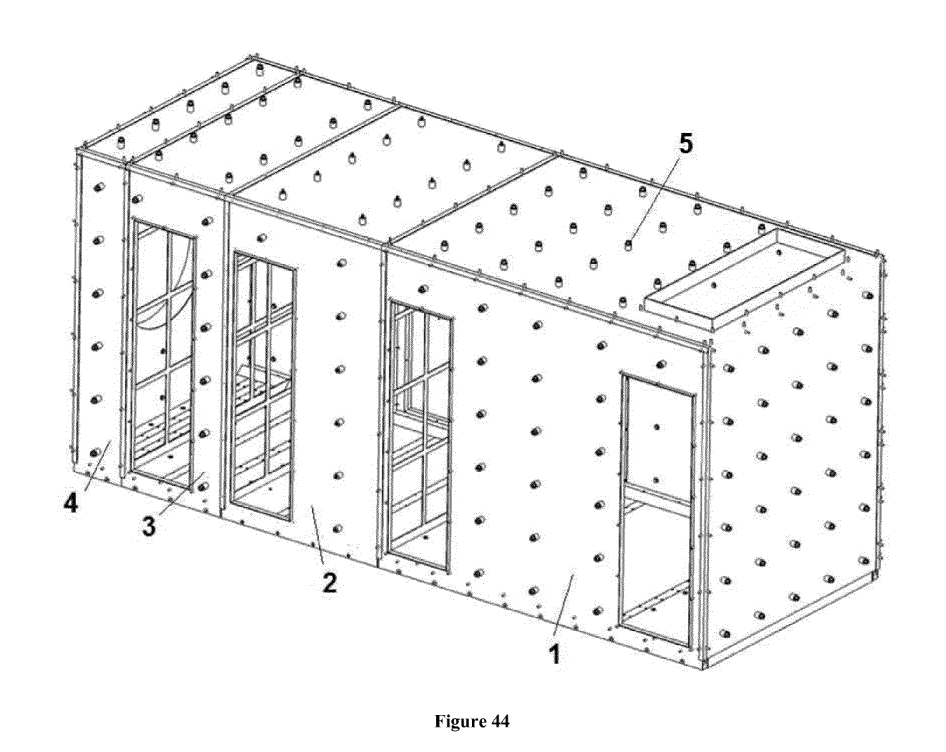

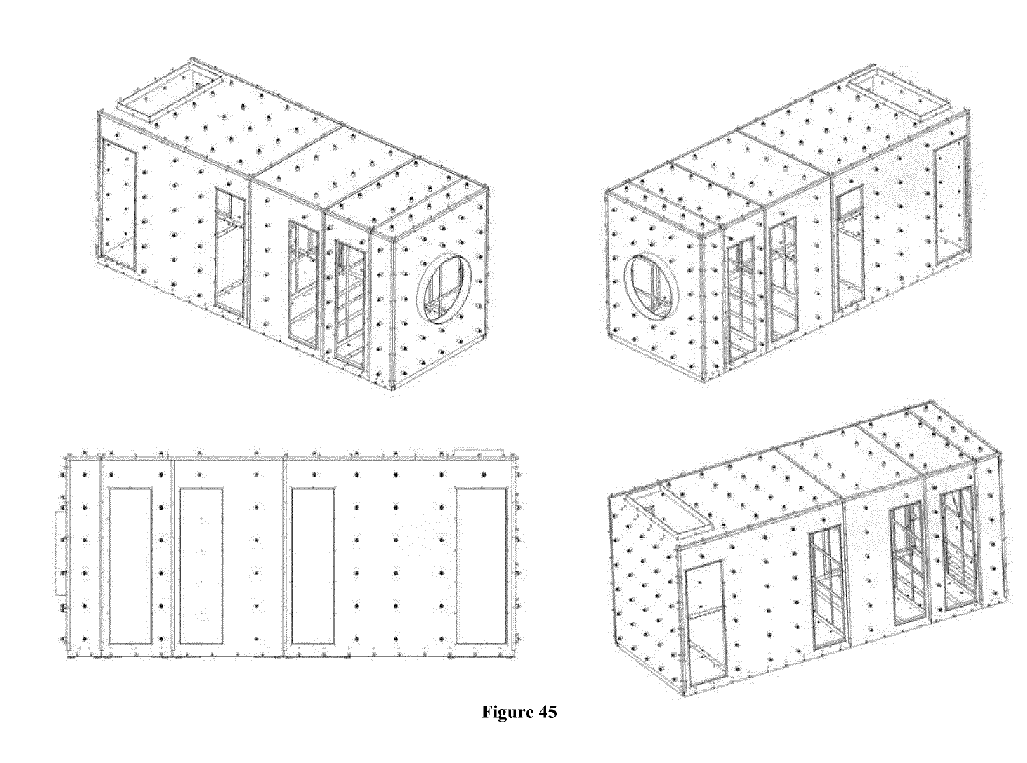

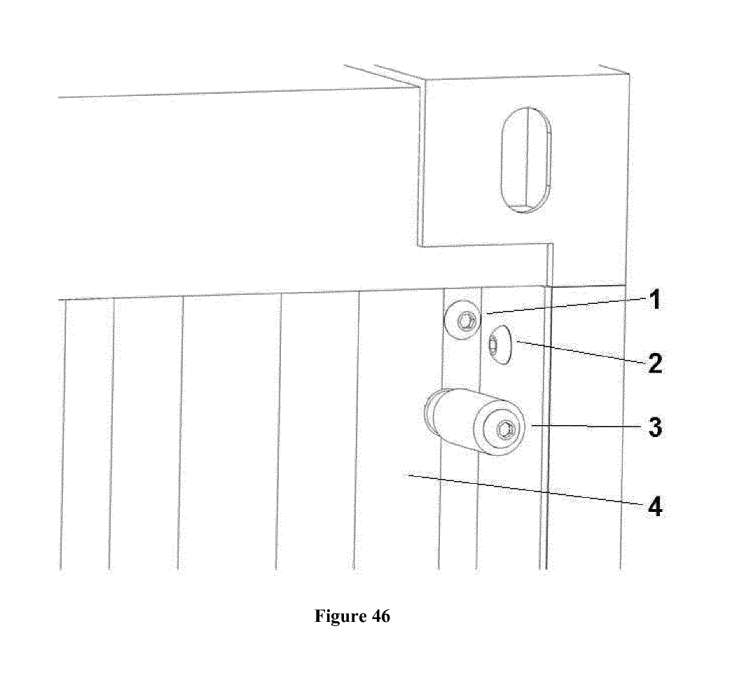

Simply however installing filtration equipment within the container is not the most ideal solution. The corrugated sides of the container create undesired turbulence within the container and are not the most desirable surface to keep clean. Furthermore, the tolerances of a typical corrugated container wall are typically +/−2.5 mm and such tolerances are not idea to attach precision filtration equipment to whilst also maintaining an airtight joint. Finding quality locations for electric cabling also becomes problematic and installing additional ancillary equipment such as automatic floor sweeping systems in the container floor is impossible. In this embodiment, modules as shown in FIG. 44 where (1) is filter module 1, (2) is filter module 2, (3) is filter module 3, (4) is filter module 4, and (5) being the support brackets that connect to the shipping container. The modules can be inserted in a variety of ways but would typically be inserted by removing the container end wall FIG. 42 (6) or (7) which can be temporarily removed by removing bolts as show in FIGS. 46 (1) & (2)), which hold the end wall in place (4) with (3) being the sound deadening mounting bracket for the outer panel), which allows direct insertion of the modules. A further cross sectional view is depicted of this concept shown in FIG. 47) where (1) & (2) are the bolt fixing the end container wall in position with (3) being the end container wall. A container could container between 1 and 100 modules but would typically contain 4 modules. Each module could contain between 1-100 filter stages but would typically contain 1 filter stage. Each module can be joined together to create a multi stage filter process. Installing modules within the container gives a quality clean surface which can be used to attach filter process, it also gives a quality surface which does not create turbulence and/or and eddy currents and can easily be kept clean. Adopting a modular concept has additional benefits, (1) it allows dedicated testing of modules on/at a dedicated test stand facility, (2) it also allows future upgrades to be easily installed with a relatively low on-site skill set, (3) reduces need to external support (engineers & mechanics). If for instance a hygienic product producer were manufacturing a product using a typical pulp/SAP mixed core scenario, and then wished to modify their production process to SAP only cores, this is some instances may require a new stage 1 filter process. Having the ability to shake-down/test the module at the filter manufacturer, thereafter sending this module to the end customer allows the opportunity to quickly exchange the modules and achieve a vertical start-up with very basic tools and limited skill set. The concept is not only beneficial for system upgrades, in the case of fire or other similar catastrophic events, having a quick exchange module concept allows the filter system to be repaired and started in a reduced time frame.

This concept is not only beneficial for the filter end user, but is also beneficial for the overall supply chain and reduction in fabrication costs. As mentioned herein above, the filter production process is similar to the basic Ford model T car, where multiple components are bolted together on an assembly site to form the final assembly.

The modular concept outlined herein allows multiple filter modules to be fabricated at the same time thereby significantly reducing filter production lead times and is a common technique used to build ocean liners in a reduced time period where larger modules of the total ship are built in separate locations. The modular concept also promotes an environment for easier production outsourcing as modules can be made is separate locations/workshops thus eliminating the need for any single vendor to gain access to the entire system-drawing package.

Simply however installing filter modules within a standard shipping container can add significant costs to the overall equipment cost and reduce the size of the actual filter modules and respective equipment housed within the modules. With a typical vacuum level of around 10-15 inches of water a very large force is applied to the module walls which consequently requires a significant structural element to stop the filter imploding. This structural element could be achieved by increasing the thickness of the module walls, or through incorporating an additional support framework onto the module walls. Both of these options are problematic. Increasing the ceiling, floor and wall plate thickness to the required thickness (typically 5-8 mm) increases filter cost and also filter weight, installing a secondary framework also increases cost but perhaps more harmful is the significant amount of space requirements which as a consequence has a negative effect on filter capacity as the available space requirements within the container are reduced.

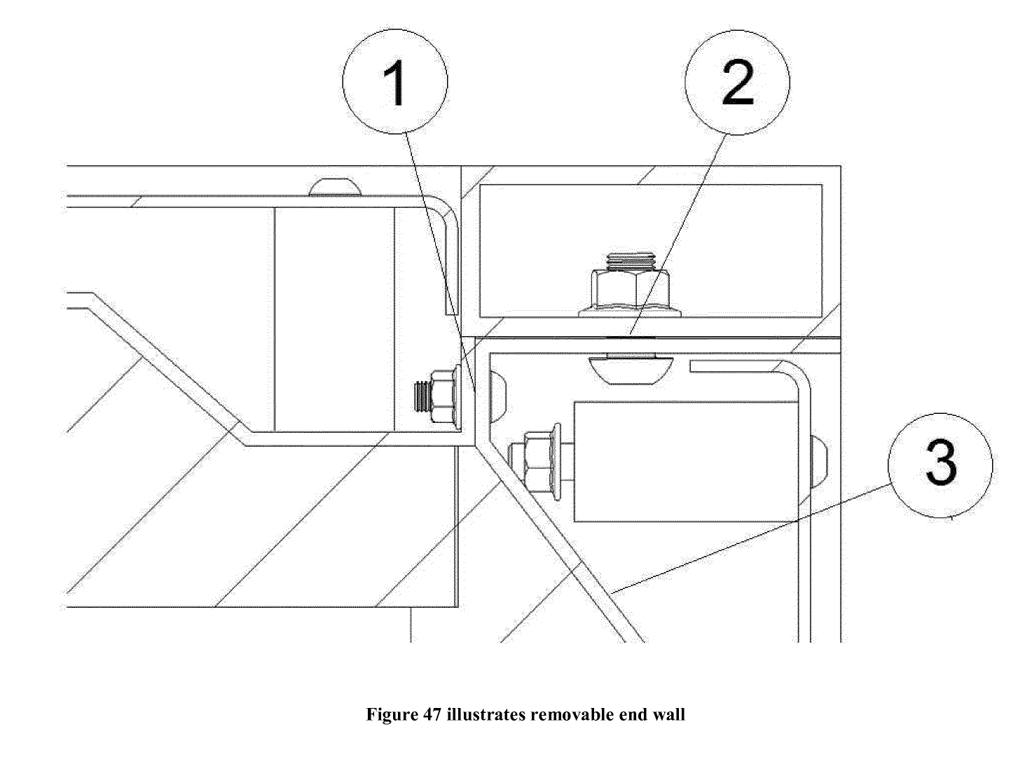

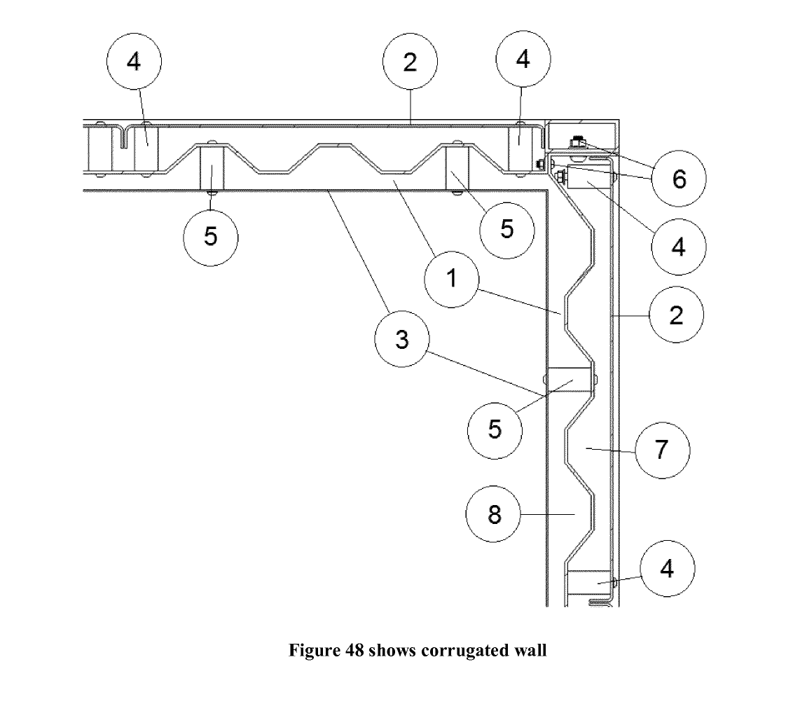

A key embodiment of this invention is to use the container's corrugated walls where the container wall is used as a structural element thereby allowing a thinner filter module wall to be used. Not only does this reduce filter production costs, the gap created between the container wall and module has significant sound and heat emission benefits. If the connections between the module and the filter wall are designed specifically and made out of such materials as rubber or any other absorbing material or spring assembly, then sound transmission from the filter modules are significantly reduced. With many industries enhancing their sound emission guidelines and with a drive to be below new levels of 83 DBA @ 1 meter with long term targets at 80 DBA @ 1 meter, any fundamental design enhancement which can achieve this target will be well adopted within industry. FIG. 48 (1) depicts the corrugates walls, (2) depicts the outer removable panels, (3) depicts the internal modules, (4) depicts the sound dampening systems connecting the panels to the container, (5) depicts the sound dampening systems connecting the panels to the modules, (6) depicts the bolts for the removable container end walls to allow module insertion/removal, (7) depicts the cavity area which can be used for cabling, heat and sound insulation, (8) depicts the cavity area which can be used for cabling, heat and sound insulation.

To allow such a solution to be implemented and the container still be eligible for sea shipment, the container walls have to be moved further within the container and respective structural enhancements are required to be made to the container as a result of these changes in order to meet the required ISO shipping regulations.

Further embodiments of this invention include the strengthening of the container in the roof and floor, (and in some instances the walls also) as a standard shipping container design is not designed to withstand the vacuum loadings placed on the container.

A further embodiment to this invention is the additional of an automatic floor cleaning/sweeping device. Adding the modules within the container housing as discussed earlier herein opens up new possibilities to install a false floor, which opens up the subsequent option to install a new range of floor sweeping technology, which could be installed in all modules but would typically be installed between stage 1 & 2 and occasionally between 2 & 3. Typically floor sweeping technology would not be required in stage 4 as airborne dust is virtually none existent at this stage in the filtration process.

Attributes of the floor sweeping invention includes a fully flat airtight wall and floor surface of the module where the dust/airflow occurs which is shown in FIG. 49, where (1) the approximate vicinity in which the air filtration phase occurs, (2) is the approximate vicinity where dust from the air filtration process typically collects (on the floor), (3) where a drive system for a floor cleaning device could be housed and where the floor located between 2 & 3 has a false floor or partial false floor location over key drive components, to allow access to the drive system if and when required.

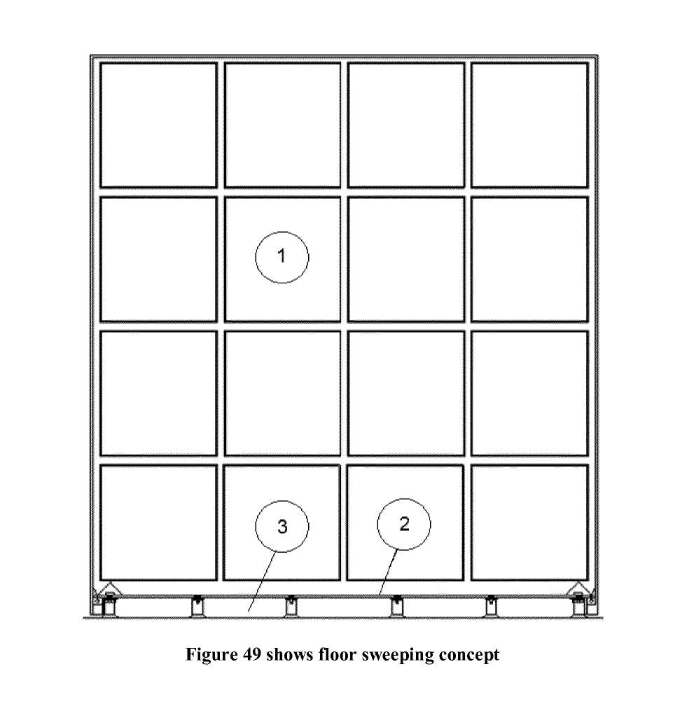

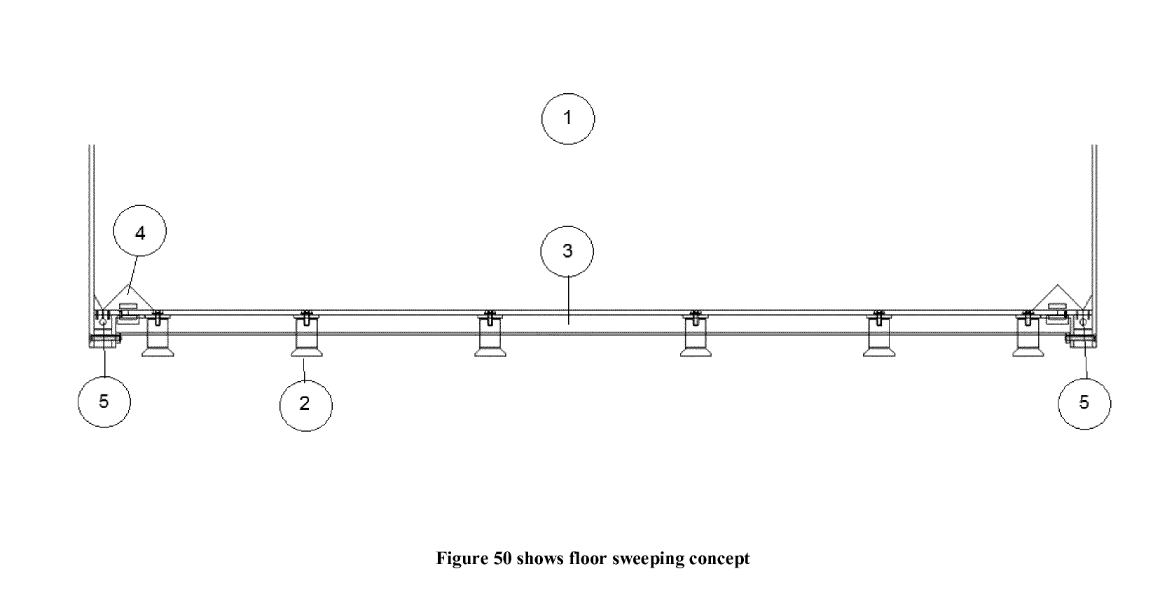

FIG. 50 depicts the drive area in more details where (1) is the approximate vicinity in which the air filtration phase occurs, (2) where foot mounts are positioned within which the weight of the module is transferred to the container floor, (3) the drive mechanism area for the cleaning device, (4) the cleaning device which would typically have the capability to sweep the entire floor), (5) the vacuum area from where the collected dust is removed.

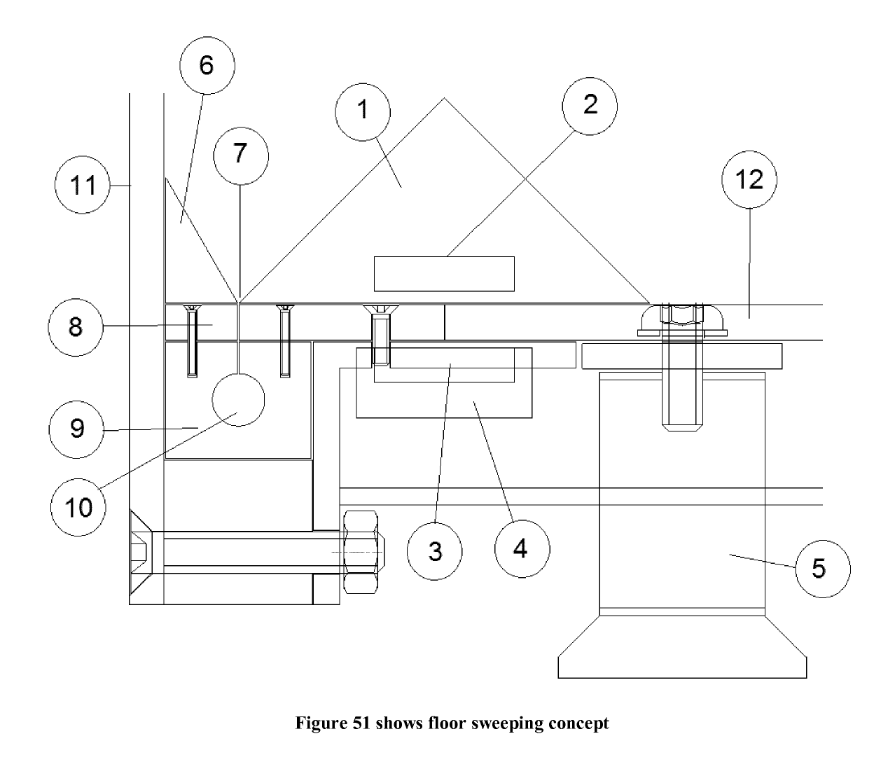

FIG. 51 depicts the drive & vacuum area in more detail where (1) is the sweeping device which moves left & right in a continuous oscillating motion design in a triangular form to eliminate surfaces on which dust can occur, (2) is a magnetic device mounted within the floor sweeper (1), (3) is the magnetic device connected to the drive mechanism, (4) is the drive mechanism bracket which holds and drives the lower drive magnet, (5) is where foot mounts are positioned within which the weight of the module is transferred to the container floor, (6) are angled corner sections which prevent dust build up on the floor edge where the sweeper cannot reach and channels the dust falling on the section into the vacuum area, (7) a slit in the removable floor plate where dust is sucked through, (8) the side removable floor plate, (9) a vacuum manifold block in which a hole or cone segment is removed from the middle which inserts into the module housing which can be easily exchanged, (10) the vacuum hole which transports dust from slit to outside of the module, (11) the module wall(s), (12) the module floor(s) which can include additional removal floor plates (13) to gain access to drive components if and when required.

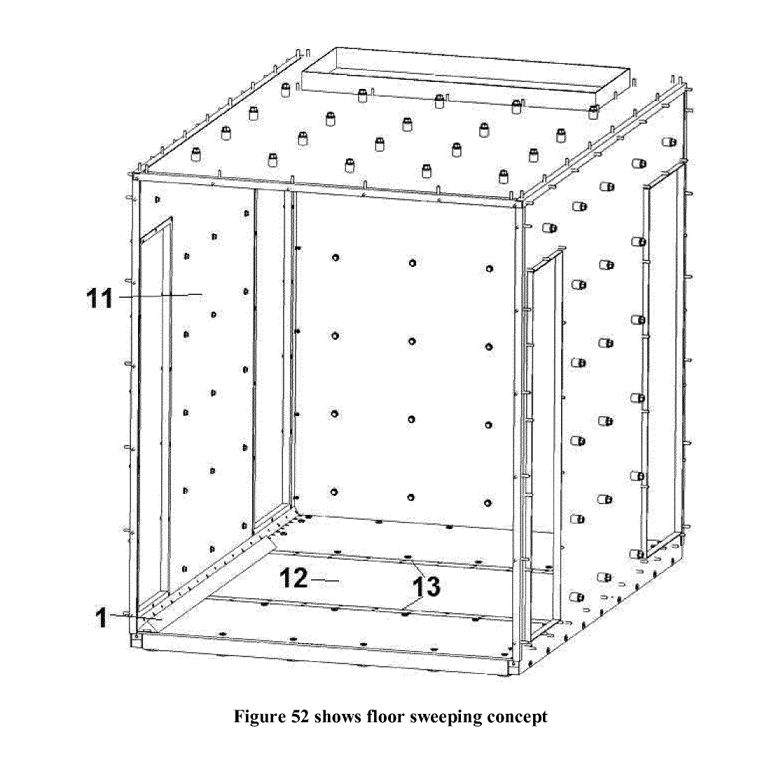

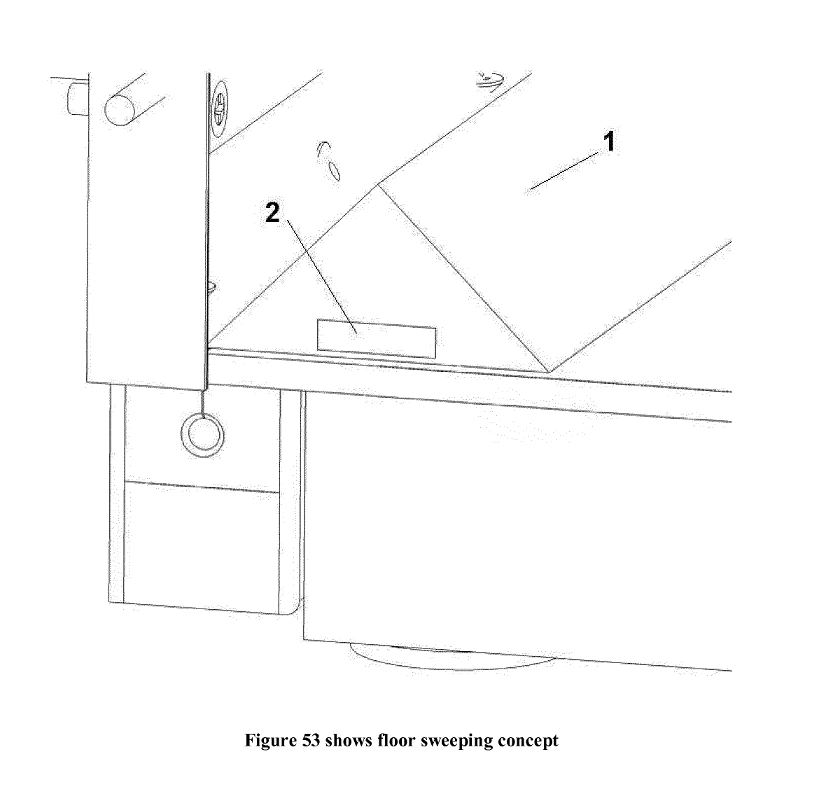

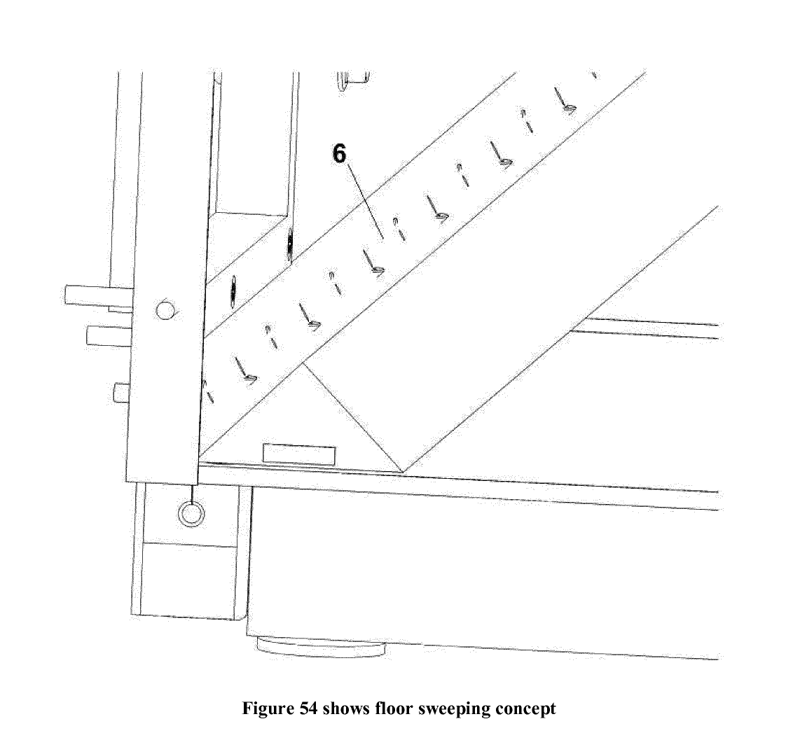

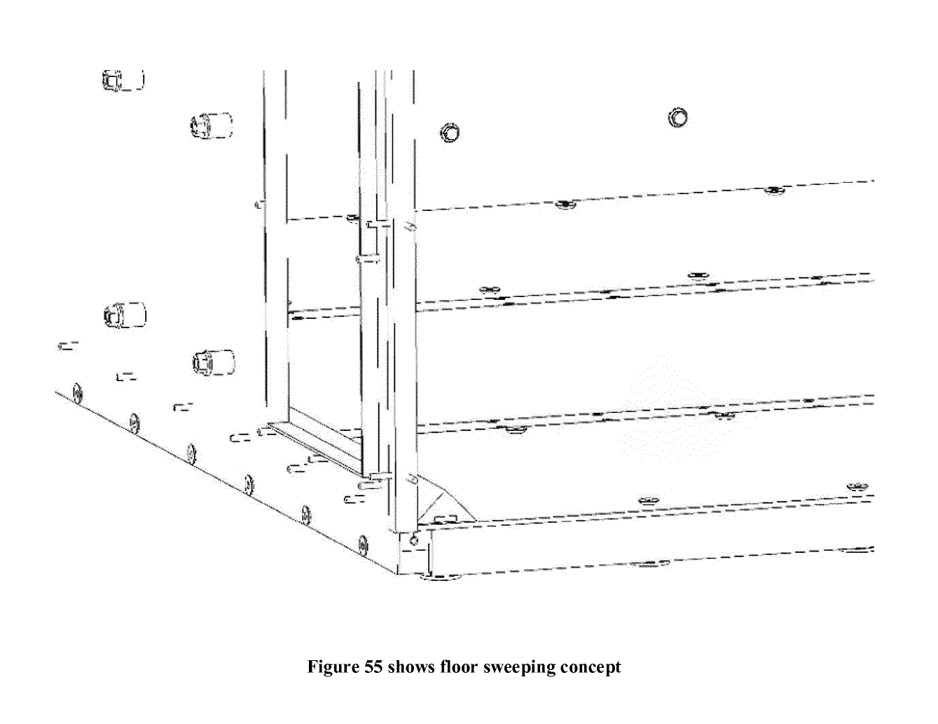

FIGS. 52-56 depict the floor-cleaning device in more detail. In these embodiments, removable floor panels are installed in CD direction under which the driven magnet oscillates back & forth. The floor panels once mounted are fully flush with the main floor to eliminate dust build up risks with seals being installed between the module housing and the floor panels to eliminate dust migration into the drive area. The floor panels are made of a low friction coating to reduce friction and where of the continuous motion of the magnets. Removing these panels gives not only access to the drive system but also the rails upon which the lower driven magnets are positioned. For maintenance purposes, the scraper can easily be removed as the only physical connection the scraper has with the module is via magnets.

A further addition to the invention is to include additional magnets to the scraper and reed switches, which follow the motion of the scraper connection to the drive mechanism. Should for whatever reason the scraper become detached, the reed switch activates a signal that the scraper has become detached.

With the scraper moving in one direction, contaminants build up on the scraper on the leading edge. The invention embodiment includes 2 vacuum systems installed at the end of travel positions of the leading edge as shown in FIG. 51 (10) that turn on intermittently when the scraper has docked at the end of travel. The vacuum system could also be turned on when the convertor stops. The nozzle fan could also be used in such circumstances if desired, and in certain embodiments, the retardant energy (inertia) in the nozzle fan could be used to remove contaminants collected by the floor scraper. The scraper itself has triangular or similar form as shown in FIG. 51 (1) as such a form by design does not allow surfaces where dust can settle. Similar triangle forms as shown in FIG. 51 (6) exist between the floors and walls to ensure that no dust builds up in the filter and all contaminants can exist via the slit outlined in FIG. 51 (7).

The frequency of motion of the system would be adjustable but could range from a cycle time of 1 second to 10 000 hours, but would typically be set between 1 minutes to 8 hours, and would more typically be set between 60 minutes to 100 minutes and would ultimately depend on contaminant loading. Another configuration would be to activate the floor-cleaning device at schedule production stops and/or, production downtimes.

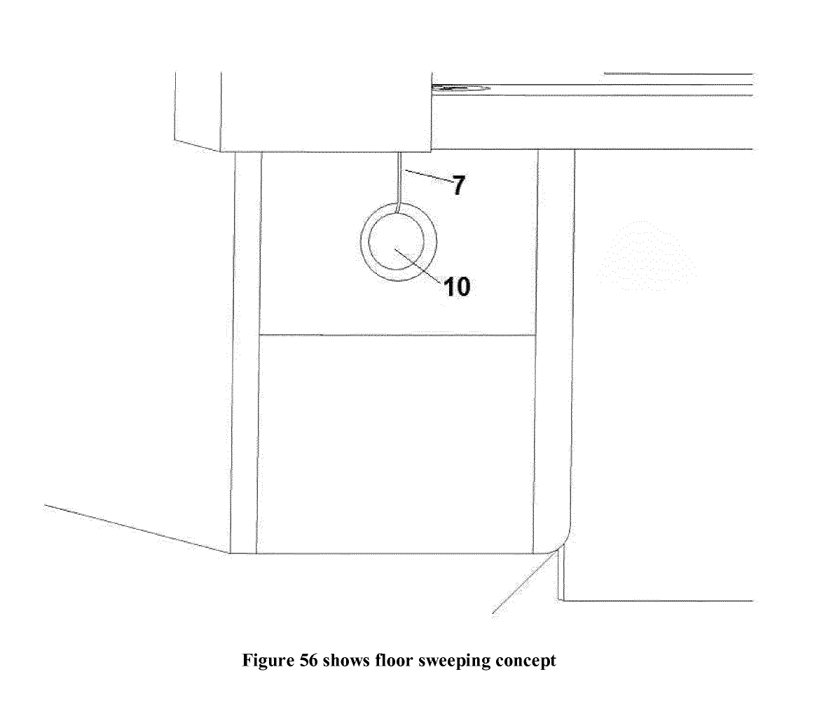

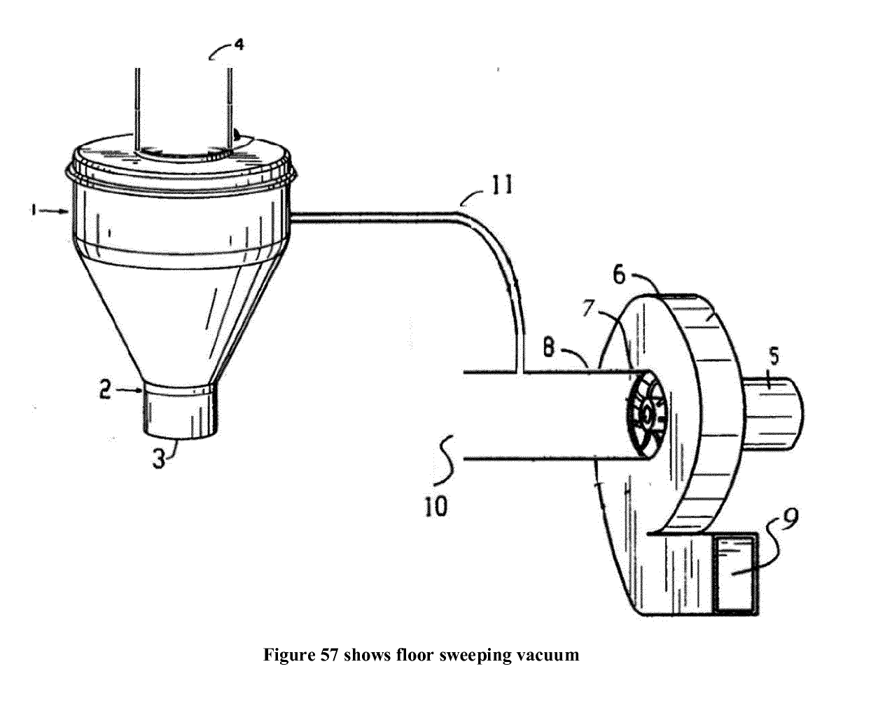

Typically the cleaning cycle only takes place once the scraper has reached the end of travel as continuously removing air from the system would essentially be a waste of energy and when the scraper is docked in the end position, the scraper also having the capability to seal the slit FIG. 56(7) thereby reducing air leakage loss. Using energy only when required would be advantageous. Another embodiment of the air scraper process is to attach a vacuum storage chamber between the vacuum source such as a fan and the cleaning process vacuum inlet area as described in FIG. 51 (10). The chamber works as a storage buffer and is connected to a vacuum source, which would typically be the nozzle-cleaning fan via a small pipe. The diameter of this pipe could be between 0.001 mm to 1000 mm but more preferred would be 2-5 mm. As airflow is extremely minimal in to the chamber, the diameter of this pipe, a larger diameter is not required. The vacuum built up in the chamber over the cycle period would be released in a few seconds, thereby sucking dust from the cleaning device which also explains why the inlet ducting into the chamber as a larger diameter verses the vacuum source. The chamber has a valve located at the bottom of the chamber, which releases dust after each cycle has taken place but can be adjusted so the valve opens up on a lesser frequency. The process concept for this set up is outlined in FIG. 57 where (1) is the vacuum storage chamber, (2) is the located of the release valve where the dust collected is released through (3), (4) is the inlet to the vacuum storage chamber which is connected via valves to the suction positions of the floor sweeping system outlined in FIG. 51 (10), (5) is the to the nozzle fan motor, (6) is the nozzle fan, (7) is the nozzle fan impeller, (8) is the inlet ducting from the nozzle fan, (9) is the outlet of the nozzle fan (10) is the connection to the nozzle fan, (11) is an additional small diameter pipe which is connected from (8) to (1) which supplies continuous vacuum supply in small quantities to the vacuum storage chamber as described herein above.

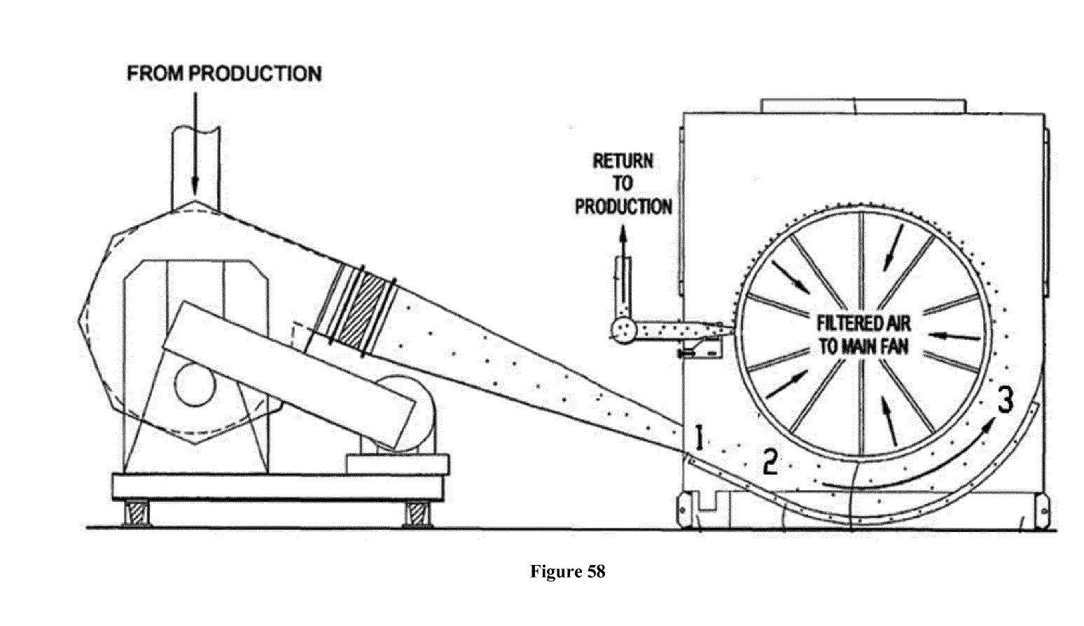

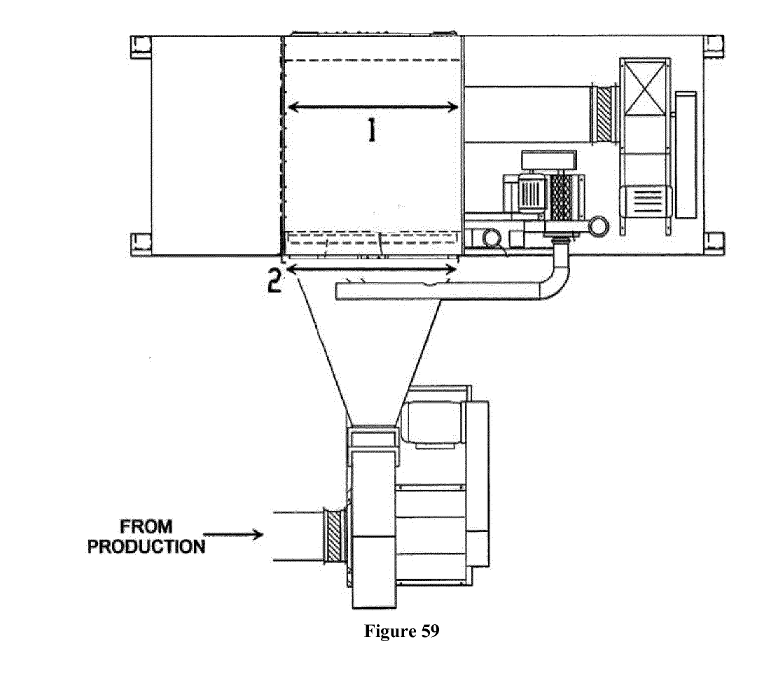

As discussed herein above, filter systems are typically sized to fit to the convertor. If air speeds are too high, dust particles can pass through filter media, if speeds are too low, dust can collected within the filter as air speeds are not high enough to keep contaminants airborne for latter removal via the media cleaning nozzle(s). Filtration systems today typically receive air from the entrance area of the filter, and in more recent generations, air can be supplied to the filter along the side of the filter drum, typically across a curved floor which promotes automatic floor cleaning (outlined in U.S. Pat. No. 5,679,136) which is advantageous as this not only reduces manual cleaning effort but also reduced explosion risk. FIG. 58 depicts a typical filter process today where contaminated air is supplied to the filter at point (1), enters the filter at point (2) and is projected around the curved floor in the area of (3). FIG. 59 depicts a top view of this process where (1) is the width of the drum filter and (2) is the width of the inlet area. To ensure this concept works, the entire floor surrounding the drum filter must be kept clean which requires a full width nozzle inlet into the filter.

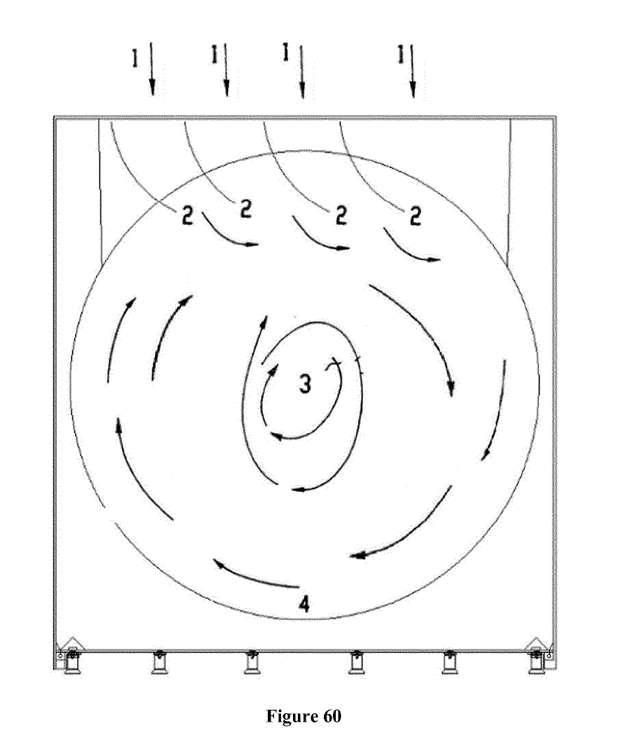

A key embodiment of the invention of the filter process is to create a vortex (also referred to as swirl or cyclone or rotatory air condition or rotatory air environment) of air at the inlet of the filter which is shown in FIG. 60 with (1) depicting inlet air inflows, (2) depicting fins to divert the air in a defined direction, (3) the air flow rotating clockwise creating a vortex, (4) the location where dust and other contaminants would usually build up but are eliminated due to high velocity flow in this region which would typically be over 20 meters per second.

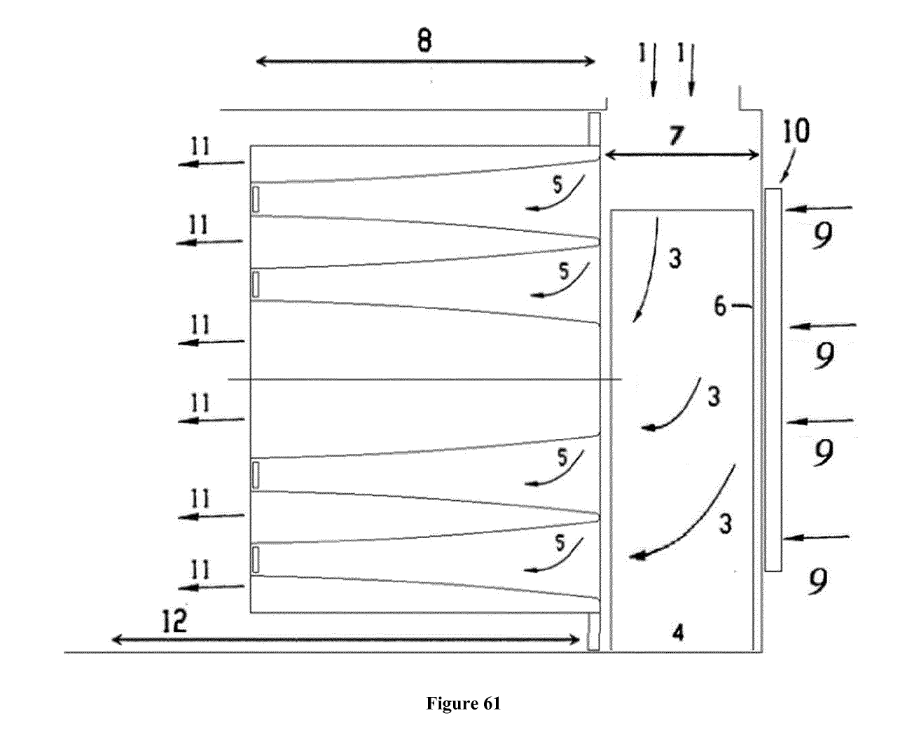

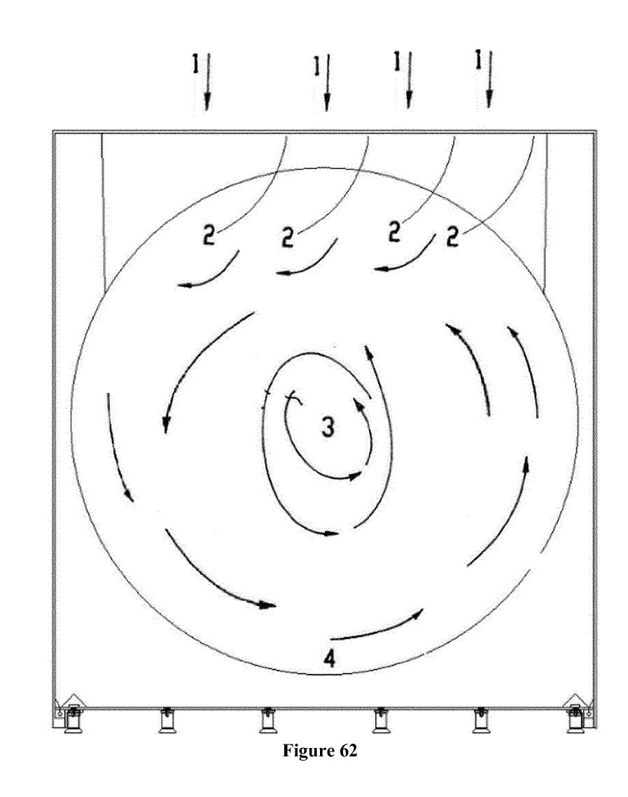

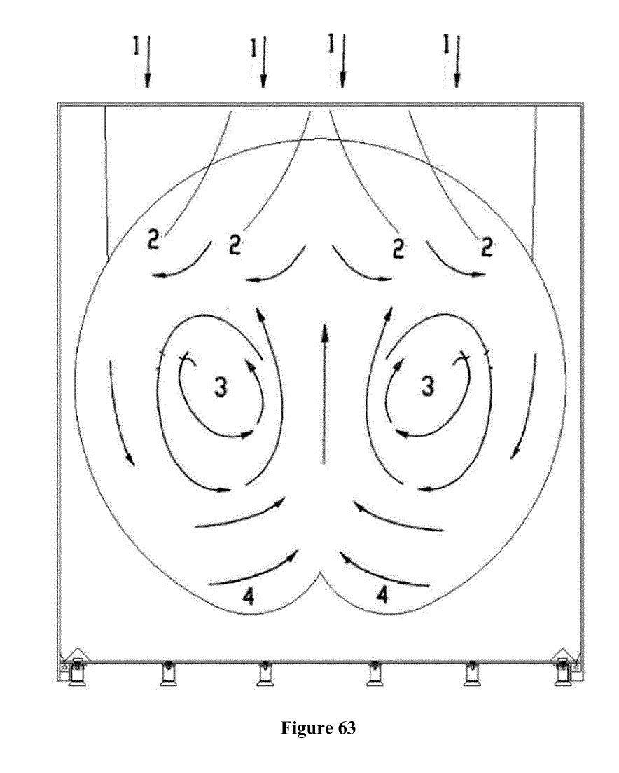

The vortex is created in front of the filter as shown in FIG. 61 which is a side view of FIG. 60, where (1) depicting inlet air inflows, (3) the air flow rotating clockwise creating a vortex and in this side view is moving to the left, (4) the location where dust and other contaminants would usually build up but are eliminated due to high velocity flow in this region and (5) the area within the filter through which air is removed from this room (6) an entry door for operator access, (7) the width of the vortex/swirl zone and which can easily accessed by operators, (8) the width of the filter, (9) shows a variation to standard design where air could enter via (9) verses (1) with (10) representing a device such as fins to create a vortex should air be entering the filter from (9). Many filter designs today do not create enough internal air velocity to clean the floor and/or the internal housing of the filter is not aerodynamically designed and significant turbulence is built up within the filter, which is detrimental to cleaning. Some filter designs also have a large floor area, and as such, to clean this area a relative high air volume is required to ensure air speeds are above a minimum level to allow a floor cleaning process to take place. FIG. 62 shows the identical concept to FIG. 60 but in an anticlockwise formation. Typically only 1 main vortex would exist (not counting vortexes created by turbulence) but any number between 1-10 000 000 could exist but more typically 1-2 main vortexes would exist which is shown in FIG. 63.

If air velocities are too low, contaminants will remain on the filter floor, as adequate air velocity is not achieved to transport contaminants onto the filter media. A modern drum filter today successfully achieves sufficient floor cleaning by a well design floor, which is aerodynamically designed to reduce turbulence, and is smooth by design to reduce locations where contaminants can build up and ensure air velocity is not compromised. Furthermore the width of the air inlet is across the full drum filter width to ensure the entire floor area is kept clean. Air inlet nozzles are also design to ensure air inlet is turbulence free, the concepts of which are shown in FIGS. 58 & 59. This design is fully functional, the only negative of the design is a relatively high air volume is required to keep contaminates airborne as the floor width is very wide.

Assuming the current drum filter concept shown in FIGS. 58 & 59, and assuming for instance for this calculation only that the drum filter 3 meters long, this in turn would require an air inlet also of 3 meters, and, assuming a nozzle inlet height of 100 mm and a gap of 100 mm between drum floor and drum filter (shown in FIG. 39 in area (1), (2), (3), this means that 10 800 cubic meters of air would be required to reach 10 meters per second air speed in this floor zone. By designing a new filter-housing concept where the inlet area is narrower as shown FIG. 61 (7), then, a much smaller amount of air is required to ensure enough air velocity is achieved to promote adequate floor cleaning. The air inlet width as shown in FIG. 61 (7) could be between 1 mm to 10 000 00 mm, but would typically be between 100 mm and 2000 mm and more typically between 300 mm (to allow human access) to 1 000 mm (to promote high air velocities). Assuming for example the inlet width was 550 mm, and then in order to achieve an air velocity of 10 meters per second as per the previous example, assuming inlet ducting height was also 100 mm then only 1980 cubic meters of air would be required which is only 18% of the example referencing today's technology.

Such a reduction in minimum air requirements significantly opens up the existing process window within which a filter can operate and therefore allows more common filter equipment SKUs to be used across multiple applications requiring very different air volumes.

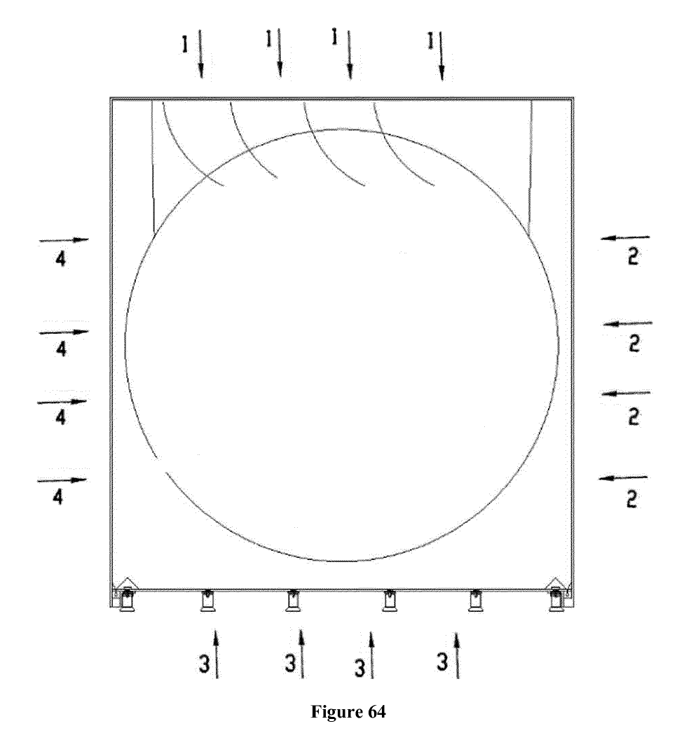

As outlined in FIG. 64 air inlets into the vortex area could be from above (1) (assuming filter container is above), or from the left (4) (assuming filter container is on the left), or from the right (2) (assuming filter container is on the right), or from below (3) (assuming filter container is below), however air inlet could be at any angle (0-360 degrees). As shown in FIG. 61 (9) Airflows could also come from the opposite wall and pass through a secondary process (usually consisting of curved fins or a stationary turbine (10)), which would create a vortex in the assigned vortex area prior to entering the filter media through (5).

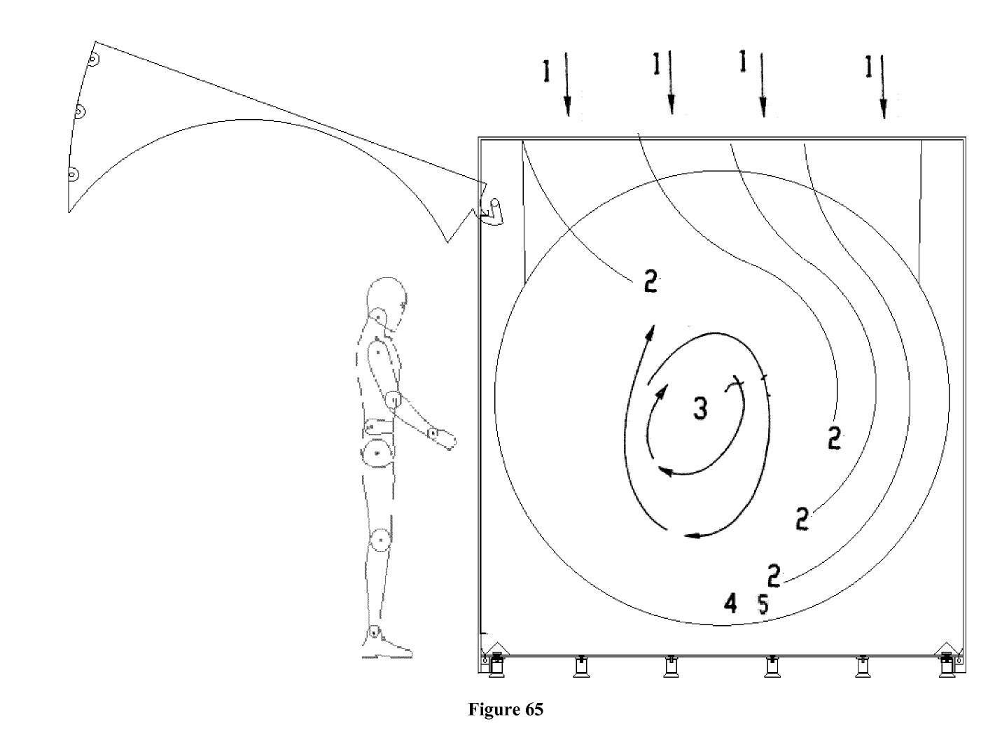

FIG. 65 shows a further embodiment to this invention where air is channelled through nozzles closer to the floor area (4), which ensures that air exiting the nozzles (5) is targeted at the most efficient point. Such a design would further increase the filter's operational process window through the direct focusing of higher air velocities on the filter floor.

In a further embodiment to this invention, this vortex area can be used for operator access as this provides an area where the operator can stand and get ideal access to the filter media. Should the media be cantilevered (as discussed herein below), and then such a scenario is a perfect layout combination between elegant design, operator access and process.

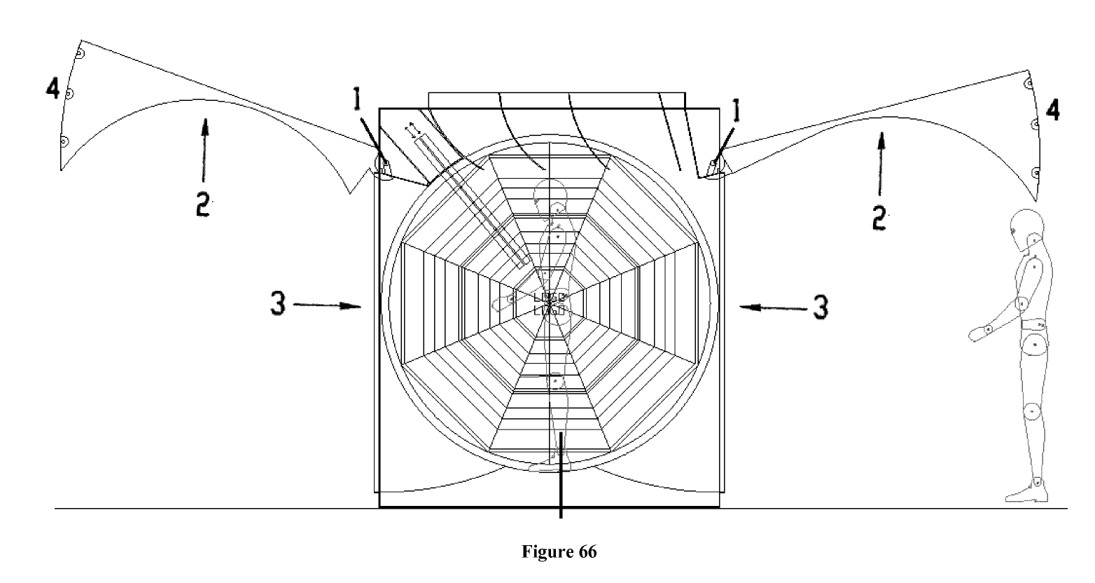

In a further embodiment to this invention, the access doors would also be shaped to assist the vortex and not to create any undesired turbulence. FIG. 66 depicts this concept where (1) is the pivot point for the doors, (2) the door(s) (either single or double) formed on the inside to a similar shape as the vortex air flow to avoid additional turbulence, (3) where operators can enter the filter within the vortex area when the filter is not running, with (4) depicting hand grips required to close the door as the door is counter weighted to avoid additional support systems and risk of injury to operators.

A further embodiment of this invention is to re-design the filter drum to allow a higher larger media area to be installed within the more confined spaces of a shipping container. A typical drum filter today consists of a revolving drum where in such designs, the internal area of the revolving drum is not efficiency utilized. In order to achieve higher air filtration volumes in the space of a container, a new method has to be found to install a larger amount of media area within a smaller space. Ideally 15-25 SQMs of filter media would be required to fit within the stage 1 filter module within the container.

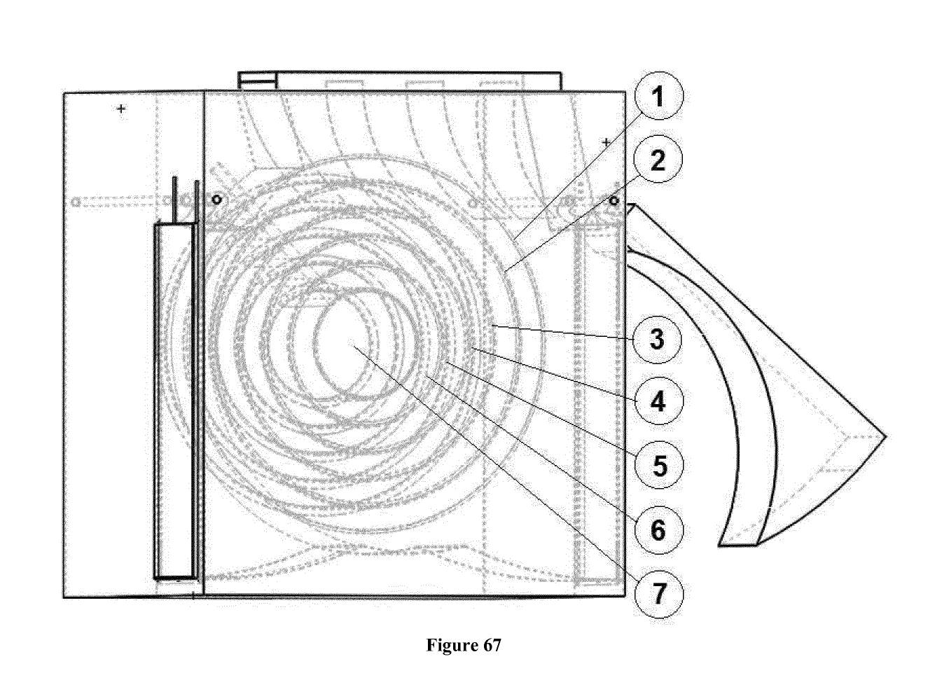

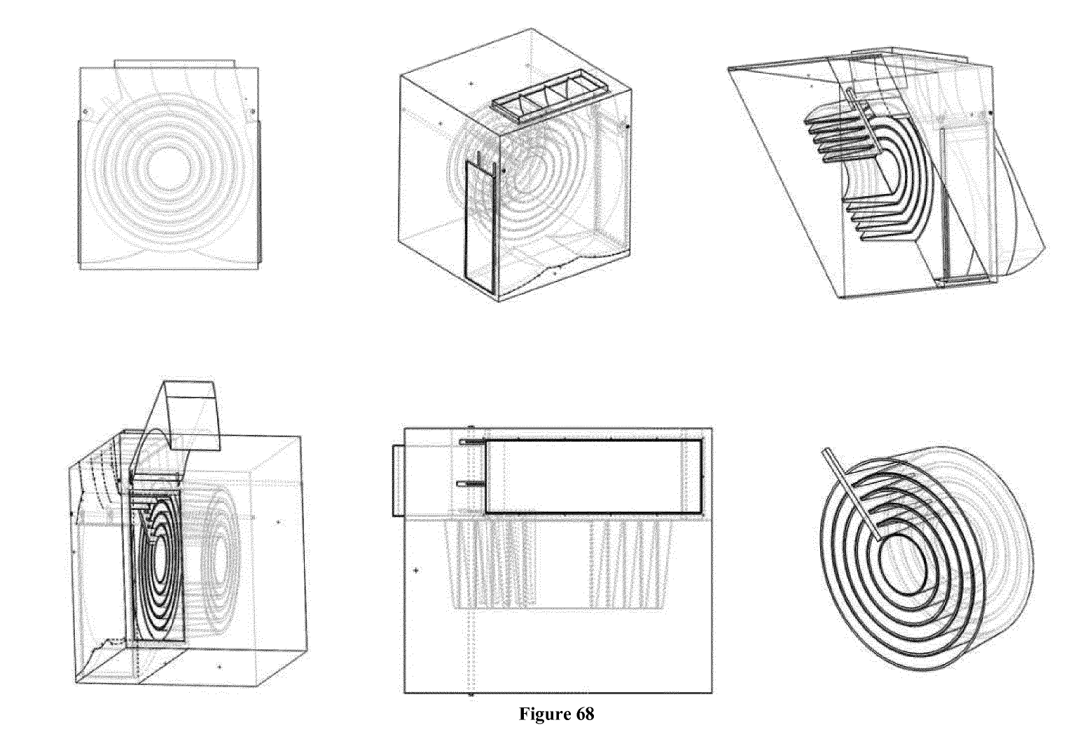

By installing more drums within drums allows a more efficient use of space. FIG. 67 & FIG. 68 outlines a concept where multiple drums 1, 2, 3, 4, 5 and 6 also referred to as cones are position inside each other. In this embodiment cones rotate and a stripping/removal nozzle exists to remove contaminants from the media surface.

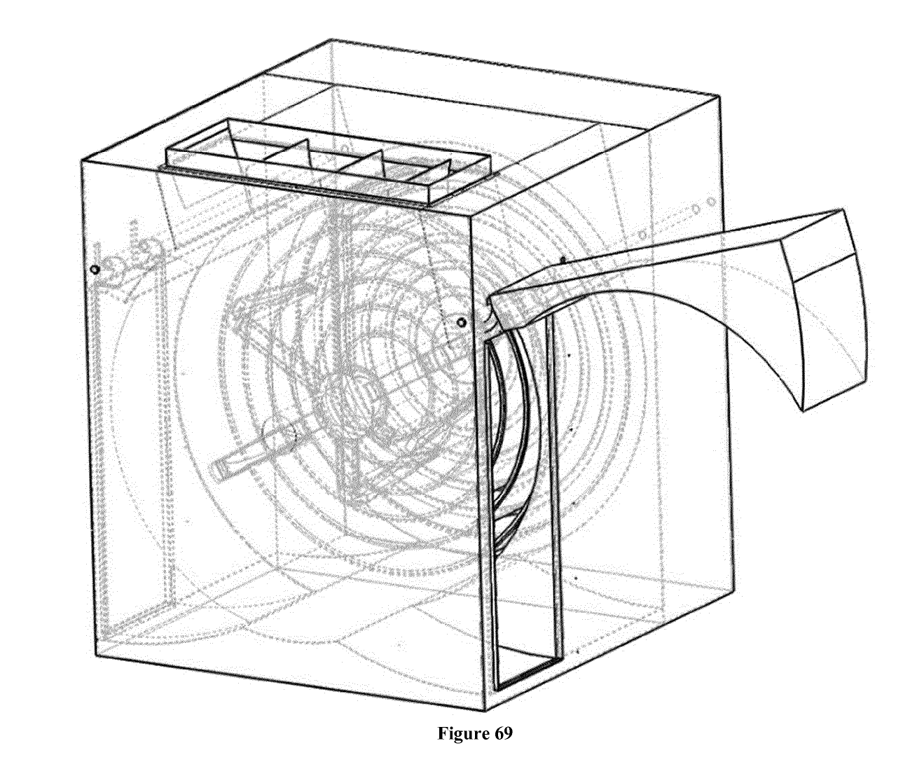

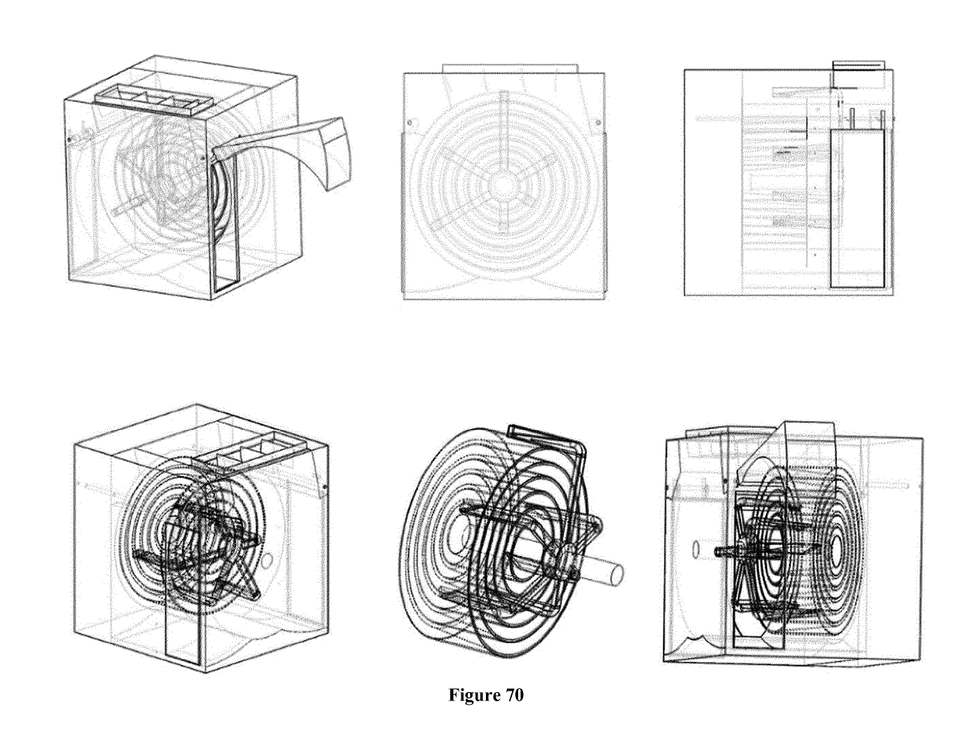

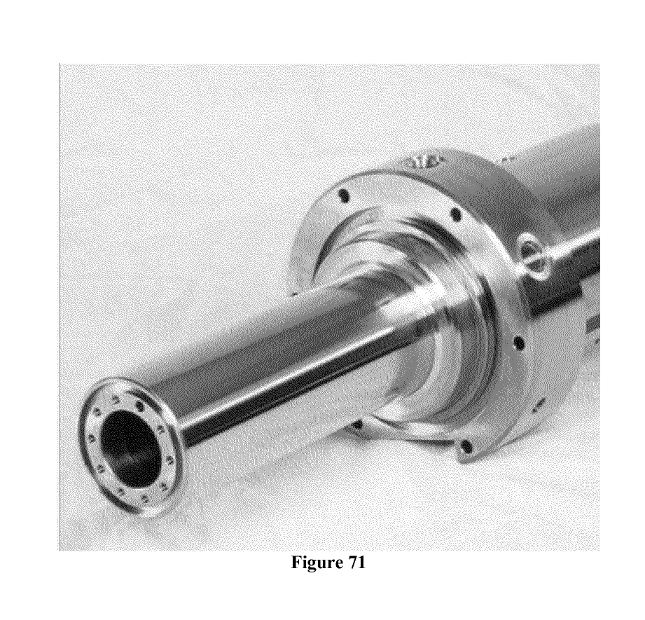

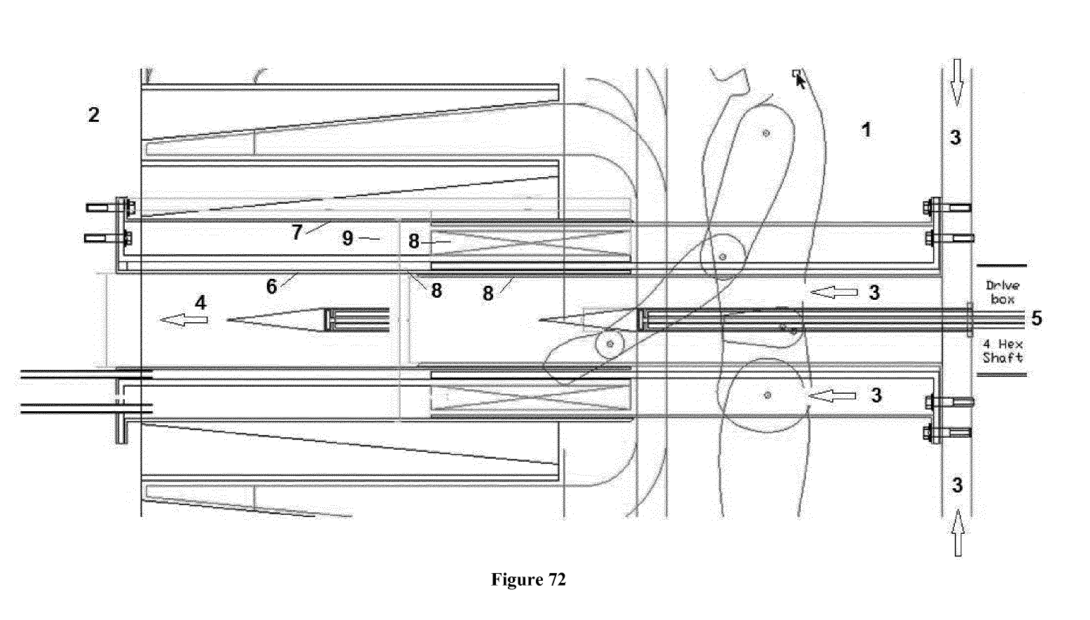

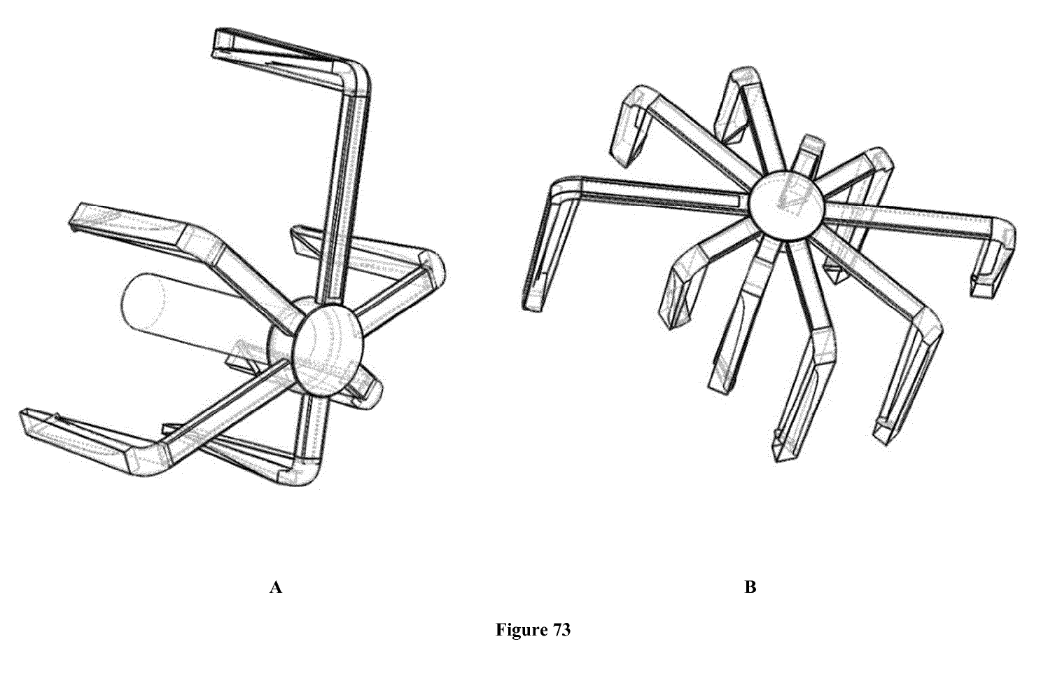

A further embodiment rather than rotate the cones, as shown in FIG. 69 & FIG. 70, the nozzle rotates whilst the cones remain static. Here a nozzle rotates and also have the capability to move in MD direction in a backwards & forwards oscillating motion. A further embodiment to this invention is the positioning the bearing assembly as shown in FIG. 71. Such a bearing utilizes compressed air to significantly reduce bearing friction and significantly increase lifetime expectancy of the bearing. The bearing has an integral hollow zone within the bearing, which is used to transport the air from the nozzle cleaning system. Such as bearing is also desired, as there is a continuous flow of compressed air leaving the bearing thereby reducing the possibility contaminants can become embodied within the bearing. A further step to reduce and/or eliminate the risk of contaminants entering the bearing is to house the bearing within a separately vented cavity as shown in FIG. 72 with (1) air in this zone is entering filter, (2) air in this zone have exited the filter, (3) nozzle in-feed air, (4) air exiting bearing from nozzle, (5) drive for nozzle both rotary and linear, (6) internal telescopic slide, (7) external telescopic slide, (8) air bearing as outlined in FIG. 71, (9) cavity where air bearing is located, (10) & (11) vents to cavity). Venting the cavity where the air bearing is located (9) to a higher pressure than the filter air pressures (1) & (2) promotes an environment in which air floor from the cavity in which the bearing is located flows through the telescopic slides. The migration of air within the telescopic slides provides a further barrier to prevent contaminants entering the air bearing.

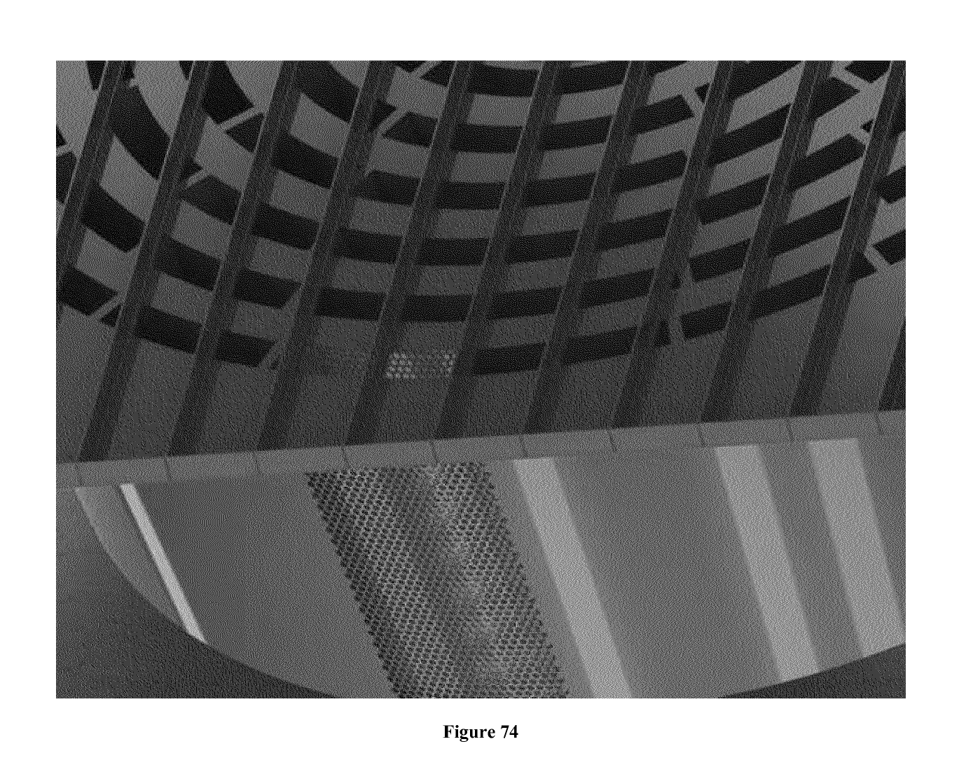

In this embodiment, the rotating nozzle, FIG. 73 (A) is attached to the rotatory air bearing which is capable to clean all surfaces of the cones. With this design, the cones remain static, and are fixed to a back plate in which the back plate is porous and/or has hole cavities to allow filtered air to migrating in the next filtration phases. An example of the cones and back plate is shown in FIGS. 74 & 75 where the design assumes filter media is applied to the outside of the cone as it is today with standard drum filter technology and as such the porous metal mesh is only positioned on the outer surface of the cones.

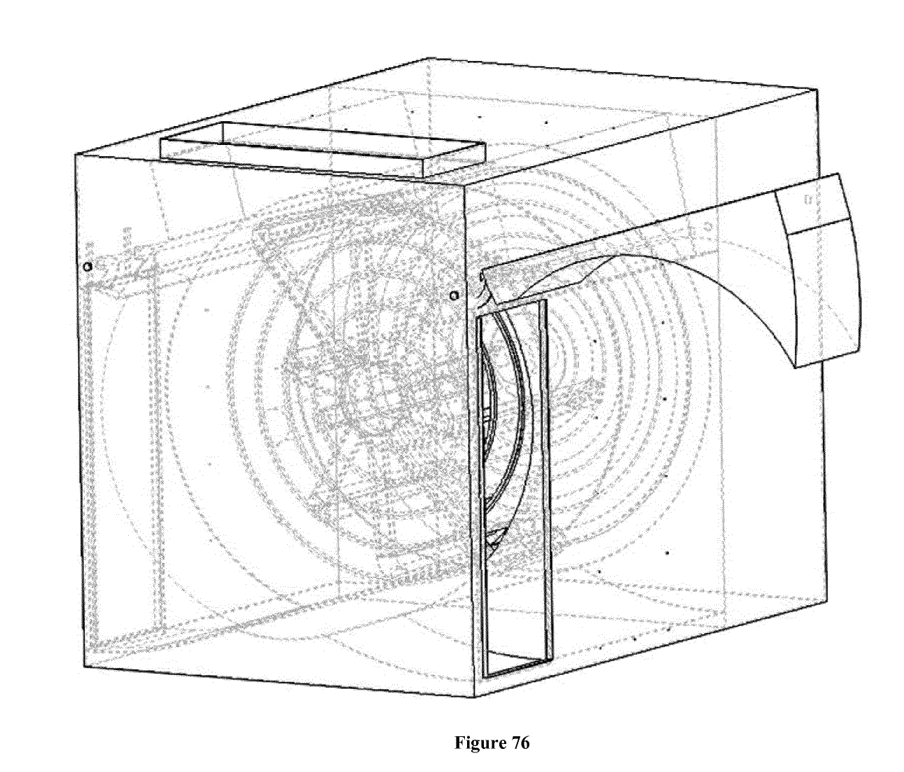

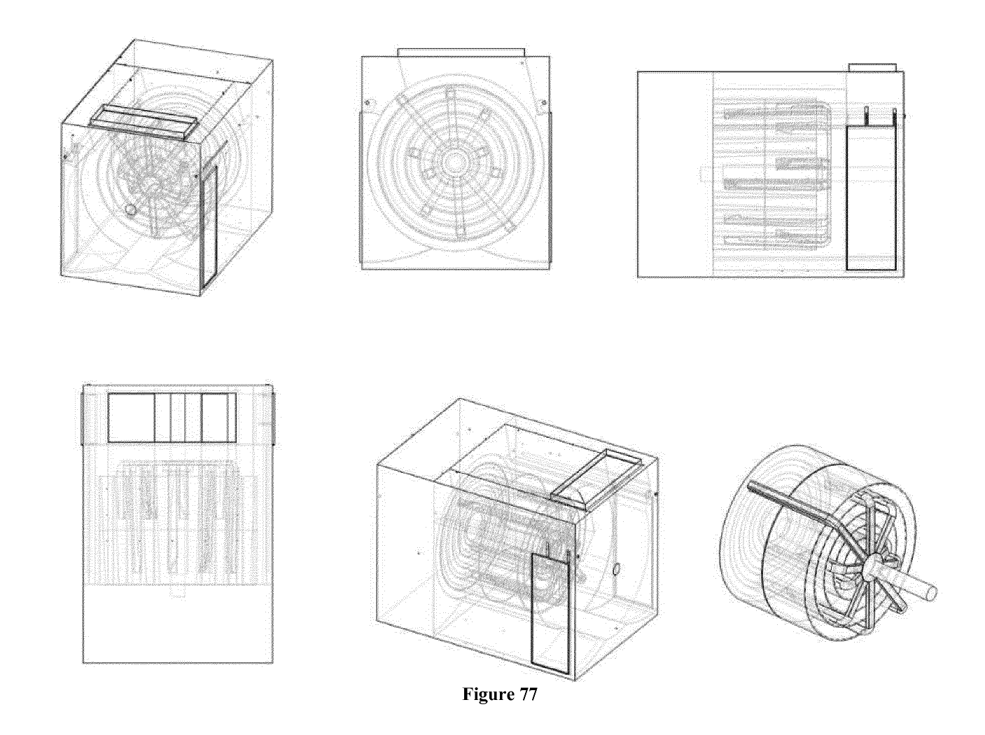

Such a filtration device however by default requires a similar area to be required in the design as the filter depth to allow the filter nozzles to traverse in the required full range of motion needed to clean the full media area. FIG. 76 & FIG. 77 outlines a further embodiment to this invention which utilizes a dual vacuum nozzle concept where 2 nozzles are used to clean a single cone thereby meaning the range of motion of the nozzle is 50% less verses the standard nozzle design.

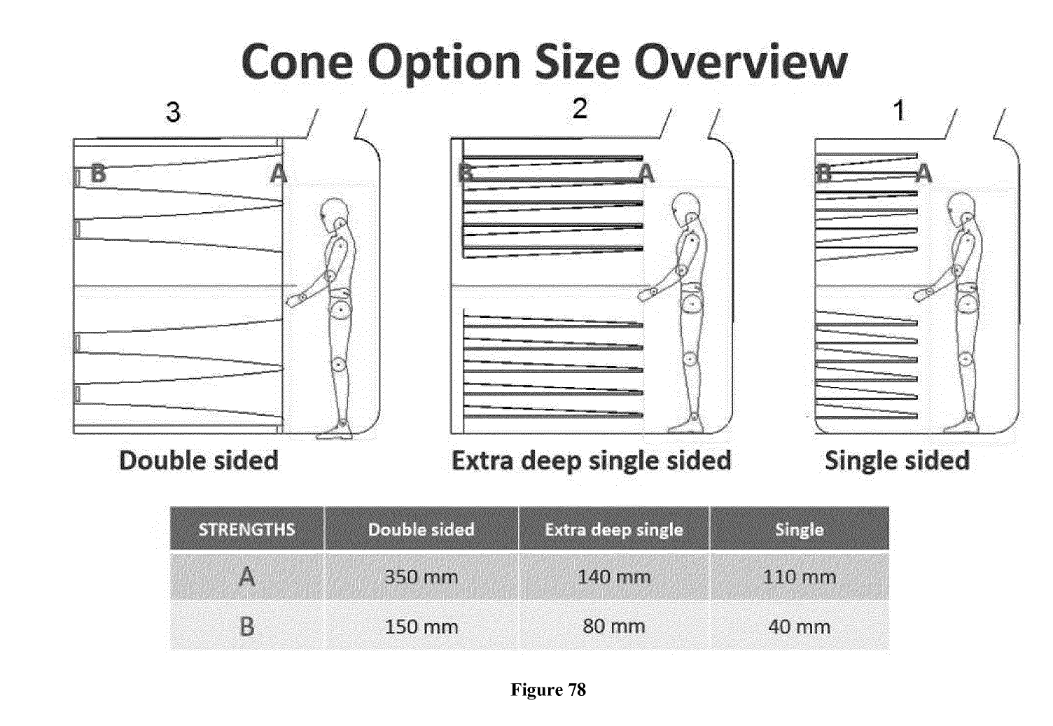

Utilizing the space more efficiently also allows the depth of the cones to be increased which thereby also allows the reduction is cone numbers from 6 to 5 which also increases the gap between the cones for enhanced nozzle and operator access. The advantages of this are shown in FIG. 78 where (1) is the single nozzle design, and (2) is the dual nozzle design where the dual nozzle is depicted in FIG. 73 (B)

All of the above-mentioned embodiments required however between 5-6 cones to achieve the desired media area targets and as such, space between the cones is somewhat restricted. Limited space between the cones is not desired as this restricts machine operator access, however, more importantly, air being removed from the nozzle has to be rotated through a 90 degree bend within the cones and the smaller the width between the cones, the sharper the radius required. A sharper radius typically means more energy losses and more turbulence.

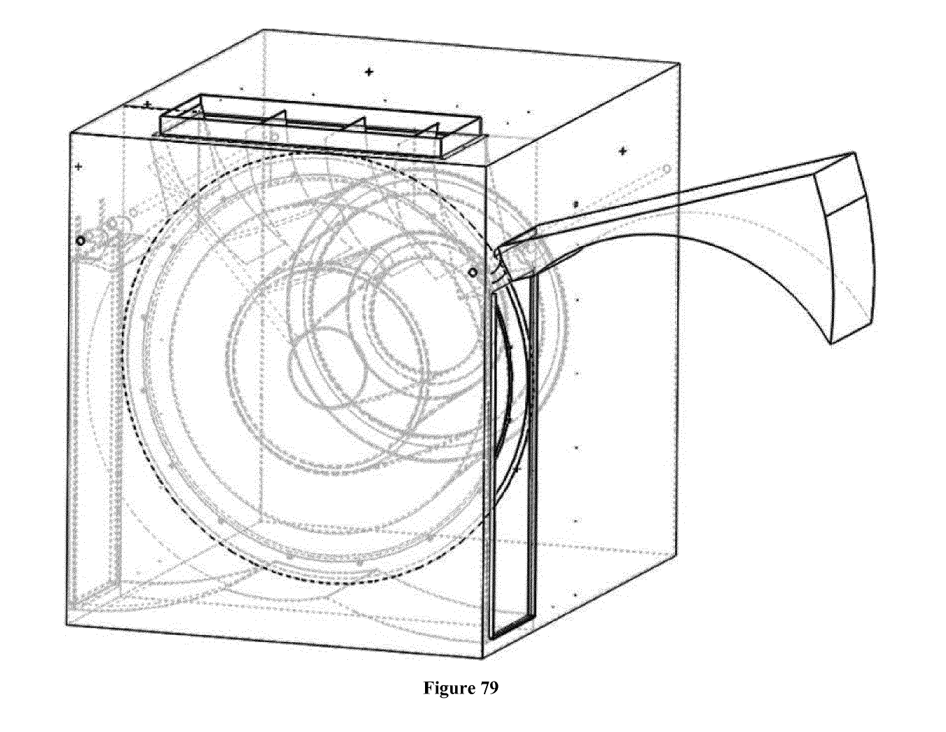

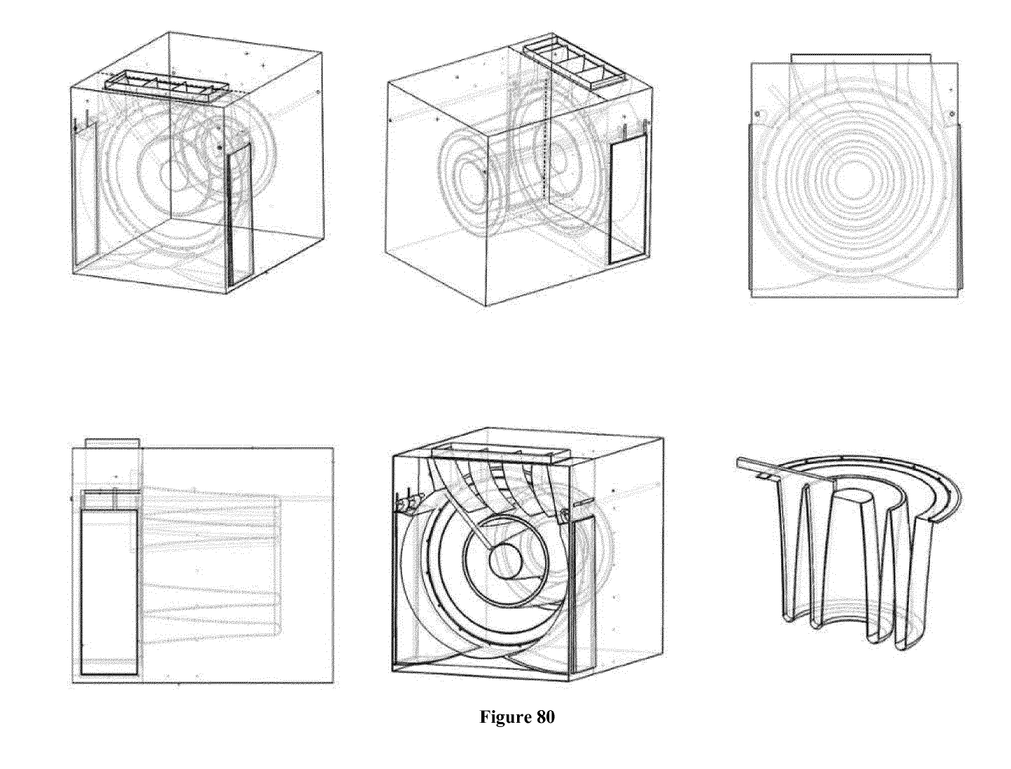

Having a method to attach filter media to the internal surface of the cones would be desired as this would reduce the number of cones by ˜50% and thereby increase the distance between the cones by a factor of ˜2. An example of this design is shown in FIG. 79 & FIG. 80.

FIG. 78 (3) gives an overview of the above mentioned filter inventions where the benefits of applying media to the internal and external surfaces of the drum/cones can easily be seen.

However, simply applying media to the inside of the cone/drum prevents significant technical challenges that are addressed as further embodiments to this invention.

On a typical drum filter today, the drum rotates in MD axis with the filter media being placed around the outside of the drum and fixed in position with a zipper or similar device with enough strength to ensuring there is enough tension build up can be applied to the media to ensure that the media stays fixed to the drum. During the media cleaning process, the nozzle pulls against the media, which essentially tries to pull the media away from the drum with the equal and opposite forces being applied to the media backing which ultimately prevent the filter media from being sucked into the nozzle. In such instances where excessive force is applied be the vacuum and/or, the vacuum nozzle is too close to the media, the media can actually lift away from the drum and becomes entangled in the nozzle.

If the media is positioned on the inside of the drum, then, applying vacuum to the nozzle would simply lift the media away from the drum as there are no opposing forces to keep the media against the drum.

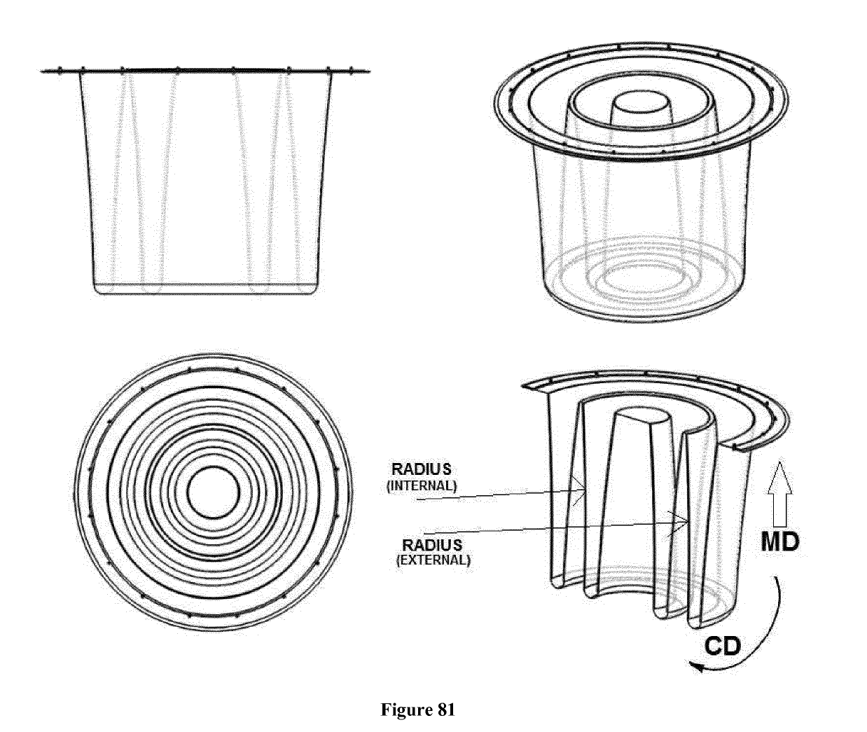

Applying a metal mesh against the media would not be desired, as this would require extra effort when a media change took place and due to the size and format of the mesh, the mesh could change the positioning of the fibres thereby allowing a higher percentage of dust to migrate through the media. Another method to hold the media against the drum would be to create a radius on the internal surface of the drum in MD direction, and, then, apply an MD tension force to the media. In such an embodiment, CD tension would oppose MD tension, so CD tension would be low or non-existent. More details exampling for media design of such a concept is shown in FIG. 81.

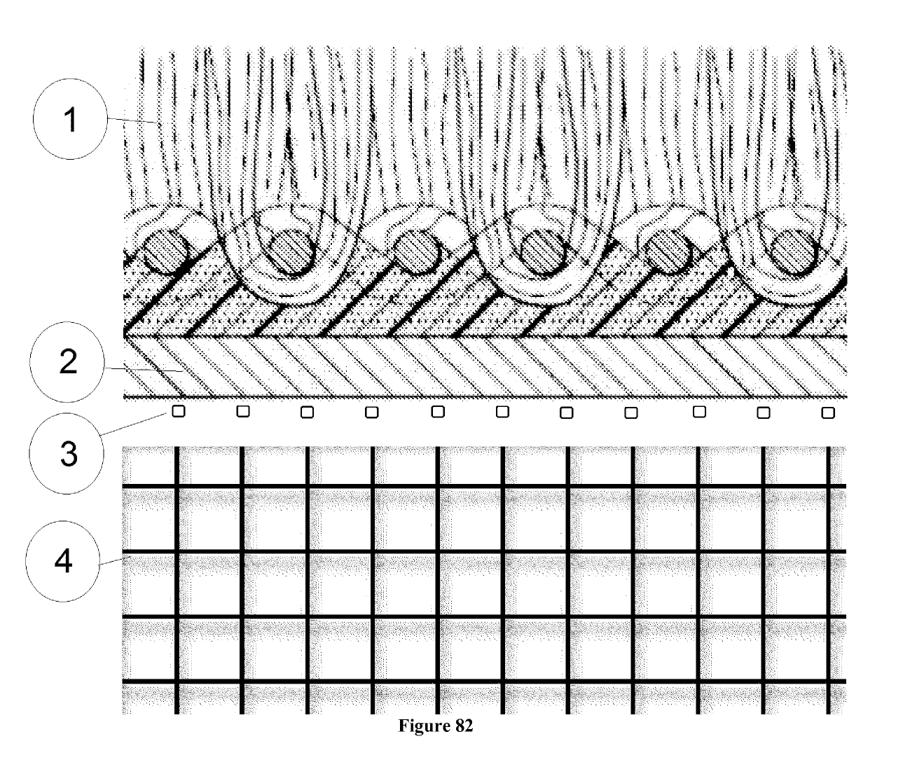

Applying a significant force to the media in MD direction also prevents challenges as typically, filter media is not designed to withstand high tensional forces and joins in the media (such as glue joins, weld joins, sewing joins) provide a weak spot in regard to tensional forces. A further embodiment to this invention is to laminate the filter media to a secondary material, which is air permeable and has adequate tensional strength characteristics, which prevents the media from lifting from the cones. Such a design is outlined in FIG. 82 where (1) is the media filter pile where contaminants are typically trapped, (2) is the media backing, (3) is the secondary backing material which is laminated onto (2) and (4) is an underside view showing a possible backing. In this scenario a connection must exist between (2) and (3) and this could be via welding, sewing, gluing or other bonding method.

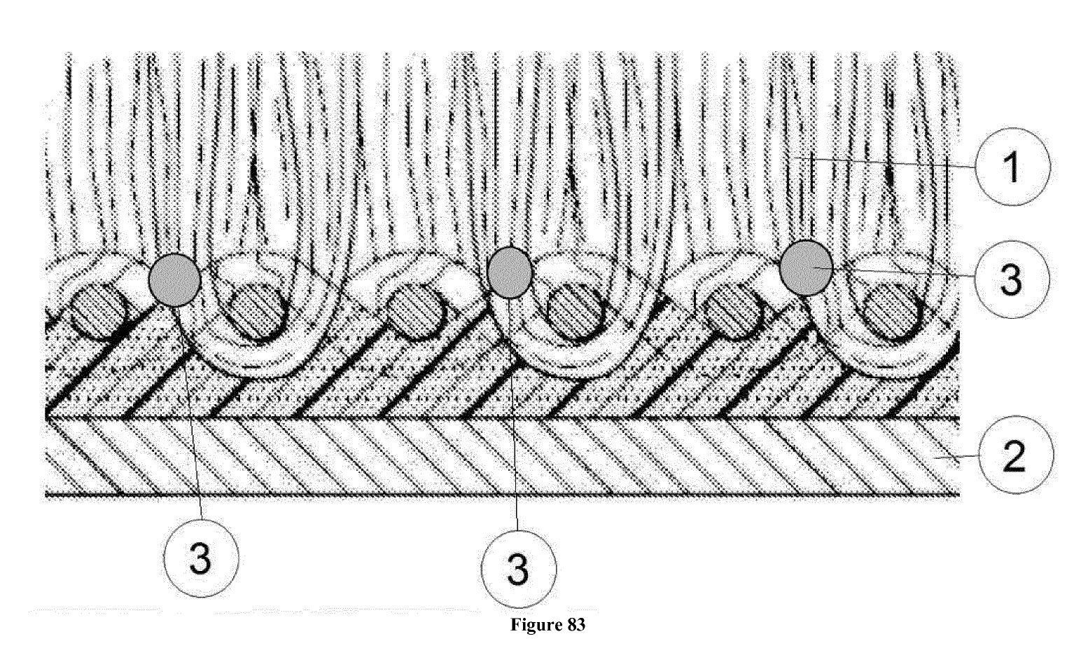

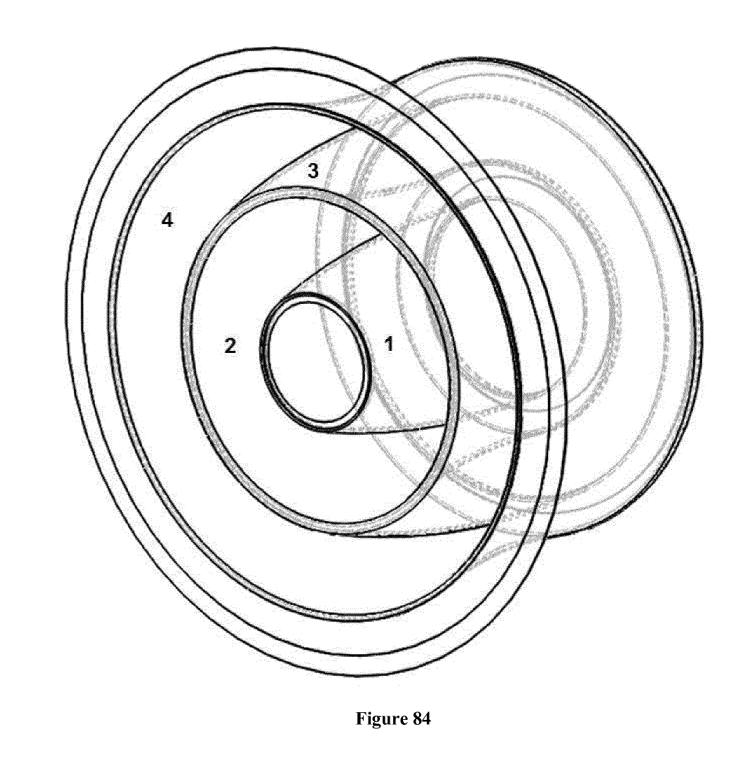

A further embodiment to this media design is the addition of a secondary strings on the pile side of the media with high tensile strength properties as outlined in FIG. 83 where (1) is the media filter pile where contaminants are typically trapped, (2) is the media backing, (3) are the additional strings applied within the media. String could be positioned between 1 to 1 000 000 000 micron but would typically between 10 000 micron and 50 000 micron. The strings referred to herein (3) would typically be made from nylon, polyvinylidene fluoride (PVDF) (fluoro-carbon), polyethylene, Dacron Dyneema (UHMWPE) but could also be made from wire, cable, rope, string or any other material offering the desired tensional properties.

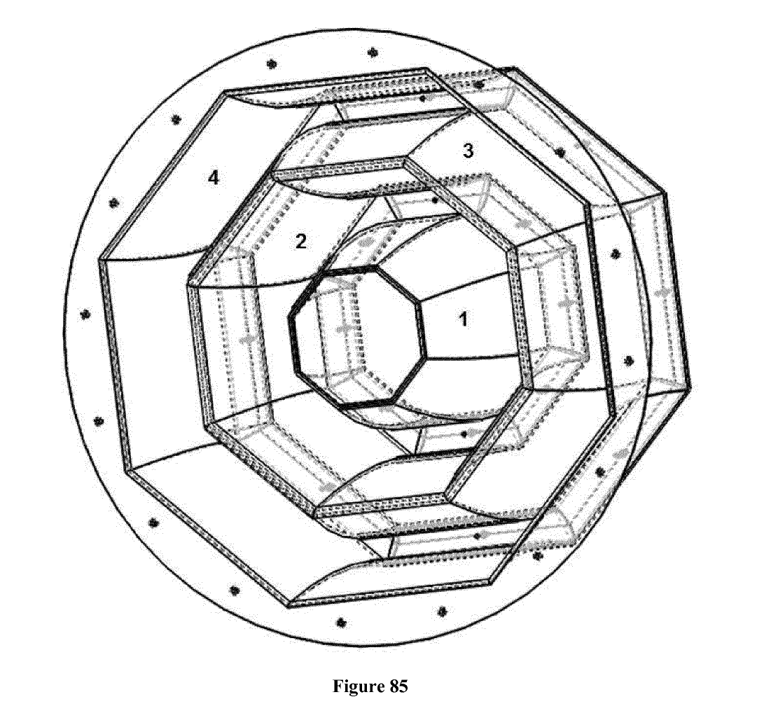

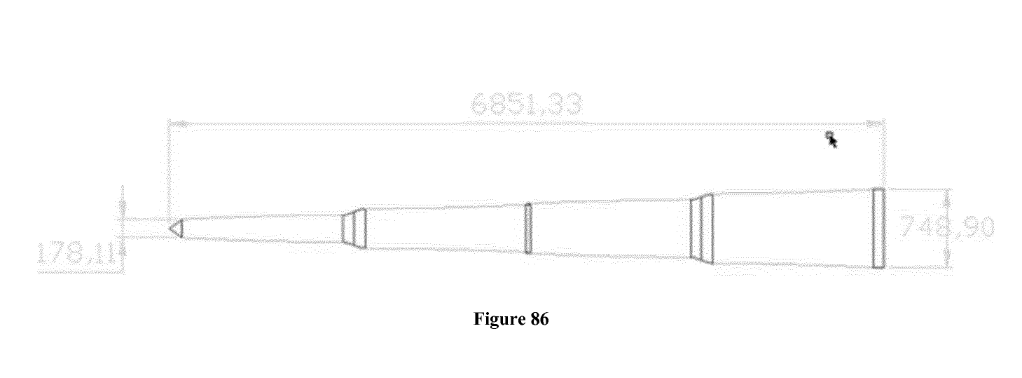

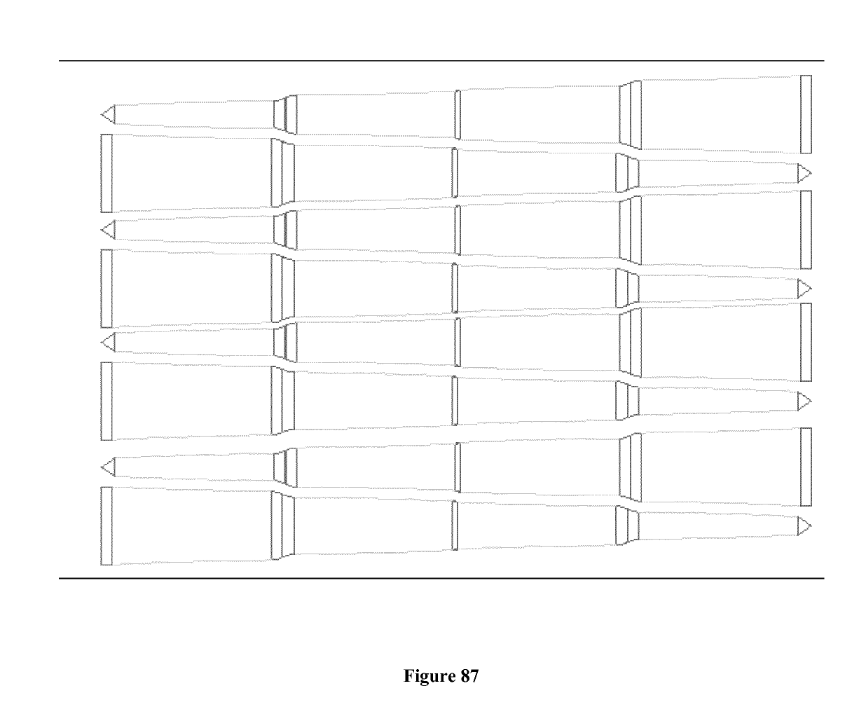

With the above-mentioned design as shown in FIGS. 79 & 80, where the media only is summarized in FIG. 84, with (1) being inner surface, numbered up to (4) on the outer surface, the media on surface (4) has a larger radius in CD as (3), which has a larger radius in CD as (2), which has a larger radius in CD as (1). Due to the decrease in radius, the fibres located on media on surface (1) are further apart verses the fibres on surface (2). By moving away from the circular format and moving to an octagon (or any shape between 1-10 000 sides) means that the radius of curvature of the media remains the same, such as design is shown in FIG. 85. Adopting such a shape means the only radius applied to the media is in MD which is constant on all surfaces (1), (2), (3) and (4). For such an invention, the assembled media would be as outlined in FIG. 86, which fits well into a nested design for low cost manufacturing as, shown in FIG. 87.

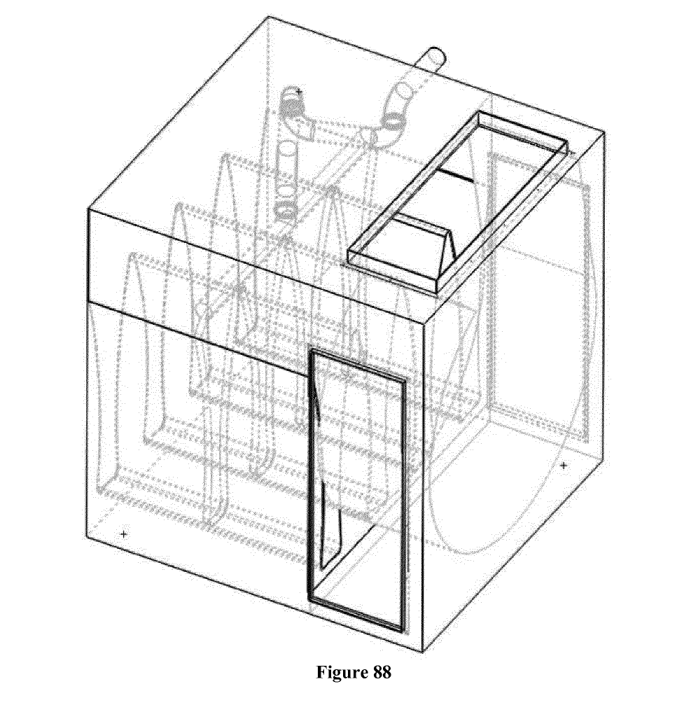

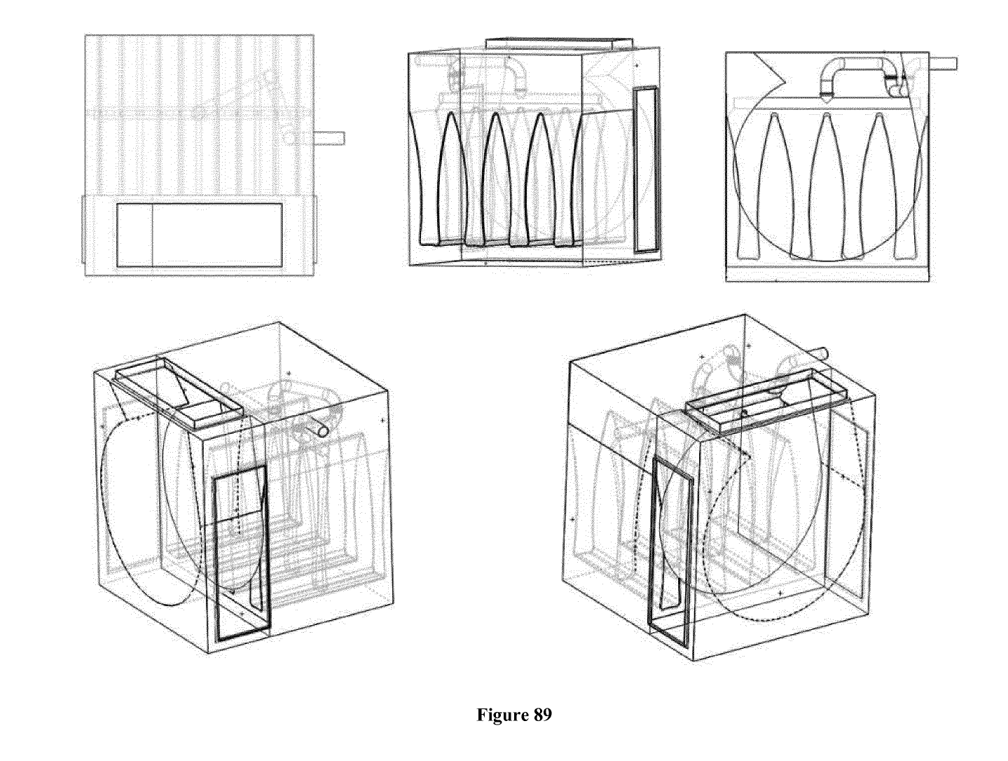

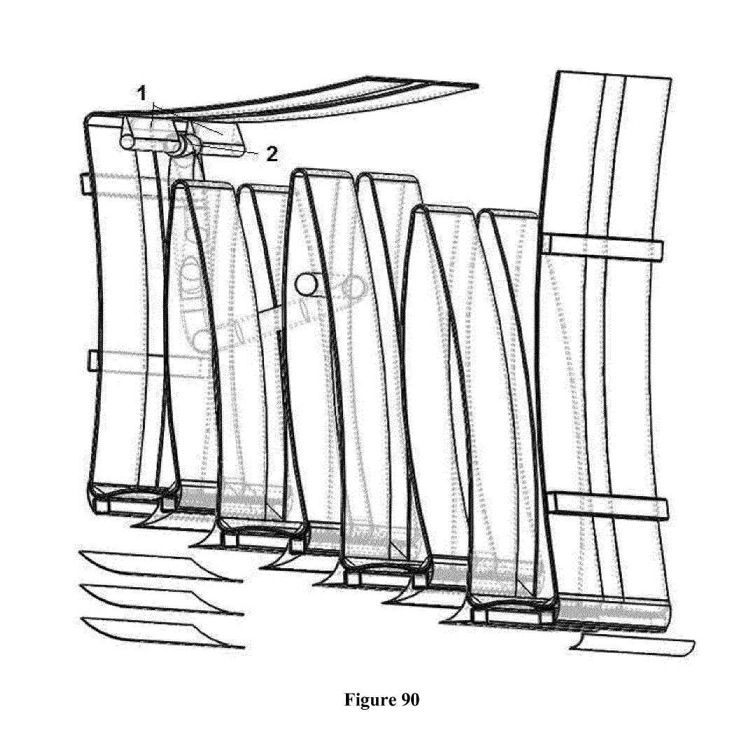

A further embodiment of this invention the additional a new module in which a wave form is used to profile the media. This embodiment has the wave valley direction in MD whilst the cleaning nozzles move in an MD direction as outlined in FIGS. 88 & 89. This design shows the profiled media linked in series with the vortex process described early. In this scenario the vortex area also allows an ideal space for operator access into the filter, however if required both processes could be either combined or fully separated.

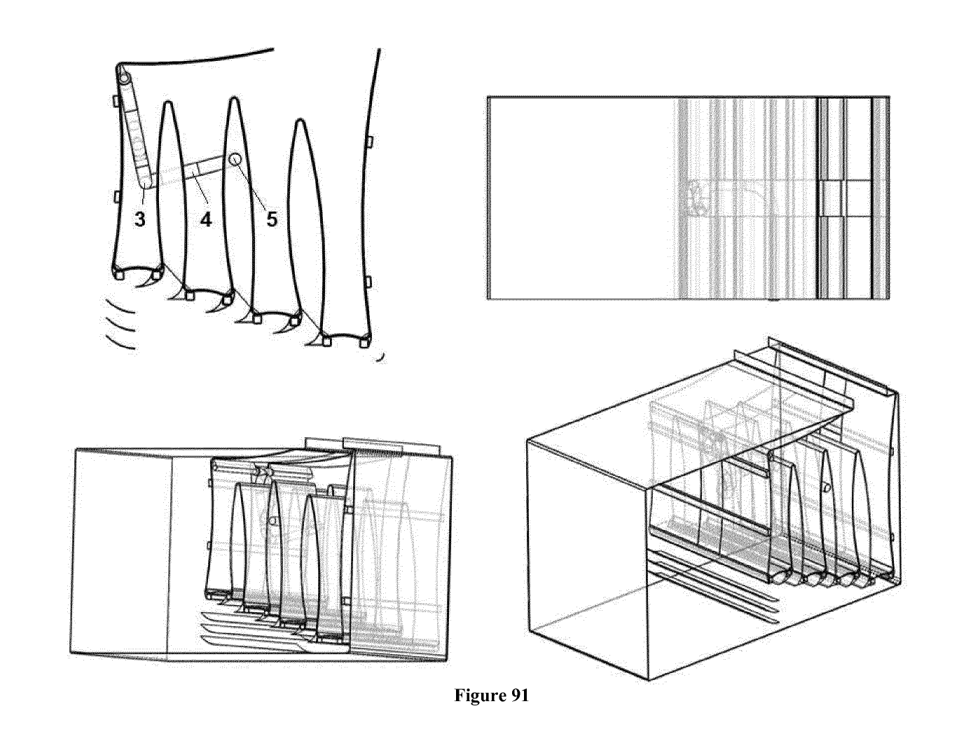

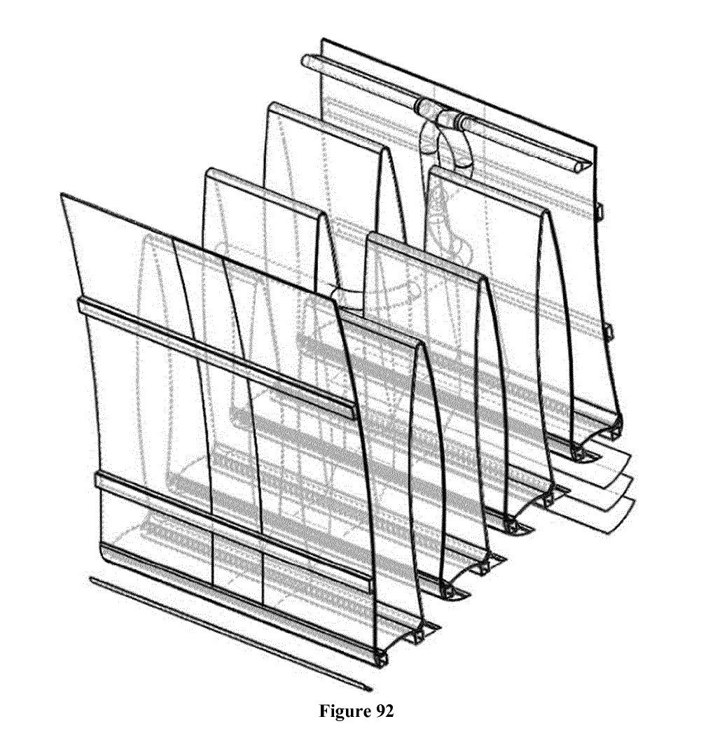

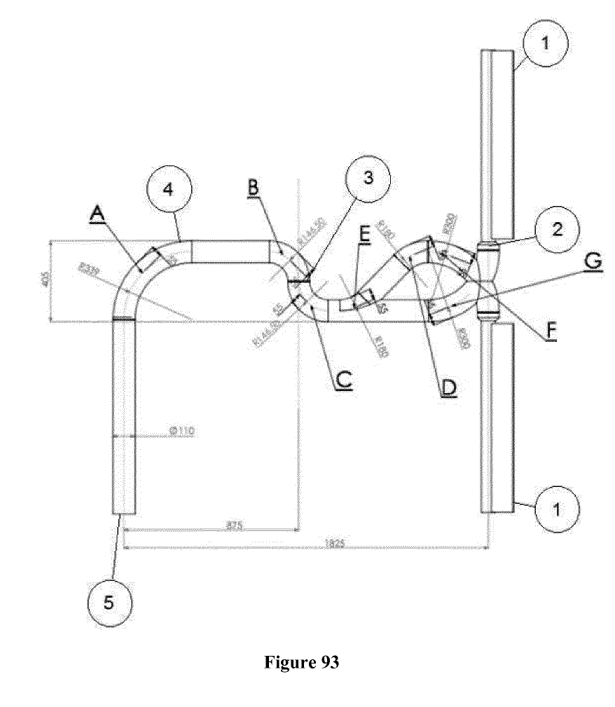

A further embodiment of this invention is to profile the media in an CD direction and move the cleaning nozzles in an MD direction in a profiled motion of axis to follow the media as shown in FIGS. 90, 91, 92, 93 where (1) is the nozzle where the air enters the nozzle, (2) is the main swivel joint on the nozzle, (3) is the main arm swivel join, (4) is the is the inlet arm section, (5) is the air outlet from the nozzle.

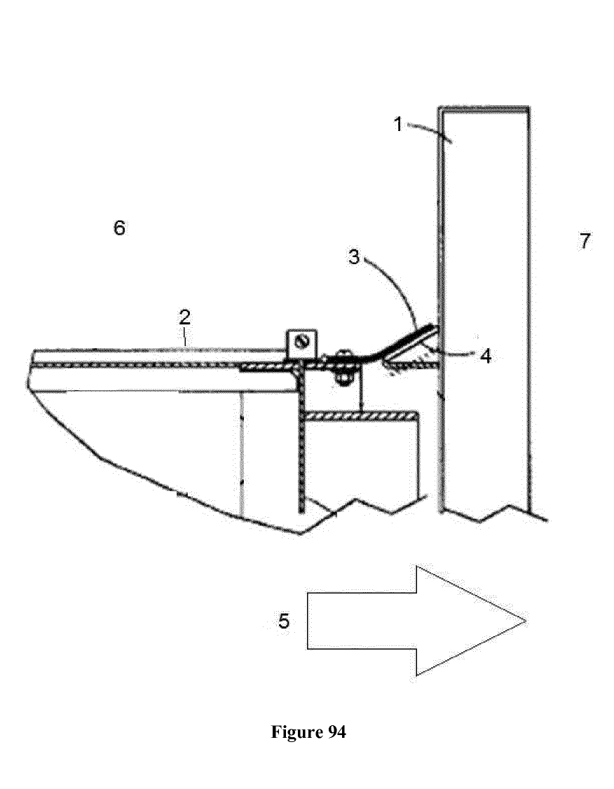

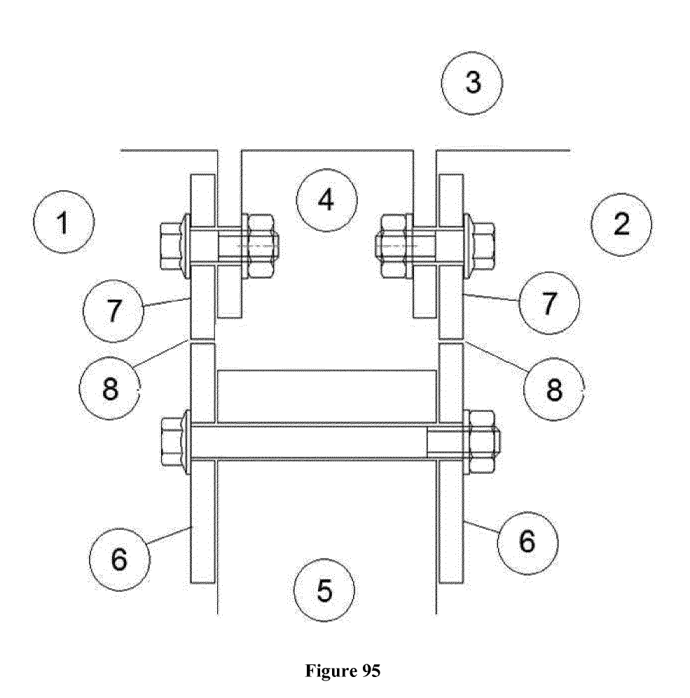

Many of the filter systems included in the modules require a filter seal as the cones/drums rotate where a seal is required between the moving and none moving interfaces. Such a seal is common amount all drum filter technology today where the drums rotated. The drum seal is typically installed between the filter housing and the rotating filter drum and allows the drum to rotate whilst preventing contaminants to pass through the seal into subsequent filter stages. A typical seal design is in use in existing drum filter technology today is outlined in FIG. 94. The seal has typically been a “weak” part of most filter systems and tests have shown that a significant percentage of dust that travels into downstream filter stages has migrated through the seal.

The filter seal is also typically a wearing component as one section of the seal is stationary whilst the other is rotating and high vacuum pressure causing a significant compression force between the 2 seal substrates. Recent improvements in seal design have been application devices, which dispense a low friction powder (such as Graphite/Talcum powder) to reduce friction and wear of the seal.

Other more recent improvements have been to enhance the material composition of the seal so that a reduced amount of friction occurs. Typically, reducing friction and enhanced the interference fit between the 2 seal surfaces reduces dust migration through the seal and power requirements through the drum.

All of these designs however allow dust migrating through the seal to migration in subsequent filtration processes and rely on some kind of inference between the 2 seal segments, which by default creates friction and wears the seal.

Having a dual seal concept where the cavity between the seals is held at a higher pressure than the air before and/or after the seal has process benefits a fundamental change in the design concept which prevents dust from migrating through the seal into subsequent filtration processes would be beneficial as filter life of subsequent filter stages would be significantly enhanced. Such a design also opens up options to install a contactless seal where (1) friction would be eliminated and power consumptions losses in relation to seal friction would be eliminated, (2) the seal would no longer be a wearing component thereby reducing operational losses such as maintenance and repair costs.

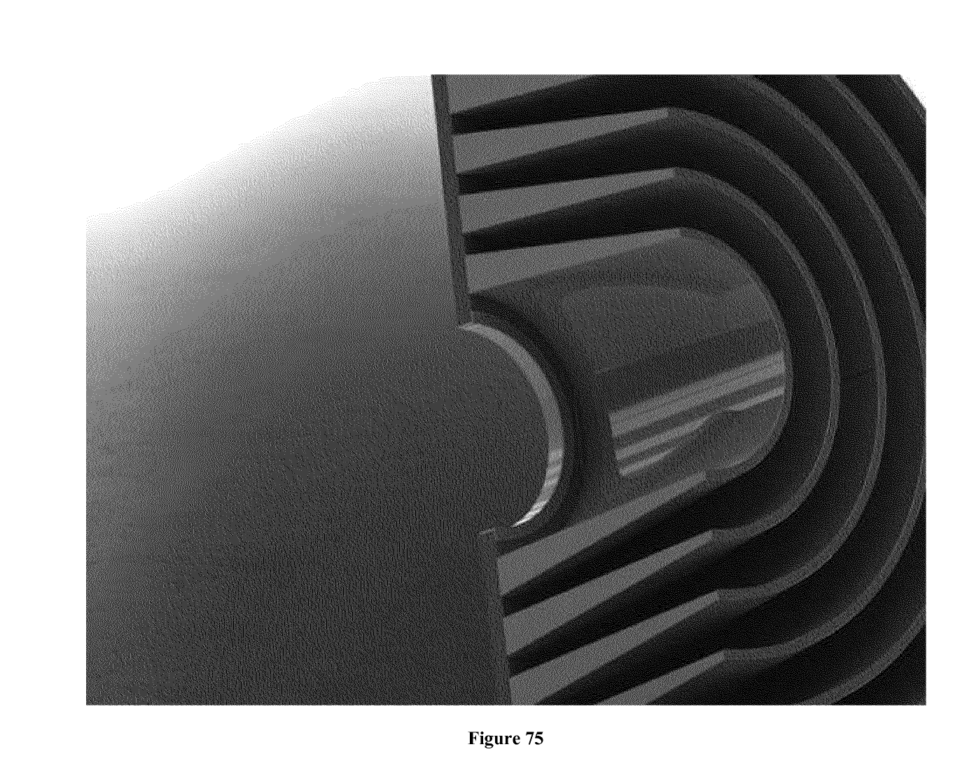

A further embedment of the filter invention is new seal design to achieve the above goals as outlined in FIG. 95 where (1) is the void area where air is entering the filter process, (2) is the void area where air has existed the filter process, (3) is the void area outside of the filter process which is typically atmospheric pressure, (4) is the void area between the 2 seals, (5) is the rotating cone/drum assembly, (6) is the internal seal components, (7) are the external seal components, (8) are the contact area/non-contact areas of the seal. FIG. 76 shows a non-contact design however a seal design as shown in FIG. 75 could also be used in the embodiment shown in FIG. 76 where 2 seals would be used. A key embodiment of the design is the inclusion of 2 none contact seals and have a naturally vented cavity between the 2 contactless seals (4). As such a filter typically operates under negative pressure (void area (2) is typically at a lower pressure than (3) and void area (1) is typically as a lower pressure than (2)) and if void (4) is higher than void (1) and void (2) and would normally be connected to void (3) vented to atmospheric), airflow by default has to migrate from the naturally vented area into the filter process. Not only is it therefore impossible for dust to enter the central cavity, by default, it is also impossible for dust particles to pass from the pre filter stage into the subsequent filter stage.

FIG. 95 (8) on depicts the gap between the stationary and rotary sections of the new seal. This gap could be between 0.0001 micron to 10 0000 micro, but would more preferably be between 1 to 200 micron. With a small gap of say 10 micron, the actual total void area on say a 1600 mm diameter drum would only be 0.5 CM squared or equivalent to an ˜8 mm diameter hole so energy losses through the seal would be minor and in many cases would be less than the energy gains main in reduced seal friction. Adding extra air resistance to the air flows passing through the seal would reduce air leakage loss and could be achieved via using labyrinth seal concepts as already in use in many turbo chargers and jet engine designs.

A further embodiment of the design is to install a secondary filter system which to prevent contaminants from entering the cavity area shown in FIG. 95 (4). This filter system would typically be a non-active filter system similar to an air filter system installed on a family car with period replacement defined in the maintenance schedule.

A further embodiment of the design is to install an automatic cleaning system for the cavity area as shown in FIG. 95 (4). Typically the cavity would never contain any contaminants as air entering the cavity would be filtered and due to the negative pressure in the filter, air would always flow from the cavity area into the filter, however, some scenarios may exist where the filtration system is not set up correctly, and, or the filter at the inlet of the cavity becomes damaged and contaminants could become positioned within the cavity. To remove the seal(s) to gain access for cleaning would be time consuming and could result in many hours of down time. A cleaning system using air is therefore installed where the passing of air within the cavity is used to clear any contaminants within the cavity. The cleaning system would typically be active manually where required however, an automatic system could be installed where at a given time interval the civility is cleaned, or, on start-up(s) and/or shut down(s), the cavity is cleaned.

A further embodiment of the invention is where the cleaning system outlined in FIG. 92 (4) is also connected to the buffer cleaning system outlined in FIG. 57 (1) i.e. when the contents of the floor sweeping buffer are removed, a seal cleaning cycle is also completed.

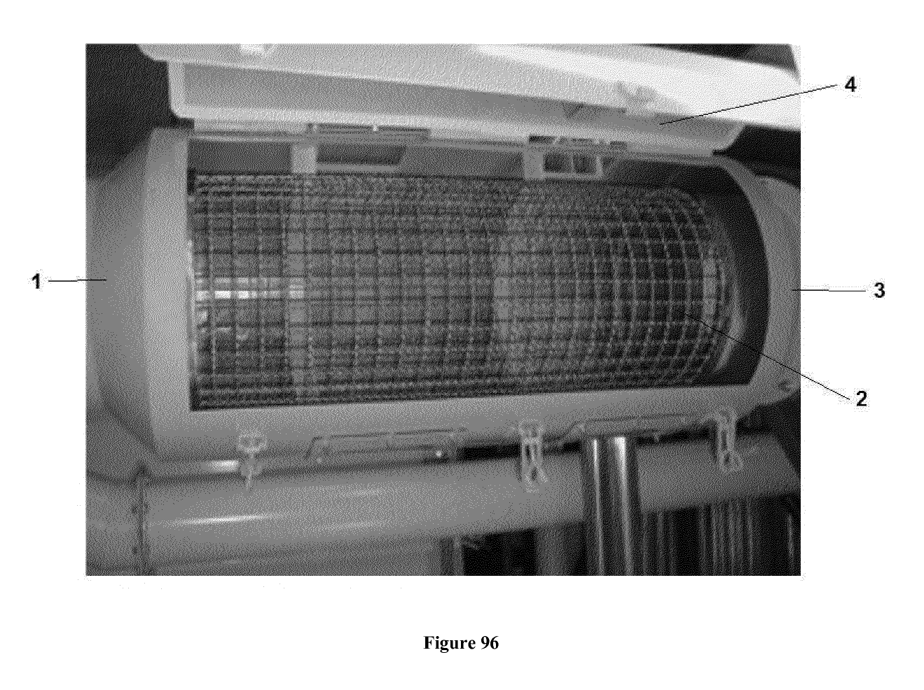

A further embodiment to the invention is an addition of a new contaminant capturing system for large contaminants entering the filter. FIG. 96 outlines a typical system used to capture large contaminants today typically before fan entry where (1) depicts the entry of air & particles into the system, (2) depicts the mesh, (3) depicts the outlet ducting of the system, (4) depicts the entry hatch for operators to gain access to the mesh to remove contaminants. The system typically consists of a fixed mesh, which captures larger contaminants and prevents them from entering the filter system. Such a system is typically installed on each fan inlet into the filter. Upon blockage, contaminants are required to be removed by hand. The general concepts of a combined vortex and operator access areas as outlined in FIGS. 60 & 61 also have additional layout benefits to install a central capturing system. With all fans outlets entering into the filter container in close proximity directly where operator access is a fixed or automated contaminant removal system can be installed.

Bringing the contaminant collection point into a single area also has benefit for supervision purposes as the video camera system supervising the stage 1 filter process can be positioned so the contaminant collection point can be observed.

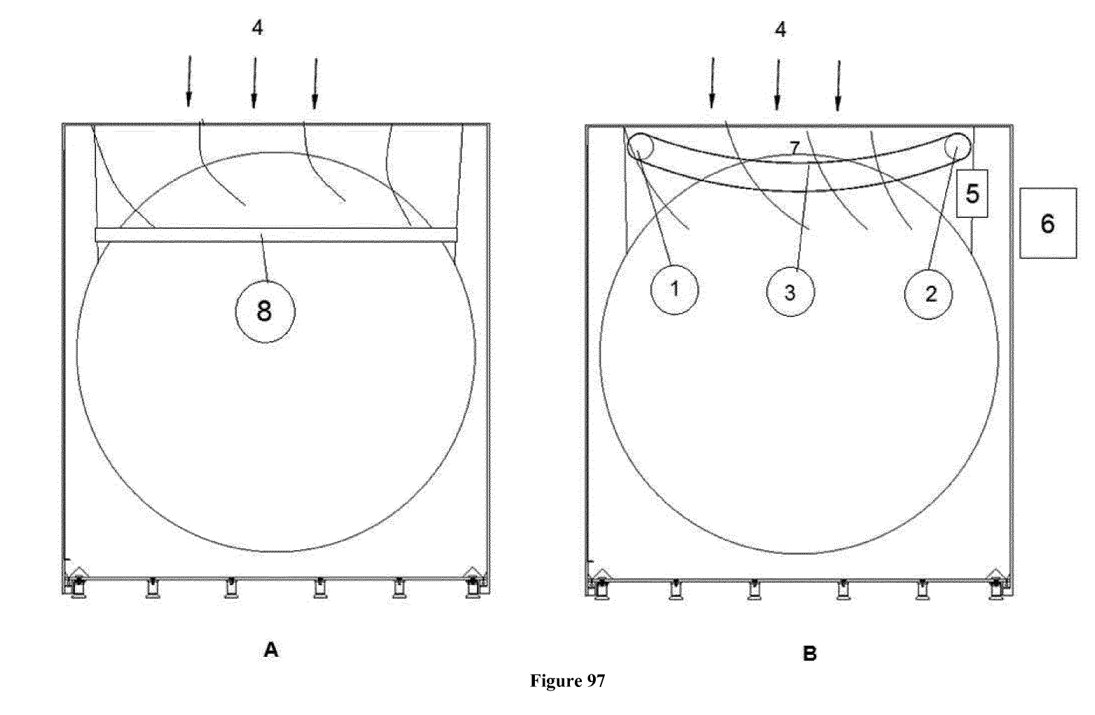

FIG. 97 A (4) outlines the air entry point, with (8) outlining a possible positioning of the mesh. FIG. 97 B outlines the concept of an automated solution where contaminants can be removed from the incoming air stream without manual intervention where (1) & (2) outlines conveyor drive points, (3) outlines a conveyor which could be straight or curved and either fixed in position against a vacuum plate or free hanging and a collection point (5) (inside filter) and collection point (6) (outside filter) where contaminants are transported from air stream (4) which land on conveyor (3) which are withheld on the conveyor at (7) which are then transported to either position (5) or position (6).

A further key component in the filter system is an upgrade package for the standard filter system, which allows the removal of the cyclone system. When filtering fine dust such as talcum powder, graphite powder, or hygiene product(s) where a high percentage of fine low-density dust particles exist, a scenario can occur where such dust particles can pass directly through the cyclone. This in turn causes the dust to be re-deposited back within the stage 1 filter process and with evermore fine dust being fed into the filter process at some time, significant levels of dust can build up within the filter is not only requires manual cleaning but also increases the risk of explosion(s) and/or fire(s).

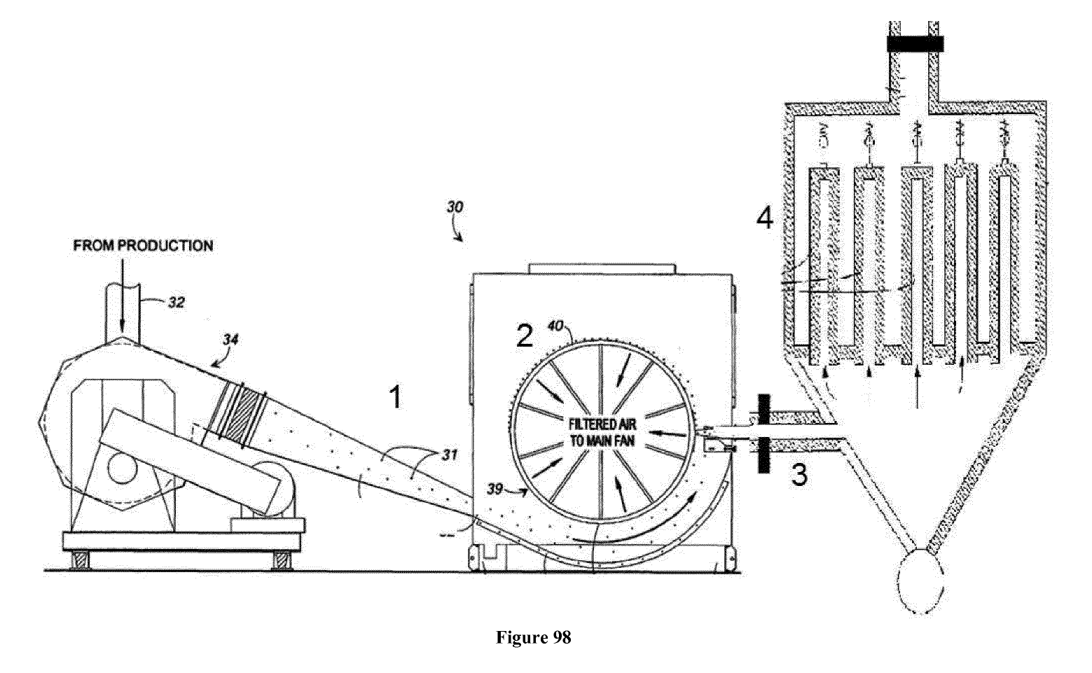

One solution to solve the problem is to feed the cleaning nozzle outlet air into a cartridge filter and/or bag house or similar filtration system which is outlined in FIG. 98, where (1) is the entry point from the production system (2) is the drum filter, (3) is the dust removal point from the drum, (4) is the cartridge filter/Bag house filter. Such a process layout eliminates the need for a cyclone system and thereby eliminates re-feed to of nozzle air back into the filtration system. A significant disadvantage however is the physical size of such a filter system as shown in FIG. 98 (4) and the additional capital costs together with on-going maintenance and repair costs. The addition of additional bag-house filtration systems is also detrimental to the shipping container plug & play concepts outlined herein.

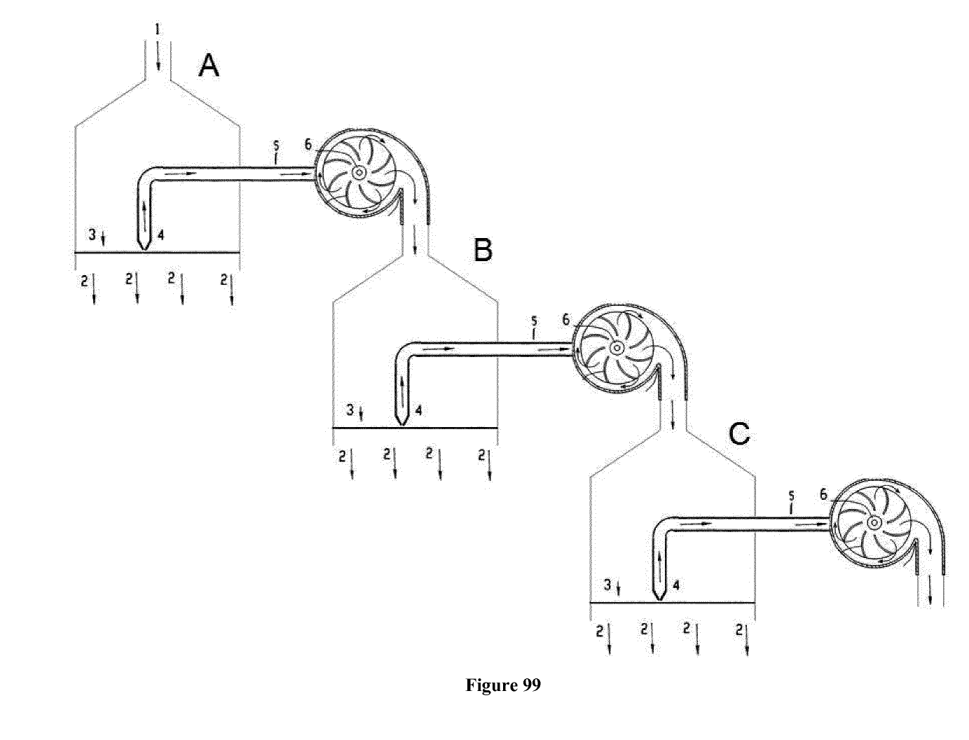

A further embodiment of this invention is to connect multiple stage 1 filter processes in series so the nozzle output from the main filtration process is fed into the second stage 1 filter process, the nozzle output from the second filtration process is fed into the third stage 1 filter process, the nozzle output from the third filtration process is fed into the fourth stage 1 filter process and so forth. Which each transition from filter process to filter process, air volumes decrease and as such overall filter size and respective media size also decreases. A process flow diagram as shown in FIG. 99, where (1) is the main air entering the filter, (2) is the clean air existing the filter, (3) is the filter media, (4) is the contaminated air being removed by the vacuum nozzle, (5) is the contaminated air flow stream into the nozzle fan, where (6) is the nozzle fan, where (7) is the final nozzle fan output which would be fed into a cartridge filter/bag-house filter system, (A) depicts the first filtration phase, (B) depicts the second filtration phase (C) depicts the third filtration phase.

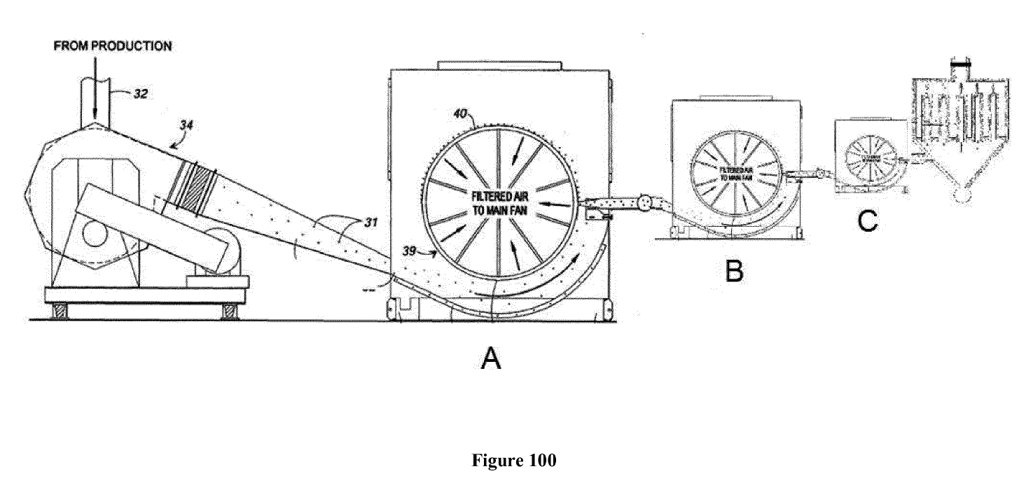

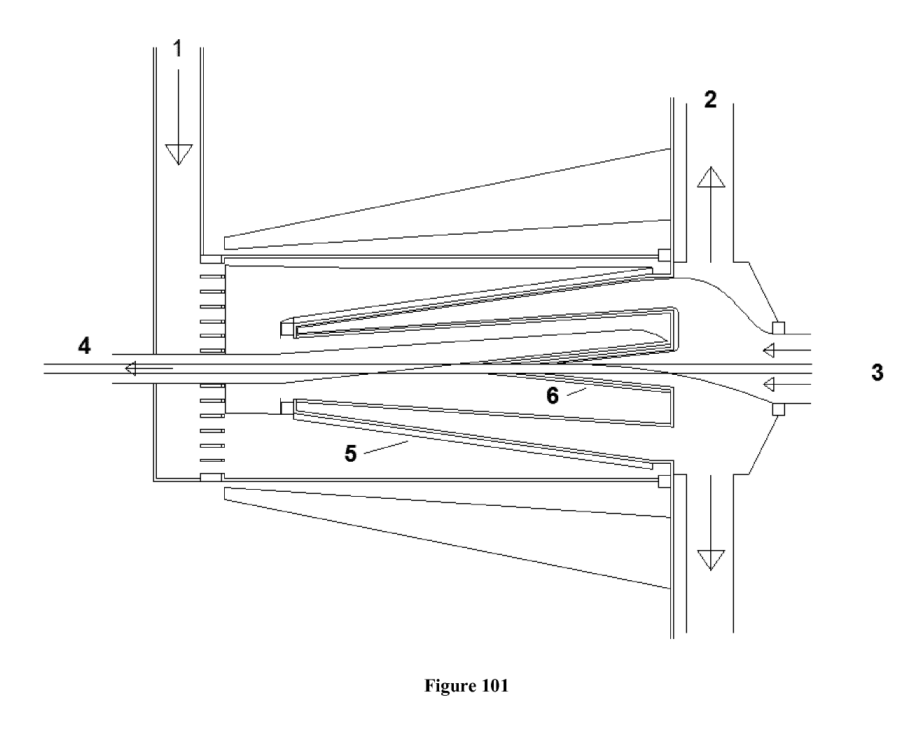

The process layout depicted in FIG. 99 is a general process concept and can be executed in a number of configurations. Furthermore, there is a significant reduction in nozzle air flows in each step, so the media size would be significantly smaller in FIG. 99 (C), verses FIG. 99 (B), verses FIG. 99 (A). A drum filter to drum filter scenario could exist as shown in FIG. 100 where (A) is the first filtration phase, (B) is the second filtration phase, (C) is the third filtration phase. As the inner space of the cone scenario outlined in FIG. 67 (7) is not utilized, this would be a perfect location to located secondary nozzle air filtration systems(s). FIG. 101 outlines a rotatory multi stage filtration concept where (1) is the incoming air stream from the nozzle(s), where (2) is connected to the nozzle fan, where (3) is venting air applied to the underside of the cleaning nozzles to increase nozzle cleaning efficiency, where (4) is the exit point of the final filtration process, where (5) is the Pt nozzle stage filtration media, where (6) is the 2^{nd} nozzle stage filtration media. In this embodiment, items 1, 3 and 4 rotate and items 2, 5 and 6 remain fixed.

This scenario depicts a total filter concept where 2 additional filtration phases exist for the nozzle contaminated air stream, however this could range between 1-1000 stages.

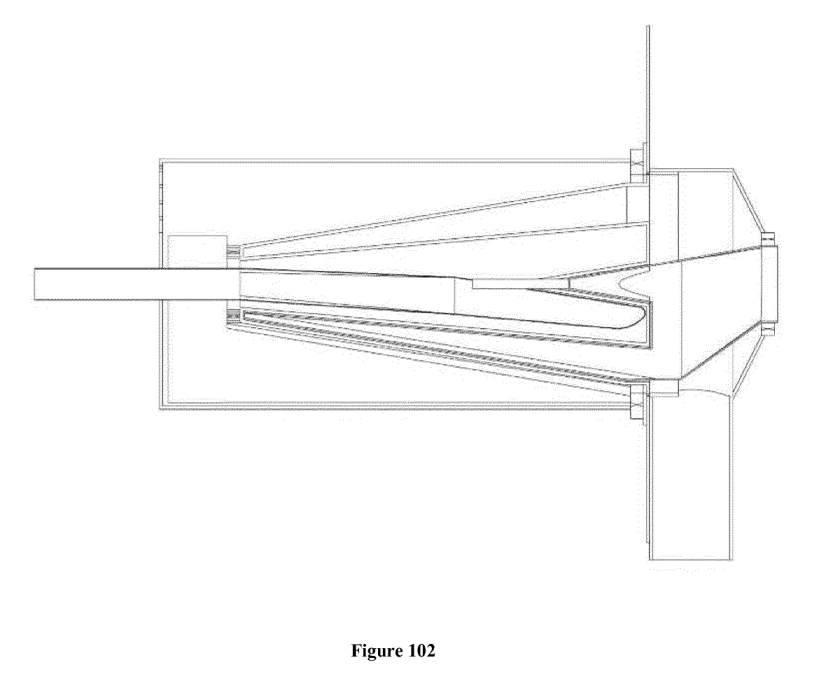

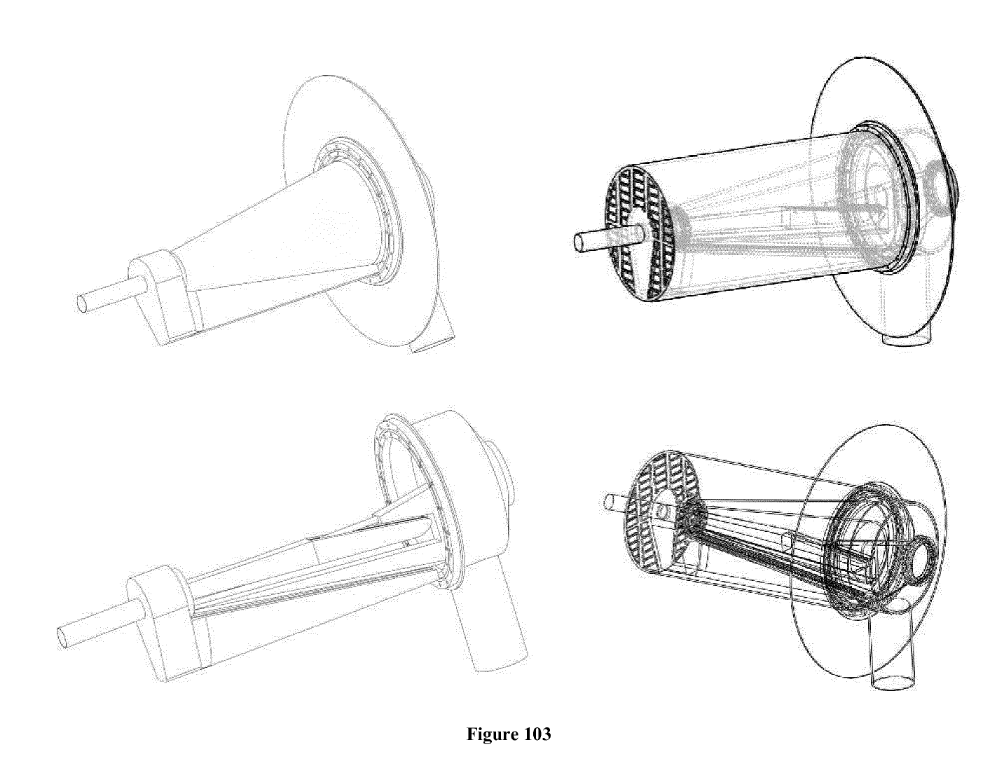

A further embodiment to this invention is to use a combined drive where only 1 drive system is required to drive the nozzle cleaning apparatus and/or relief air for all filter stages. Further outlines of this design are shown in FIGS. 102 & 103.

A further embodiment of this invention, which would typically be used for a stage 2 or 3 or 4 filter process, is the use of a dedicated mobile filter-cleaning device which can be used in filter stages typically referred to as “passive” where no filter cleaning device exists, and/or, to replicated processes where compresses air is used to clean filter media.

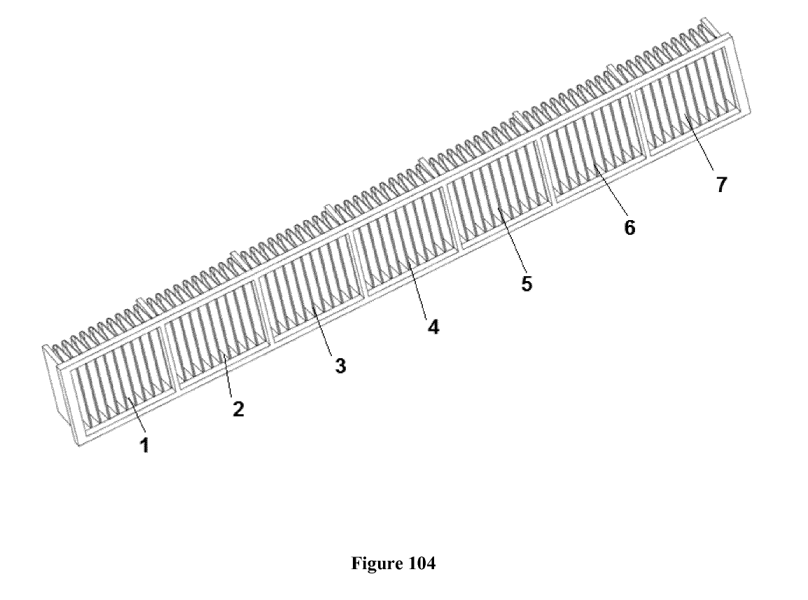

Many stage 2 & filtration processes today typically rely on compressed air for cleaning (not desired as this causes dust emissions within the filter environment) or the dust is allowed to settle within the media and is removed when the filter media is replaced (not desired for cost reasons). Being able to clean the stage 2, 3 and 4 media would be advantageous, however, with limited space media inserts are required to be located as close to each other as possible, gaining access for media cleaning and achieving the correct air velocities can be problematic. FIGS. 104, 105, 106, 107, 108, 109, 110, 111, 112 outlines a mobile cleaning device which moves from filter insert to filter inserts and intermittently cleans each filter insert.

As the filter insert has a very high surface area, even removing a large amount of air from the entire insert has limited cleaning potential. A key embodiment of this invention is a channelling device within the cleaning device which allows air flows to be directed at a specific point on the filter media allowing smaller sections of the filter insert to be cleaned at any moment in time. The device consists of a driven vehicle, which drives continuously through the filter media wall which stops at each media insert. The media insert is shown FIG. 104, which is split into multiple sections, which in this example is 7 however, this could vary between 1 and 100.

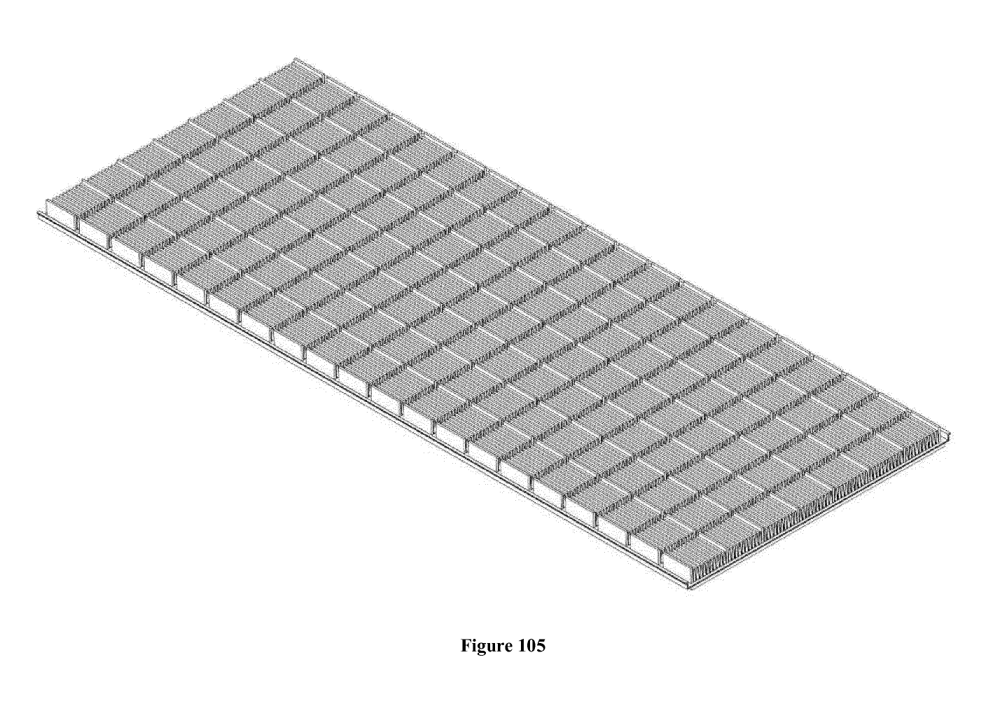

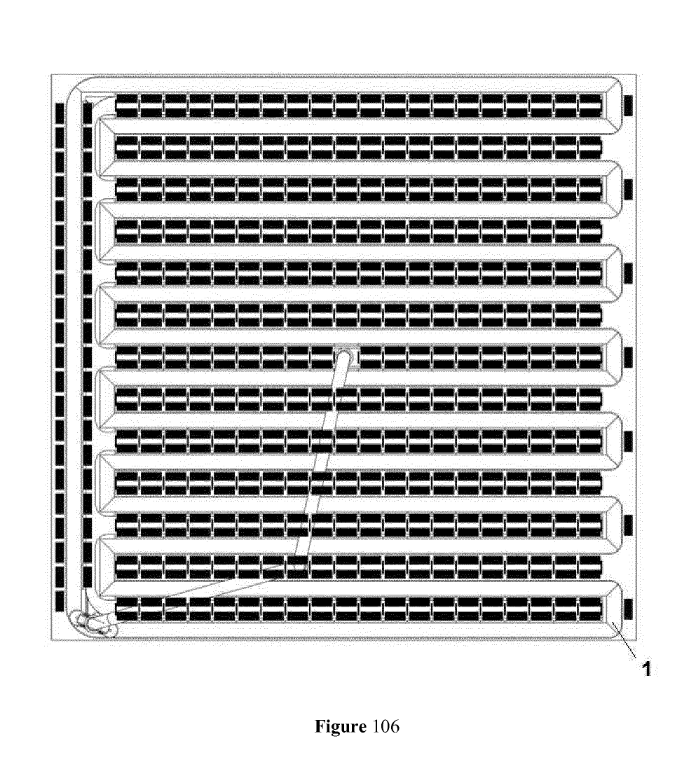

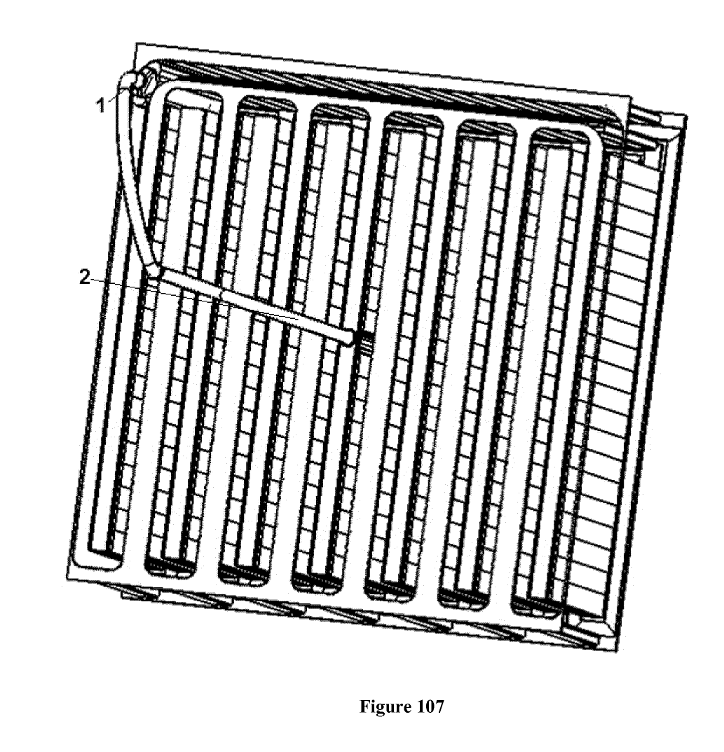

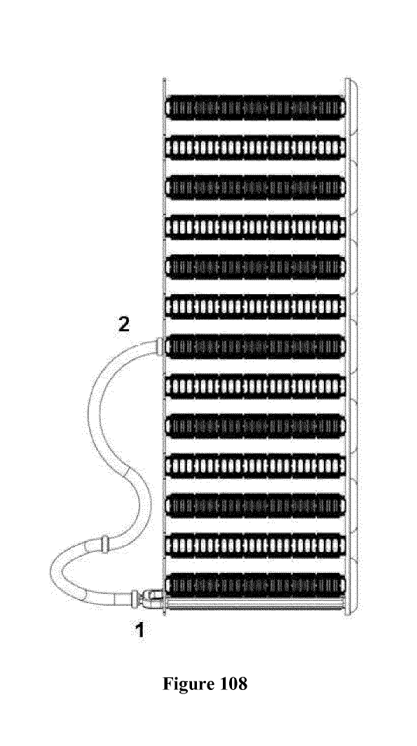

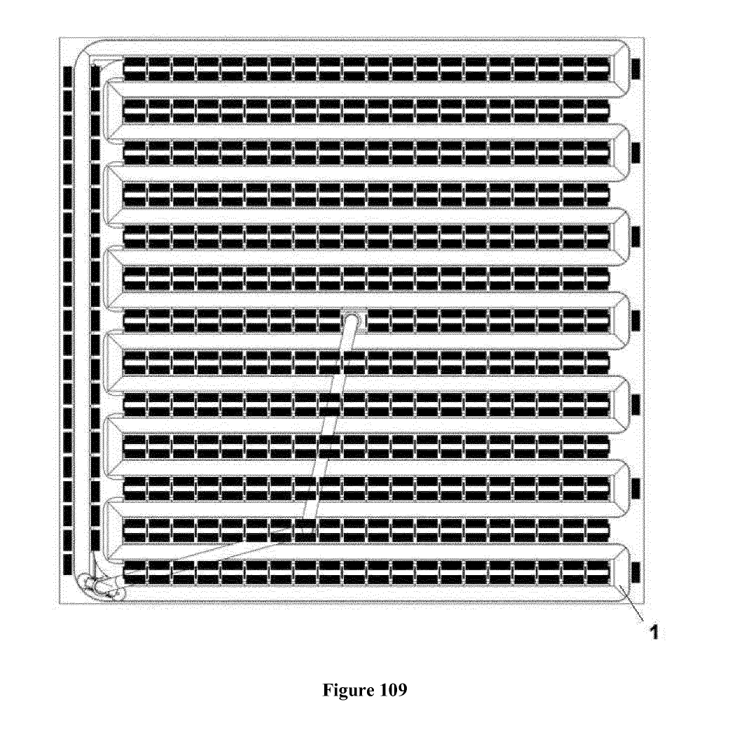

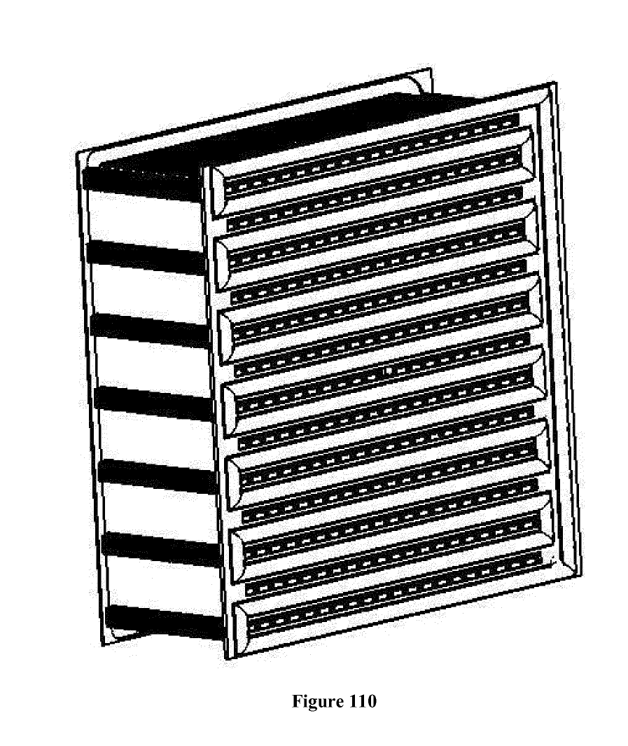

The splitting of the total media into smaller sections allows higher air velocities to be achieved across the media that gives a far enhanced cleaning of individual cleaning of each section to take place verses attempting to clean the entire media in 1 cleaning cycle. FIG. 105 depicts a number of media inserts assembled side by side which would form a media wall. FIG. 106 shows a multitude of walls joined together with a slot to allow access for cleaning and media replacement and in this scenario; the slot (1) is a continuous slot, i.e., is joined together. FIG. 107 shows a 3D image of the total filter wall which also shows (1) a vehicle which travels in the slit to clean the media inserts, and (2), a vacuum source connected to the vehicle. FIG. 108 shows the assembly from the side with the centrally located vacuum ducting with FIG. 109 depicting the front end elevation and FIG. 110 the rear side view of the filter wall.

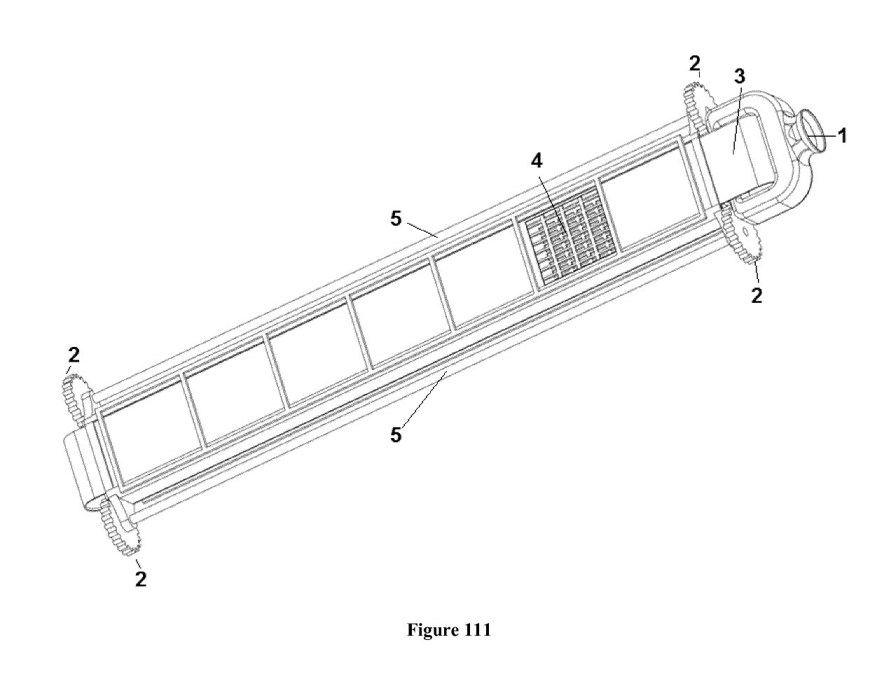

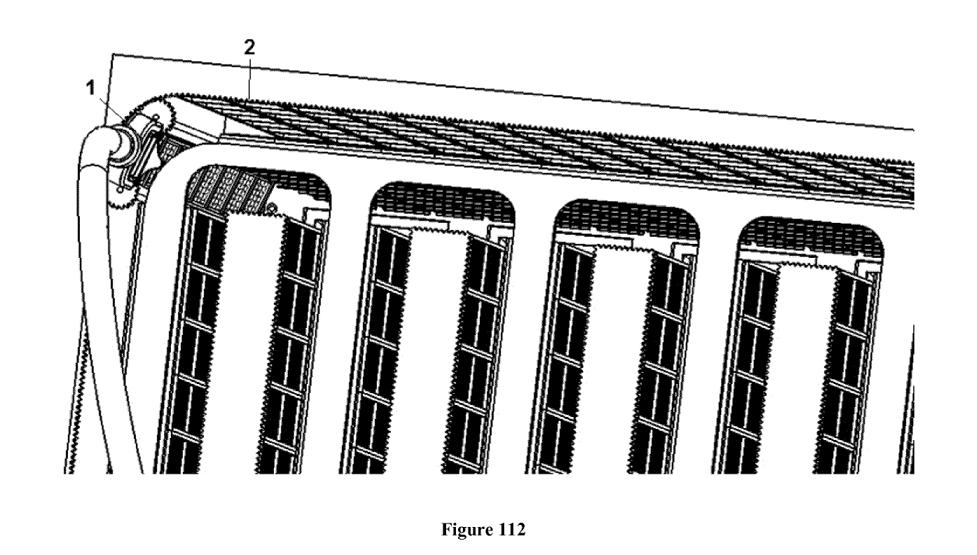

The vehicle is shown in FIG. 111, with (1) the vacuum inlet area, (2) the driven drive wheels which in this instance are connected via 2 shafts (5), with (3) the driven valve belt which diverts vacuum to a particular zone, (4) a vacuum zone currently open for cleaning and (5) the drive shafts. FIG. 112 depicts with the vehicle (1) in position with the geared profile (2). Once positioned above the filter insert, the vehicle clamps itself against the media using a compressional force, then direct vacuum to a single chamber within the media and once cleaned, then directs vacuum to another chamber for subsequent cleaning. Due to the direct linking of the channels within which the vehicle moves, the entire process is a continuous process which could take between 1 minute to 10 000 minutes to complete a full cycle but would typically take between 100-200 minutes for a complete cleaning cycle to take place.

A further embodiment of this invention is an additional equipment option that can be installed after the outlet of the main fan process and is designed specifically for FMCGs manufacturers who are wishing to reduce their electric costs and respective CO2 footprint by utilizing geo-thermal sources to reduce HVAC energy requirements. The system consists of an air cooler connected to geo-thermal sources, which is essentially similar to a household geo-thermal heating system but works in reverse to cool air leaving the utility system.

For FMCG manufacturing sites with HVAC systems already installed the system can work in conjunction with the existing HVAC system(s). For sites which do not yet have HVAC capability and where plants managers are wishing to comply with more stringent QA criteria (predominately related to insect and vermin contamination risk) and operate their production facility with a closed door policy, the system offers sites a low cost environmentally friendly total HVAC solution which fully utilizes quad stage HEPA filtration technology. The system control interface continuously monitors internal and external air temperatures and moisture levels and continuously adjusts flow rates between the geo-thermal energy loop, external and internal air recovery systems to ensure lowest possible energy usage and essentially allows companies to achieve up to 100% air recycling on a continuous basis within their factory irrespective of external weather conditions. Offering a dust free production environment not only creates a healthy environment for employees but is also proven to significantly reduce staff attrition rates and increases staff productivity. For FMCG companies using SAP in their production process, running convertors in a controlled moisture environment also improves production efficiency with significantly reduced cleaning effort requirements.

The system is forms part of the modular filter plug & play platform technology based on ISO 6346 shipping container standards. For clients with existing filtration equipment, dependent on equipment specification, the system technology can also be installed with existing plants without the need to upgrade to next generation filter equipment platform.

All modern FMCG manufacturing sites operate with a close door policy using HEPA air filtrations systems recycle conditioned air back into the plant. Typically, there are always 2 sets of doors between the production area and external environment, with a variety of insect and vermin traps to reduce product contamination risk. A diaper convertor would normally remove 30-40 000 CMH from the production area, this air has to be replaced with “new” air. To avoid the expense of treating external air before sending into the factory, typically, conditioned air that has been removed from the production area is re-used to reduce air conditioning energy requirements. In such cases, air removed from the convertor process is passed through a quad stage filter system consisting of HEPA filtration technology, which removes 99.999% of dust particles down to 0.3 micron, and then sent back into the plant. Air taken from the production area, is typically around 24 degrees centigrade @ 40-45% relative humidity.

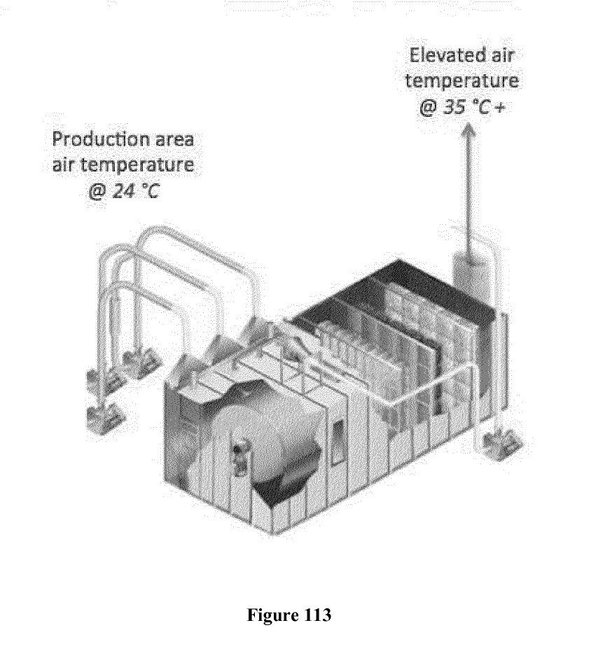

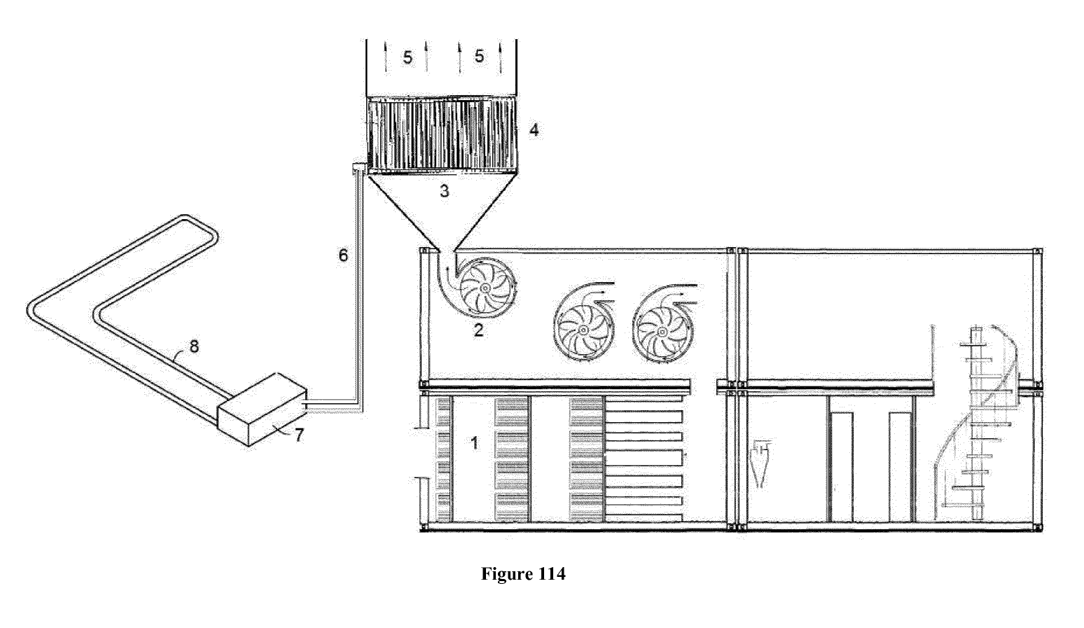

By the time however the air has passed through the diaper convertor and fans, the exit air is typically over 35° C. as depicted in FIG. 113, and in some cases, temperatures over 60° C. have been recorded. For manufacturing sites where heating is required, this is ideal as it saves or even eliminates additional heating costs. However, during summer periods, and all year round for plants located closer to the equator, this elevated air temperature unfortunately requires additional energy requirements to cool prior to re-entry back into production area. Typically HVAC control systems would monitor internal and external air temperatures and moisture levels and calculates the cost to reduce temperature of filter outlet air verses de-humidification of external air and adjust the air volumes accordingly for optimal energy usage. FIG. 114 depicts a scenario where (1) is a filter connected to a hygienic convertor, (2) is the main system fan, (3) is the exit point of the main system fan which is diverted into a chilling device, (4) is a chilling device, similar to a standard radiator used in a car or HVAC system, (5) is the air exiting the system which is fed back into the factory directly or fed back into the factory via a secondary HVAC system, (6) is the output circuit of the geo-thermal system, (7) is the pump system and heat exchanger, (8) is the geo-thermal pipework installed typically either as A. at a lower depth using drilling method, B. just below ground level by removing topsoil, adding pipework and replacing topsoil or by using a trenching method, C. within an existing water systems such as a lake, river, or pond.

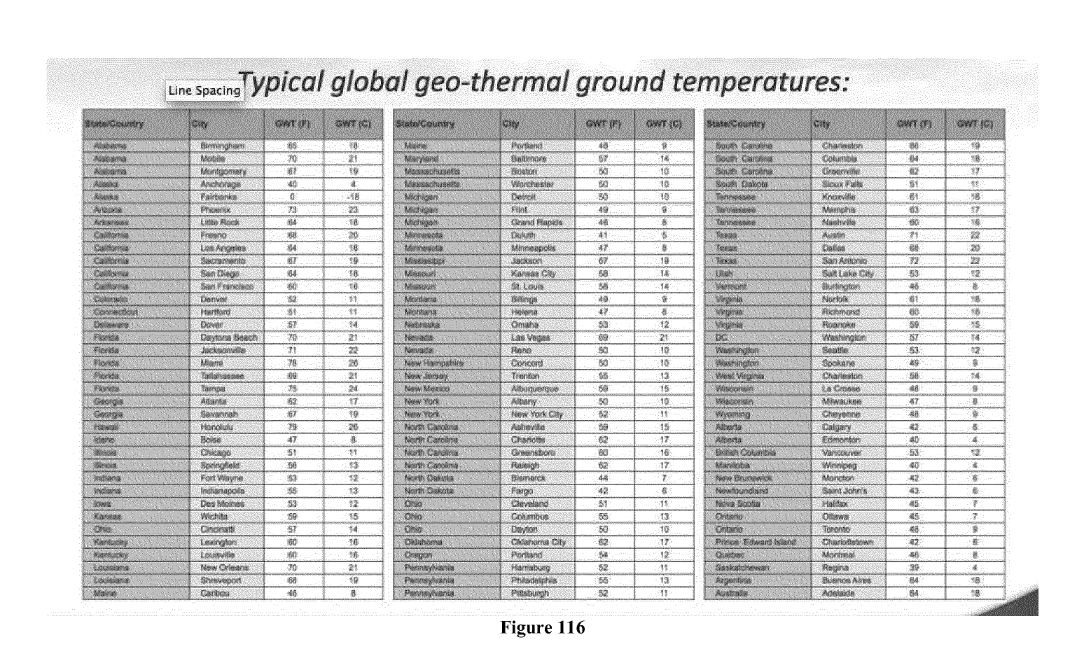

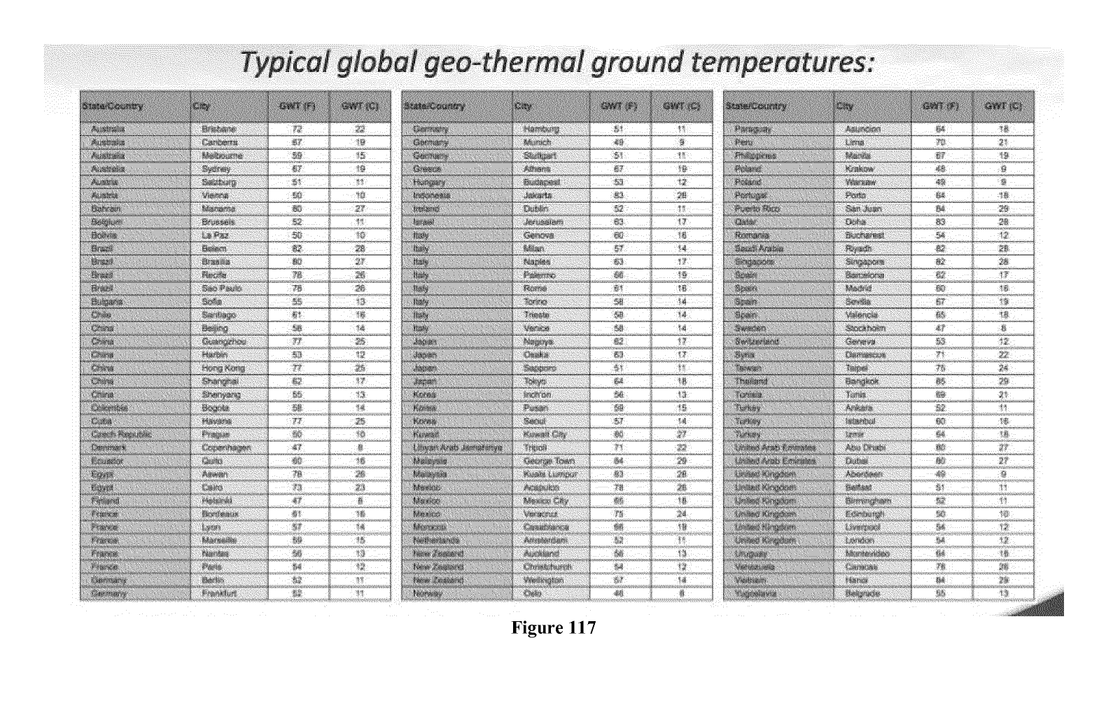

If the filter outlet air could be cooled using geo-thermal resources prior to being sent back into the HVAC system, then significant energy costs could be saved and CO2 emissions subsequently reduced. FIGS. 116 & 117 outline ground temperatures around the globe. It is clear to see that even production sites close to the equator which typically have below ground geothermal resources around 25-29° C. can still take advantage of the system interface to reduce a large percentage of their HVAC costs.

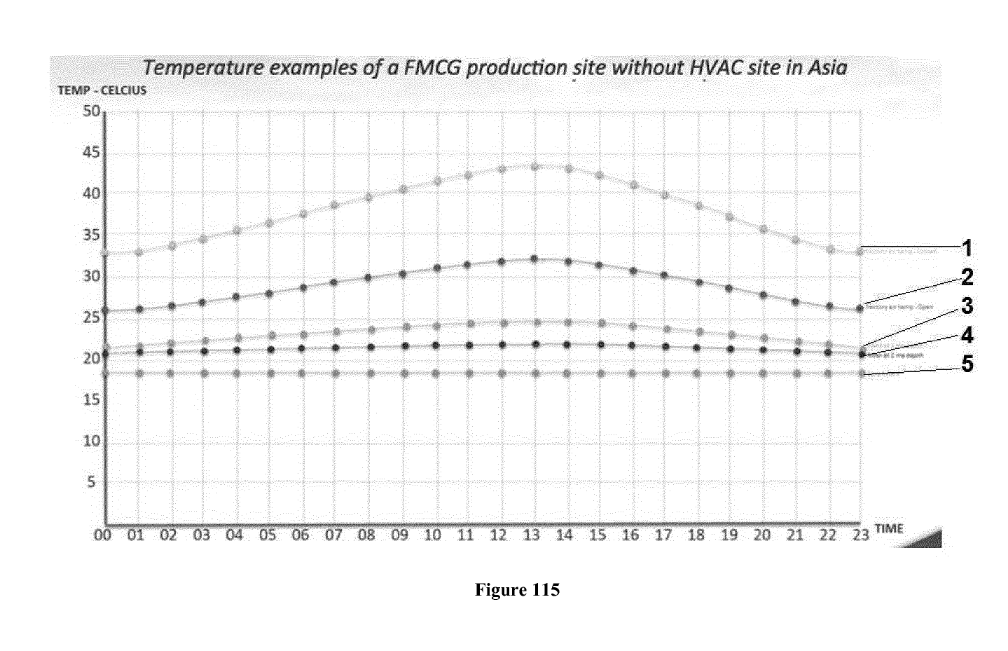

FIG. 115 outlines a common scenario in a production site located closed to the equator. In this scenario, the site has not installed air recycling and as such, the cost to install an HVAC system cannot be justified and as a consequence, factor temperatures are typically high. Under such a scenario, factory workers wish to open the factory doors, in response however to rising customer complaints due to insect contamination in finished product, the plant manager wishes to keep the factory doors closed. FIG. 115 outlines a temperature analysis over a 24-hour period, with the X-axis depicting hours according to the 24-hour clock with the Y-axis depicting temperature in Celsius. (1) Indicates factory temperature changes throughout the day when the plant manager is on-site and ensuring all doors are kept closed. (2) Indicates factory temperature changes throughout the day when the plant manager is off-site and the factory workers have open all doors allowing air to naturally ventilate throughout the factory. (3) Depicts temperatures at a local pond, 3 meter depth located 50 meters from the factory containing on average around 10500 tonnes of water, (4) depicts temperatures at a local river located 550 meters from the factory at a 2 meter depth, (5) Depicts temperatures at a test bore hold 36.5 meters in depth. FIGS. 116 & 116 indicate actual geothermal ground temperatures.

A further embodiment in the filter system is the installation of a new control and supervision technology comprising of data collection system with in-feeds from multiple processes and video camera supervision system. Data management is carried out through a variety of systems namely (1) direct remote access via Internet, (2) Automatic synchronisation between local storage systems and Internet storage systems via systems similar to Drop-box, (3) Local storage with capability to extract specific segments of data via remote access, (4) Local storage with capability to extract specific segments of data via remote access where data being stored is deleted once data becomes a pre-defined age, or, data storage capacity becomes limited. Data can be analysis and feed-back to modify filter process could either at the location of the utility system, at the production line to which the utility system is connected, at another location (say maintenance managers office) but on the same site, off-site, or even off-shore.

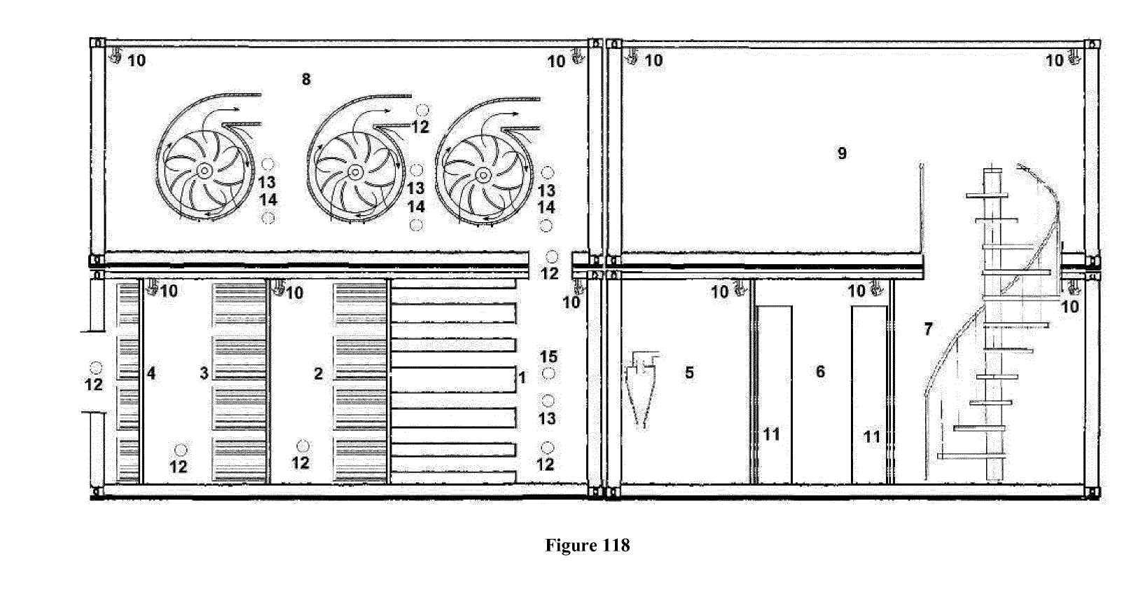

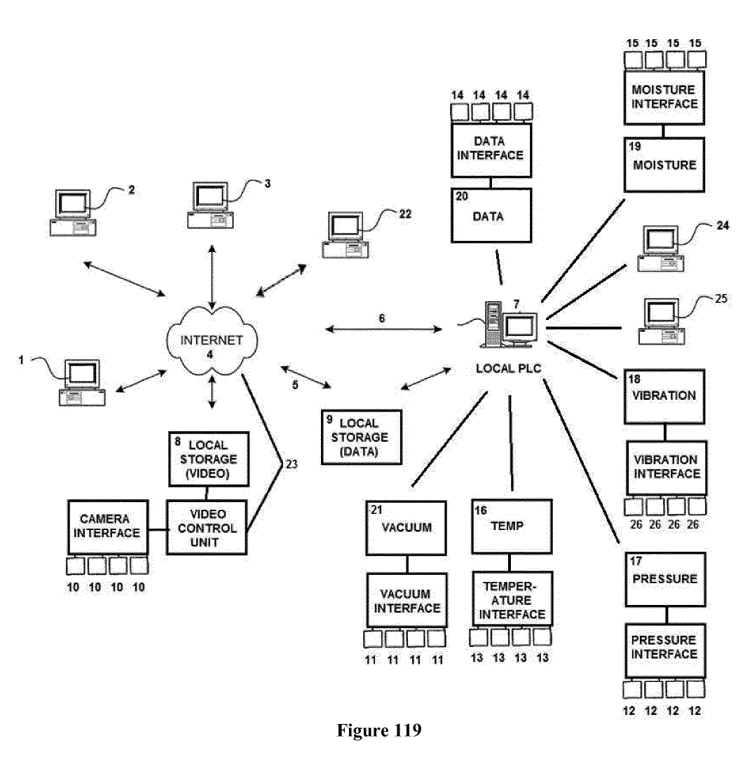

The total system in outlined in FIGS. 118 & 119 where 118 (1) is the stage 1 filter process, (2) is the stage 2 filter process, (3) is the stage 3 filter process, (4) is the stage 4 filter process, (5) is the ancillary area where cyclone and vales are located, (6) s the power & control room (7) is the access area to 2^{nd} level, (8) is the fan container, (9) is the OEM container, (10) are video surveillance cameras, (11) are data interface locations, (12) are pressure sensor locations, (13) are temperature sensor locations, (14) are vacuum sensor locations, (15) are possible moisture sensor locations. Depicted on FIG. 119 (1) is a computer terminal connected to the internet, connected to the filter supervision website where, real time filter data is being access which would typically have password entry, VPN, pin generator protection or similar, where (2) is a computer terminal connected to the internet, connected to the utility system supervision website where, historic filter data is being access which would typically have password entry, VPN, pin generator protection or similar, where (3) is a computer terminal connected to the internet, connected to the filter supervision website where, real time filter data is being access and camera images and control signals are being given back to the filter which would typically have password entry, VPN, pin generator protection or similar, where (4) is the internet, also referred to as the world wide web, WWW, where (5) is a data exchange connection via the internet where local data is synchronises with data stored at another location (22), which could for instance be carried out by a service provider such as drop-box, where (6) is the data exchange connection from the local utility computer system to the internet, where (7) is the local utility computer system/PLC, where (8) is a data storage system typically a hard disk drive or similar with large capacity which could range from 1 GB to 1000 TB, but would typically be ˜5 TB where video images are recorded from multiple cameras, and where either video images are deleted over a certain age, or, images are deleted when the storage capacity is becoming full, where (9) is a data storage system typically a hard disk drive or similar which locally stores process data such as vibration, temperatures, moisture levels, RPM levels, vibration levels, cycle frequencies, E-Stop switching, door opening, pressure levels in compressed air, vacuum levels, where (10) are the in-feeds from multiple camera systems, where (11) are the in-feeds from multi vacuum sensors, where (12) are the in-feeds from multi pressure sensors, where (26) are the in-feeds from vibration sensors, where (13) are the in-feeds from multi temperature sensors, where (14) are the in-feeds from multi data streams such as VFD RPM control, where (15) are the in-feeds from multi moisture sensors, where (16) is the temperature interface, where (17) is the pressure interface, where (18) is the vibration interface, where (19) is the moisture interface, where (20) is the secondary data interface, where (21) is the vacuum interface, where (22) is a storage system where data stored at another location to the utility system which would typically be connected via the internet and have synchronisation capability, which could for instance be carried out by a service provider such as drop-box, (23) is a direct link from the video interface to the internet to allow for real time video supervision, where (24) is a viewing & control method such as a touch screen display located on or close to the utility system(s), where (25) is a viewing & control method such as a touch screen display located on or close to the production system to which the utility system is connected and could be integrated into the production systems power & control architecture.

Additional storage systems (8) & (9) could also be added and stored in another location within or close to the utility system to provide data access should a fire or similar incident occur. Similarly, to a data flight recorder, the data storage devices could be installed within a housing, which has fire protection properties.

The above mentioned system is quite unique in that should the utility system not be connected to the internet, data will still be stored locally and when once again connected to the internet, data synchronisation would be automatic. The data stored is of great value to local operations and the filter manufacture as a better process understanding the fundamental framework for correct process decisions to be made. Having direct access to current and historic data and presenting this in an easily understandable form such as graphic representation so process trends can be understood will allow sensible recommendations to be made to enhance process configurations & setting, as well as recommendations on filter media replacement. Additional SPC (statistical process control) packages can be added to analyse the process data being received.

Such an interface can also be used in conjunction with an offsite and/or off shore location, which could not only monitor the utility process but also control.

A further embodiment in the filter system is to limit the access to the system by VPN or other similar device.

A further embodiment in the filter system is to install a camera lenses cleaning system which would typically be the installation of an air jet system where clean air is supplied to the camera lenses. Air feed-ins from naturally venter air to the filter passing through a secondary filter however additional fan(s) could be installed to increase airflow or compressed air could also be used. Other cleaning methods such as a revolving lenses cover and/or mechanical cleanings process such as brushing can also be used.

A key embodiment in the filter design is a new integrated calling system referred to as an “eco” interface. Typically today, if production problems occur the utility systems continue to run up to a point where an operator shuts down the power. Any energy consumption reduction is desired and with the progression of convertor technology over the past 30 years, a significant amount of data is available “electronically” as to the reasons for the product problems, an “intelligent” interface would have the ability to understand activities in the production area and manage the utility system accordingly in order to reduce energy consumption.

On a typical hygienic production process a very large percentage of problems occur in the actual physical production process. Many of these problems are related to glue build up, raw material variances, raw materials tracking issues, which ultimately result in a raw material jam and/or raw material breakage. When such an event occurs, typically the problem is picked up by electronic sensors, which subsequently shut down the production process. Each shut down typically has a defined workload associated to resolve the problem and start the product process.

A frontal tape process related problem would typically be resolved in 1-2 minutes, a leg cuff process related problem would typically be resolved in 5-10 minutes, a top sheet breakage which disrupted secondary raw material flows such as the leg cuffs could take 10-15 minutes to resolve. By receiving data from the production equipment as to the reason for the production stop, this data can be analysed together with a data outlining time requirements for the repair, and a time prediction could be made as to the length of the shutdown.

Once estimated start up times are calculated, the respective utility systems could shut down. Respective utility systems could mean the entire system, however, as shutting down the entire process may create additional process problems (such as cut & slip processes holding material on the vacuum shells) in some instances only partial systems would shut down.

With the utility systems starting up again at a defined time, this may create un-desired effects as workers could still be in the production area. To compensate this potentially negative effect, secondary valve systems can be installed to enable a quick start up as soon as production commences. Other data input can also be used for the utility system to understand actual status of the production process such as the closing of safety doors, and, motion detectors positioned in the production area.

A typical scenario could be:
i. Diaper Leg cuff web breaks.
ii. From data within utility system's database, the utility system knows that core fans can be shut down without experiencing any process issues. Core fans are therefore shut down.
iii. From data within the utility system's database, the utility system knows that conveyor vacuum fans can be shut down in a when the production system is in a stationary mode to 20% of their typical airflows without any noticeable side effects. Conveyor fans are therefore shut down to 20% of their typical airflows.
iv. From data within utility system's database, the utility system knows that process vacuum fans can be shut down in a stationary mode to 65% of their typical airflows without any noticeable side effects. Process vacuum fans are therefore shut down to 65% of their typical airflows.
v. From data within database utility system knows that repairing the leg cuff web takes between 10-15 minutes. For the first 9 minutes, the system remains essentially in sleep mode.
vi. After 11 minutes, the utility system detects that safety doors are in the process of being closed, this is the signal that the line will most likely be starting up shortly, and as such, main fan increases to 80% of production process value awaiting further signals, the conveyor vacuum and core vacuum go up to 50% of their typical air flows (in scenarios where during the repair process motion detectors sense no activity around the convertor area, the system assumes the crew have gone for a break and does not re-active this phase until the crew returns).
vii. Once all doors close, motion detectors detect that an operator is walking to the main control panel where he would typically start the convertor. When operator is within a set distance from the control panel typically say 5 meters away, the system returns all fans to typical production level.
viii. Once the start warning alarm is finished its warning cycle, all off-line utility systems are running at correct speeds and airflows are balanced.

With the continued focus on energy saving, a further embodiment in the utility system is an integrated energy storage system. With energy costs rising and VFD technology becoming more common, new ways exist to return energy to the system.

When the diaper convertor shuts down, typically there number of revolving components within the utility system such as fans, which, have respective energy stored as kinetic energy. Furthermore, there is also kinetic energy in the air flowing through the utility system. In systems today, power is simply turned off which and the air and fans slowly come to a stop.

One embodiment of this invention is to reclaim this energy back and re-use this energy when the utility system starts again. The energy can be stored in a mechanical device, and would more preferably stored in a electrical device, and would more preferably stored in a electrical device consisting of a battery and would more preferably stored in a electrical device consisting of a capacitor.

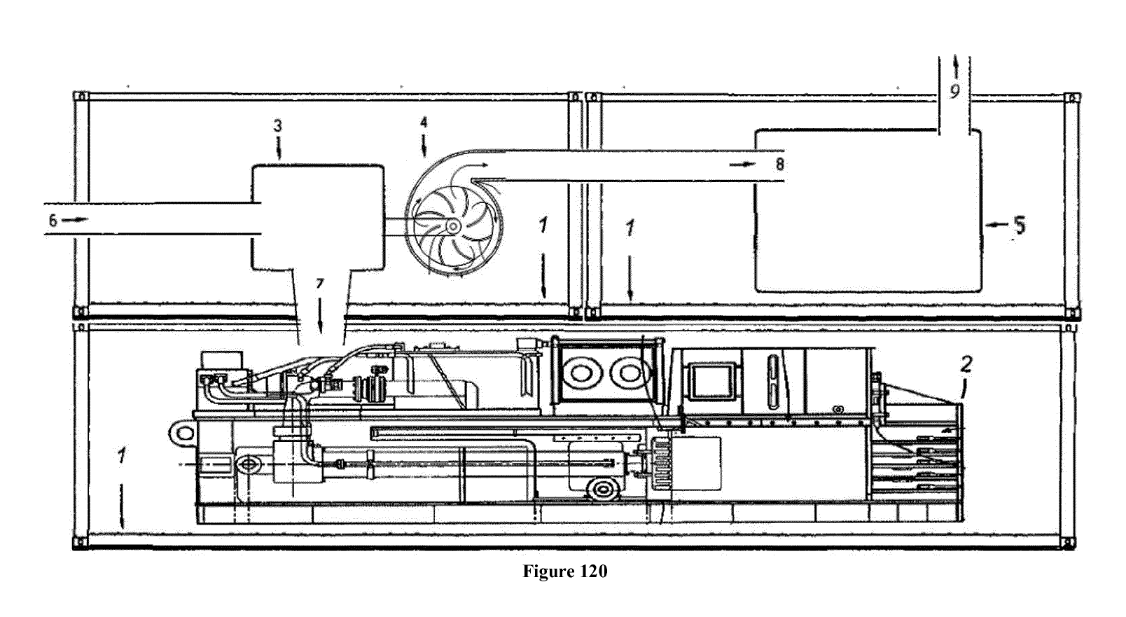

A further embodiment of this invention is the inclusion of all utility systems into a shipping container concept. FIG. 120 illustrates certain embodiments of this concept where (1) is the shipping container framework, (2) is a baler but could also be a poly heat compactor, briquette machine or any compaction device, (3) is a separation device where (6) is the air/product in feed, (7) is the product out feed, (4) is the fan removing air from (3), (5) is the filtration device with in coming air (8) and outlet air (9). All systems are held within a shipping container format with a modular plug & play utility interface where a multitude of boxes or containers used within the shipping industry are used to house the utility equipment. The term “shipping container” would typically be all sea shipping container formats conforming to standard outline in ISO 668, ISO 1496-1 & ISO 55.180.10, however, as ISO standards are continuously changing, the term “shipping container” described in this invention reference to any container and or box which has the ability to be directly shipped by sea without any significant modification.

Further embodiments include the inclusion of air separators (for removing particles from an air stream) into the shipping container concept as mentioned above, where, in additional the air separator container can be positioned above the baler and where the container framework can be used as an integral part of the final structure where mezzanine, walkways and stairs can also be included.

Further embodiments include the inclusion of poly heat compactors into the shipping container concept as mentioned above, where, in additional the air separator container can be positioned above the baler and where the container framework can be used as an integral part of the final structure where mezzanine, walkways and stairs can also be included.

Further embodiments include the inclusion of briquetting machines into the shipping container concept as mentioned above, where, in additional the air separator container can be positioned above the baler and where the container framework can be used as an integral part of the final structure where mezzanine, walkways and stairs can also be included.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. An air filtration device
comprising
a filter housing;
a filter positioned inside said filter housing;
an air inlet in said filter housing;
a vortex area positioned between said air inlet and said filter; and
a vortex creating device.

93. An air filtration device according to claim 92, wherein said vortex creating device is positioned between said air inlet and said vortex area.

94. An air filtration device according to claim 92, wherein said vortex creating device comprises fins.

95. An air filtration device according to claim 92, wherein said filter comprises one or more
corrugated, or
cone shaped, or
curved
filter media.

96. An air filtration device according to claim 92, wherein said filter is a drum filter.

97. An air filtration device according to claim 92, wherein said filter is rotatable mounted in a cantilevered arrangement.

98. An air filtration device according to claim 92, wherein said inlet area exhibits an inlet area width, and said drum filter exhibits a filter width, and said air inlet width is smaller than said filter width.

99. An air filtration device according to claim 92, further comprising one or more of the elements selected from the group consisting of
a contaminant capturing system comprising a mesh positioned between said air inlet in said filter housing and said vortex area or opposite of said vortex area relative to said air inlet;
said filter housing comprising a door to allow access to said vortex area, said door being adapted and shaped to assists the vortex flow;
said filter housing comprising a door to allow access to said vortex area, said door having a curved general profile;
said filter housing comprising a door to allow access to said vortex area, said door further comprising fins;
said filter housing comprising an inner and an outer wall;
said filter housing comprising an inner and an outer wall, wherein said outer wall is the wall of a shipping container,
said filter housing comprising an inner and an outer wall, wherein said outer wall is the wall of a shipping container as structural element;
said filter housing comprising an inner, a middle and an outer wall, wherein said middle wall is the wall of a shipping container and said outer wall comprises a removable panel;
said filter housing is adapted to withstand an internal vacuum of at least 1 inch H2O;
said filter housing comprising a fan system;
said filter housing comprising a fan system affixed on a sliding device adapted to move at least a portion of said fan system outside of said housing;
said filter housing comprising a fan system that is arranged such that the motors are positioned in a first zone and the fans are positioned is a second zone separated from said first zone.
a cleaning device for cleaning said filter media;
a cleaning device for cleaning said filter media wherein the nozzle surface speed across filter media within the system may differ and where nozzle width may differ accordingly;
an automatic floor cleaning sweeping device for cleaning said filter housing;
a contactless filter seal system comprising two contactless filter seals separated by a naturally vented cavity;
a contactless filter seal system comprising two contactless filter seals separated by a naturally vented cavity, wherein said contactless filter seals are labyrinth seals.

100. A utility system comprising one or more stages of air filtration device/s, wherein said filtration device/s comprises/e
a filter housing;
a filter positioned inside said filter housing,
an air inlet in said filter housing
a vortex area positioned between said air inlet and said filter;
a vortex creating device positioned between said air inlet and said vortex area.

101. A utility system according to claim 100, wherein at least two stages if air filtration device are in modular arrangement and comprise a common electrical or mechanical interface.

102. A utility system according to claim 100, comprising at least a first and a second stage air filtering device which are in a serial arrangement.

103. A utility system according to claim 100, further comprising a filter media cleaning device comprising an exhaust system comprising a nozzle delivering air to an air inlet of the same or a different filtering device.

104. A utility system according to claim 100, further comprising at least one fan system in a fan housing.

105. A utility system according to claim 104, wherein said fan system is affixed on a sliding device adapted to move at least a portion of said fan system outside of said housing.

106. A utility system according to claim 104, wherein said fan system is arranged such that the motors are positioned in a first zone and the fans are positioned is a second zone separated from said first zone.

107. A utility system according to claim 100, wherein said one or more air filtration device/s are in a modular arrangement,
said utility system further comprising one or more further module/s selected from the group consisting of
filter module;
fan module;
ancillary equipment module;
material separator module;
compactor module;
baler module;
HVAC module;
geothermal cooling module,
wherein said modules comprise a common electrical and mechanical interface with said air filtration device/s.

108. A utility system according to claim 107, wherein said modules or combinations of said modules comply without significant modifications to ISO shipping container standards.

109. A utility system according to claim 100, further comprising a local data collection and storage system which automatically synchronizes with remote storage system.

110. A process for filtering air, comprising the steps of
providing an air filtration device comprising
a filter housing,
a filter positioned inside said filter housing,
an air inlet in said filter housing,
a vortex area positioned between said air inlet and said filter,
a vortex flow aid device positioned between said air inlet and said vortex area;
creating an air flow from said air inlet through said filter,
creating one or more vortex/es in said air flow in said vortex area by guiding said air flow by said flow aid device before passing through said filter.

111. A process for filtering air according to claim 110, said creating of an air flow and said creating of one or more vortex/es eliminating deposition of dust and other contaminants in said vortex area.

112. A process for filtering air according to claim 110, said creating of an air flow and said creating of one or more vortex/es resulting in a high speed air flow in said vortex area.

113. A process for filtering air according to claim 110,
wherein said filter is a drum filter exhibiting a drum filter axis,
and wherein the axis/es of said vortex/es in said vortex area is essentially parallel to said drum filter axis.
